(19) United States
(12) Patent Application Publication
(10) Pub. No.: US 2026/0027545 A1
(43) Pub. Date: Jan. 29, 2026

(54) COMPOSITIONS AND METHODS FOR FIBROUS POLYMER-MODIFIED LAYERED DOUBLE HYDROXIDE

(71) Applicant: VIRGINIA TECH INTELLECTUAL PROPERTIES, INC., Blacksburg, VA (US)

(72) Inventors: Wencai ZHANG, Blacksburg, VA (US); Yanan PAN, Blacksburg, VA (US)

(21) Appl. No.: 19/280,270

(22) Filed: Jul. 25, 2025

Related U.S. Application Data
(60) Provisional application No. 63/675,470, filed on Jul. 25, 2024.

(51) Int. Cl. B01J 20/26; B01D 15/20; B01J 20/08; B01J 20/28; B01J 20/30; B01J 20/32; B01J 20/34; C01F 7/784; C22B 3/24; C22B 26/12; D01F 1/10; D01F 6/18; D01F 9/08

(52) U.S. Cl. CPC B01J 20/261; B01D 15/203; B01J 20/08; B01J 20/28011; B01J 20/28023; B01J 20/3007; B01J 20/3085; B01J 20/3204; B01J 20/327; B01J 20/3293; B01J 20/3425; B01J 20/3475; C01F 7/784; C22B 3/24; C22B 26/12; D01F 1/10; D01F 6/18; D01F 9/08; D10B 2505/00

(57) ABSTRACT

The present disclosure relates to electrospun nanosorbent fibers, tailored for lithium extraction having enhanced physicochemical properties. The present disclosure further relates to methods of making the disclosed electrospun nanosorbent fibers and methods of using the disclosed electrospun nanosorbent fibers.

### CROSS-REFERENCE TO RELATED APPLICATIONS

This Application claims the benefit of and priority to U.S. Provisional Application No. 63/675,470, filed on Jul. 25, 2024 which is incorporated herein by reference in its entirety.

### BACKGROUND

Lithium, as the optimal anode material in lithium-ion batteries, plays a role in shifting industries away from fossil fuels towards more sustainable energy sources. According to projections by the U.S. Geological Survey (USGS), global lithium consumption is expected to reach approximately 180,000 metric tons by 2023, highlighting the rapidly increasing demand. This surge underscores the critical need for developing more effective lithium extraction methods to meet the growing requirements for clean energy technologies. Lithium primarily occurs in various natural forms, such as in lithium-bearing pegmatite deposits, Salt Lake brine reservoirs, and sedimentary deposits associated with clay minerals. Among them, Salt Lake brine is especially valuable for lithium extraction due to its high concentration of dissolved lithium, making the process both economically viable and technically feasible. This characteristic places Salt Lake brine at the forefront of lithium extraction research and development efforts, highlighting its strategic importance in the industry. Currently, the principal methods for lithium extraction from brine include evaporation ponds, direct lithium extraction (DLE), membrane technologies, geothermal extraction, and electrochemical methods. Despite advances in lithium extraction technology, there is still a need for more efficient and effective methods of lithium extraction. These needs and other needs are satisfied by the present disclosure.

### SUMMARY

In accordance with the purpose(s) of the disclosure, as embodied and broadly described herein, the disclosure, in one aspect, relates to electrospun nanosorbent fibers, tailored for lithium extraction having enhanced physicochemical properties. The present disclosure further relates to methods of making the disclosed electrospun nanosorbent fibers.

Disclosed are lithium porous nanosorbent fiber compositions comprising: an LDH (Layered Double Hydroxide) substrate; and a polymer attached to the LDH substrate; wherein the composition has improved affinity for extraction of lithium from a lithium-containing source material; and wherein the composition has a fibrous structure.

Also disclosed are methods of making the disclosed lithium porous nanosorbent fiber compositions, the method comprising: (a) preparing a Li/Al-LDH substrate using co-precipitation; (b) dissolving a polymer in a dissolving solution, thereby creating a polymers suspension; (c) adding the Li/Al-LDH substrate to the suspension, thereby forming a Li/Al-LDH-polymer suspension; (d) electrospinning the Li/Al-LDH-polymer suspension, thereby forming a fibrous product; and (e) drying the fibrous product.

Also disclosed are methods of using the disclosed lithium porous nanosorbent fiber compositions, comprising: (a) flowing a feedstock solution comprising lithium over a solid comprising the disclosed lithium porous nanosorbent fiber compositions, thereby producing a first effluent; (b) flowing an aqueous solution over the solid; and (c) flowing a desorption solution over the solid, thereby producing a second effluent.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a schematic diagram of representative lithium porous nanosorbent fiber (Li-PNF) preparation procedures.

FIG. 2 shows photos of representative Li-PNFs.

FIG. 3A shows an ingredient content chart of representative Li-PNFs.

FIG. 3B shows steady viscosity as a function of shear rate for representative polyacrylonitrile/layered double hydroxide (PAN/LDH) composite suspensions with different LDH contents at 293 K.

FIG. 3C shows viscosity of representative PAN/LDH composite suspensions at the shear rate of 0.01 1/s as a function of LDH content.

FIG. 4A shows stress-strain curves of different representative Li-PNFs.

FIG. 4B shows thickness z and yield stress p changes as a function of LDH content.

FIG. 4C shows tensile strength δ_{b} and elongation ε_{b} changes as a function of LDH content.

FIG. 4D shows dynamic real water drops on the surface of representative Li-PNFs.

FIG. 4E shows the time required for complete wetting and contacting angle of different representative fibers.

FIGS. 5A and 5B show N₂ adsorption curves (FIG. 5A) and desorption curves (FIG. 5B) of various representative Li-PNFs.

FIG. 5C shows pore size distributions of various representative Li-PNFs.

FIGS. 5D and 5E show porosity ϕ (FIG. 5D) and pore volume (FIG. 5E) changes as a function of LDH content.

FIGS. 5F and 5G show average pore diameter (FIG. 5F) and average surface area (FIG. 5G) changes as a function of LDH content.

FIGS. 6A-6E show representative morphologies of Li-PNFs-1 (FIG. 6A), Li-PNFs-2 (FIG. 6B), Li-PNFs-3 (FIG. 6C), Li-PNFs-4 (FIG. 6D), and Li-PNFs-5 (FIG. 6E).

FIG. 6F shows a representative high-magnification scanning electron microscopy (SEM) image of Li-PNFs-1.

FIG. 6G shows a representative energy dispersive X-ray (EDS) mapping of Li-PNFs-1.

FIG. 7 shows fiber size distribution of different representative Li-PNFs.

FIGS. 8A-8D shows X-ray diffraction (XRD) spectra (FIG. 8A), Fourier transform infrared (FTIR) spectra (FIG. 8B and FIG. 8C), and thermogravimetric analysis (TGA) curves (FIG. 8D) for various representative Li-PNFs.

FIG. 9 shows representative atomic concentrations (%).

FIG. 10A shows C 1s, N 1s, and O 1s high resolution spectra of representative PAN fiber and Li-PNFs-1.

FIG. 10B shows a diagram illustrating the structural optimization of PAN, LDH, and PAN/LDH.

FIG. 10C shows a diagram illustrating the optimized geometry of PAN and PAN/LDH.

FIG. 10D illustrates the electron density and electron difference density variation between PAN and PAN/LDH.

FIG. 11A shows initial lithium concentration effect on different representative fibers.

FIG. 11B shows pH value and fiber amount effects on different representative fibers.

FIG. 11C shows representative lithium adsorption kinetic and fitting curves using Li-PNFs-1.

FIG. 11D shows a representative lithium adsorption isotherm using Li-PNFs-1.

FIG. 11E shows a representative adsorption selectivity for Li-PNFs-1.

FIG. 11F shows representative lithium adsorption cyclic performance for Li-PNFs-1.

FIG. 11G shows a schematic diagram of representative lithium extraction by Li-PNFs-1.

FIG. 12 shows a schematic diagram of a representative fixed-bed experiment.

FIGS. 13A-13D show an SEM micrograph (FIG. 13A), a transmission electron microscopy (TEM) micrograph (FIG. 13B), and high-resolution TEM (HRTEM) micrographs (FIG. 13C and FIG. 13D) of representative Li-PNFs.

FIGS. 13E and 13F show elemental mappings on different sections of representative Li-PNFs.

FIGS. 14A-14E shows XRD patterns (FIG. 14A), FTIR spectra (FIG. 14B), N₂ adsorption-desorption isotherms (FIG. 14C), pore size distribution (FIG. 14D), and surface area, pore volume, and average ore size comparison (FIG. 14E) of representative Li/Al-LDH and representative Li-PNFs.

FIG. 15A shows lithium adsorption capacity comparison of representative Li/Al-LDH and representative Li-PNFs.

FIG. 15B shows the selectivity factor of representative Li-PNFs.

FIG. 15C shows a comparison of Li⁺ binding energy in different sites of representative Li/Al-LDH and representative Li-PNFs.

FIGS. 16A-16C show comparisons of experimental breakthrough curves of lithium adsorption under different flow rates (FIG. 16A), initial Li⁺ concentrations (FIG. 16B), and bed heights (FIG. 16C).

FIGS. 16D-16F show comparisons of penetrated Li⁺ concentration under different flow rates (FIG. 16D), initial Li⁺ concentrations (FIG. 16E), and bed heights (FIG. 16F).

FIG. 17 shows lithium extraction performance in different serial fixed-bed experiments.

FIGS. 18A-18L show a comparison of the theoretical breakthrough curves of lithium adsorption using Clark (FIGS. 18A-18C), Thomas (FIGS. 18D-18F), Yoon-Nelson (FIGS. 18G-18I), and Modified-Dose-Response models (FIGS. 18J-18L).

FIGS. 19A-19F show the effect of flow rate, initial Li⁺ concentration in desorption solution, and bed height on lithium desorption performance for lithium desorption curves (FIGS. 19A-19C) and lithium desorption recovery rates (FIGS. 19D-19F).

FIG. 20A and 20B show XRD patterns (FIG. 20A) and FTIR results (FIG. 20B) for representative PAN fiber and representative Li-PNF fiber.

FIG. 21 shows representative cyclic lithium extraction in an adsorption phase and representative lithium recovery rate in a desorption phase.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a layered double hydroxide,” “a polymer,” or “a substrate,” includes, but is not limited to, two or more such layered double hydroxides, polymers or substrates, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “contacting” as used herein refers to bringing a disclosed analyte, compound, chemical, or material in proximity to another disclosed analyte, compound, chemical, or material as indicated by the context. For example, an analyte contacting an antibody refers to the analyte being in proximity to the antibody by the analyte interacting and binding to the antibody via ionic, dipolar and/or van der Waals interactions. In some instances, contacting can comprise both physical and chemical interactions between the indicated components. It is to be understood that chemical interactions can comprise a combination of covalent and non-covalent interactions, including one or more of ionic, dipolar, van der Waals interactions, and the like. For example, a WE layer contacting a substrate layer is understood to mean that the WE layer is in physical and chemical contact with the substrate layer that can comprise covalent, ionic, and non-covalent interactions.

The terms “disclosed composition”, “disclosed absorbent”, “disclosed electrospun nanosorbent fibers”, “disclosed lithium absorbent”, “lithium porous nanosorbent fiber compositions”, and “Li-PNF” can be used interchangeably and refer to a disclosed material comprising a Li/Al-LDH substrate and a polymer formed into a fibrous structure. This material can be used as an absorbent, in particular, an absorbent for lithium that can extract lithium from low concentration lithium sources.

The terms “Li/Al-LDH substrate” and “Li/Al-LDH powder” can be used interchangeably herein and refer to a Li/Al-LDH material that can be powder, a powder dispersed in a slurry or suspension, and the like which is modified by the disclosed methods herein to comprise a polymer. In some instances a Li/Al-LDH substrate can be in the form of a “Li/Al-LDH salt” or a solution comprising a Li/Al-LDH salt.

The term “lithium source” is used herein to refer to a source material or feedstock from which lithium can be extracted using the disclosed methods for extraction of lithium utilizing the disclosed compositions comprising a Li/Al-LDH substrate and a polymer, e.g., a water-byproduct or product obtained from shale gas extraction or operations, or other lithium-containing byproduct thereof. A further example of a lithium source is a water-byproduct or product of a mining operation.

As used herein, the term “effective amount” refers to an amount that is sufficient to achieve the desired modification of a physical property of the composition or material. For example, an “effective amount” of a polymer or LHD refers to an amount that is sufficient to achieve the desired improvement in the property modulated by the component, e.g. achieving the desired flow and absorption capacities of a disclosed composition. The specific level in terms of wt %, mol% or other denotation of amount in a composition required as an effective amount will depend upon a variety of factors including the amount and type of polymer, the LDH used, and the desired adsorption capacity of a disclosed composition.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### B. COMPOSITIONS

In one aspect, the disclosure relates to electrospun nanosorbent fibers, tailored for efficient lithium extraction, and having enhanced physicochemical properties. These fibers can be fabricated using a polymer/solvent matrix, e.g., a polyacrylonitrile/dimethylformamide matrix, where viscosity and dynamic mechanical analysis indicated that enhanced interactions were achieved at lower contents of layered double hydroxide. The adjustment in formulation can lead to the creation of lithium porous nanosorbent fibers (Li-PNFs). The disclosed Li-PNFs can exhibit enhanced mechanical attributes, e.g., yield stress, tensile strength and elongation at break as disclosed herein. Additionally, the disclosed Li-PNFs can have enhanced hydrophilicity and hierarchical porous architecture, which—without wishing to be bound by a particular theory—is believed to provided rapid wetting kinetics and lithium adsorption. Morphologically, the disclosed Li-PNFs exhibited uniform smoothness indicative of orderly crystalline growth and a dense molecular arrangement. X-ray photoelectron spectroscopy and DFT-CASTEP simulations revealed modifications in the spatial and electronic configurations of polyacrylonitrile due to hydrogen bonding, facilitating enhanced lithium adsorption capacity. Kinetic and isotherm analyses showed rapid equilibrium within a short period of time, e.g., 60 min, and confirmed the chemical and selective nature of Li⁺ uptake. The disclosed Li-PNFs maintained consistent adsorption performance over multiple cycles consistent with an enhanced potential for sustainable industrial applications.

In one aspect, disclosed are lithium porous nanosorbent fiber compositions comprising: an LDH (Layered Double Hydroxide) substrate (e.g., Li/Al-LDH); and a polymer attached to the LDH substrate; wherein the composition has a fibrous structure. A fibrous structure can, in one aspect, refer to a plurality of fibers. In various aspects, the LDH substrate and polymer are in contact with one another via non-covalent interactions. The compositions can have good affinity for extraction of lithium from a lithium-containing source material, particularly in comparison to an LDH substrate without the inclusion of the polymer component.

In various aspects, the polymer can be selected from a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), and combinations thereof (e.g., copolymers thereof). In a further aspect, the polymer can be selected from PAN, PVDF, PVC, and combinations thereof (e.g., copolymers thereof). In a still further aspect, the polymer can be selected from PAN, PVDF, PVC, and combinations thereof (e.g., copolymers thereof). In a yet further aspect, the polymer is a PAN.

In various aspects, the polymer can be a block copolymer comprising two or more blocks; and wherein each block can be independently selected from a polymer block comprising a PAN, a PVDF, a PVC, a PEG, a PAA, a PLA, a PP, a PET, a PS, and combinations thereof (e.g., copolymers thereof). In a further aspect, the polymer can be a gradient copolymer comprising a first gradient block comprising a PAN, a PVDF, a PVC, a PEG, a PAA, a PLA, a PP, a PET, a PS, or combinations thereof (e.g., copolymers thereof); and wherein the gradient copolymer can comprise a higher concentration of the first gradient block at a first terminus and a lower concentration of the first gradient block at a second terminus distal to the first terminus. The gradient copolymer can further comprise a second gradient block at a higher concentration at the second terminus and at a lower concentration at the first terminus. The second gradient block can comprise hydrophilic and/or flexible polymers, such as a PEG, a PAA, a PLA, or combinations thereof. In a further aspect, the first gradient block can comprise a PAN and the second gradient block can comprise a PEG or a PAA.

In the gradient copolymer, there is a gradual change in composition along the copolymer from primarily the first gradient block near one the first terminus of the polymer to primarily other blocks (e.g., the second gradient block) near the second terminus of the polymer. More specifically, in one aspect, greater than 50% of all of the first gradient blocks contained within the copolymer are contained within a terminal region (e.g., the first terminus) of the gradient copolymer. The terminal region is defined as less than 50% of the copolymer's overall backbone degree of polymerization. In another aspect, about 75% or about 99% of the first gradient blocks are contained within a terminal region of the gradient copolymer. In another aspect, greater than 50% to about 99% or about 75% to about 99% of the first gradient blocks are contained within a terminal region of the gradient copolymer.

In various aspects, the polymer can have a molecular weight from about 10,000 Da to about 500,000 Da. In a further aspect, the polymer can have a molecular weight from about 100,000 Da to about 300,000 Da. In a still further aspect, the polymer can have a molecular weight from about 125,000 Da to about 175,000 Da. In a further aspect, the composition comprises a plurality of fibers, wherein the fibers are electrospun fiber.

In various aspects, the disclosed composition, i.e., disclosed Li-PNFs, can have a lithium adsorption capacity of from about 0.1 mg/g to about 50 mg/g. In a further aspect, the disclosed composition can have a lithium adsorption capacity of from about 0.1 mg/g to about 50 mg/g, about 0.1 mg/g to about 40 mg/g, 0.1 mg/g to about 30 mg/g, about 0.1 mg/g to about 20 mg/g, about 10 mg/g to about 50 mg/g, about 20 mg/g to about 50 mg/g, about 30 mg/g to about 50 mg/g, about 10 mg/g to about 40 mg/g, or about 5 mg/g to about 30 mg/g. In various aspects, the Li-PNFs comprises fibers. In a further aspect, the Li-PNF fibers are porous. In a still further aspect, the individual fibers within the Li-PNFs can each have a diameter from about 50 nanometers (nm) to about 2000 nm. In various aspects, the Li-PNFs can each have a diameter of about 50 nm to about 2000 nm, about 100 nm to about 600 nm, about 100 nm to about 200 nm, about 300 nm to about 1000 nm, about 400 nm to about 900 nm, about 450 nm to about 850 nm, about 500 nm to about 800 nm, about 500 nm to about 700 nm, about 500 nm to about 600 nm, about 400 nm to about 700 nm, about 400 nm to about 600 nm, or about 450 nm to about 550 nm.

In various aspects, the weight ratio of LDH substrate to polymer in the composition can be from about 1:1 to about 1:100. In a further aspect, the weight ratio of LDH substrate to polymer can be from about 1:1 to about 1:50. In a still further aspect, the weight ratio of LDH substrate to polymer can be from about 1:1 to about 1:20. In a yet further aspect, the weight ratio of LDH substrate to polymer can be from about 1:1 to about 1:10. In a further aspect, the weight ratio of LDH substrate to polymer can be from about 1:1 to about 1:5. In a still further aspect, the weight ratio of LDH substrate to polymer can be from about 1:1 to about 1:2. In another aspect, the lithium porous nanosorbent fiber composition has an LDH substrate concentration of about 20 wt/v % (weight of the substrate per volume of the composition) to about 80 wt/v %, about 20 wt/v % to about 60 wt/v %, about 20 wt/v % to about 40 wt/v %, about 40 wt/v % to about 80 wt/v %, about 60 wt/v % to about 80 wt/v %, or about 40 wt/v % to about 60 wt/v %.

In various aspects, the Li-PNFs can have a yield stress of at least about 0.5 MPa, at least about 0.6 MPa, at least about 0.7 MPa, at least about 0.8 MPa, at least about 0.9 MPa, or at least about 1.0 MPa. In another aspect, the Li-PNFs can have a yield stress ranging from about 0.5 MPa to about 2.0 MPa, about 0.5 MPa to about 1.5 MPa, about 0.5 MPa to about 1.0 MPa, or about 1.0 MPa to about 2.0 MPa. In various aspects, the Li-PNFs can have a tensile strength of at least about 2.0 MPa, at least about 2.1 MPa, at least about 2.2 MPa, at least about 2.3 MPa, at least about 2.4 MPa, at least about 2.5 MPa, at least about 2.6 MPa, at least about 2.7 MPa, at least about 2.8 MPa, at least about 2.9 MPa, or at least about 3.0 MPa. In another aspect, the Li-PNFs can have a tensile strength ranging from about 2.0 MPa to about 4.0 MPa, about 2.0 MPa to about 3.5 MPa, about 2.0 MPa to about 3.0 MPa, about 2.5 MPa to about 4.0 MPa, or about 3.0 MPa to about 4.0 MPa,

In various aspects, the Li-PNFs can have an elongation at break of at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, or at least about 25%. In another aspect, the Li-PNFs can have an elongation at break ranging from about 10% to about 30%, about 10% to about 25%, about 10% to about 20%, about 15% to about 30%, or about 20% to about 30%. In various aspects, the Li-PNFs can have a surface area of about 5 m²/g to about 60 m²/g, about 15 m²/g to about 60 m²/g, about 25 m²/g to about 60 m²/g, about 35 m²/g to about 60 m²/g, about 45 m²/g to about 60 m²/g, about 5 m²/g to about 50 m²/g, about 5 m²/g to about 40 m²/g, about 5 m²/g to about 30 m²/g, about 5 m²/g to about 20 m²/g, about 15 m²/g to about 40 m²/g, or about 25 m²/g to about 50 m²/g. In another aspect, the Li-PNFs can have a porosity of about 5% to about 30%, about 15% to about 30%, about 5% to about 20%, about 5% to about 15%, or about 10% to about 25%.

### C. METHODS OF MAKING THE DISCLOSED COMPOSITIONS

Disclosed are methods of making the disclosed lithium porous nanosorbent fiber compositions, the method comprising: (a) preparing a Li/Al-LDH substrate using co-precipitation; (b) dissolving a polymer in a dissolving solution, thereby creating a polymer suspension; (c) adding the Li/Al-LDH substrate to the polymer suspension, thereby forming a Li/Al-LDH-polymer suspension; (d) electrospinning the Li/Al-LDH-polymer suspension, thereby forming a fibrous product; and (e) drying the fibrous product. In various aspects, adding the Li/Al-LDH substrate to the polymer suspension can be done at a LDH/polymer ratio of about 0.1:1 to about 10:1, about 1:10 to about 10:2, or about 1:10 to about 10:5. In various aspects, the Li/Al-LDH-polymer suspension can have a viscosity of about 100 mPa·s to about 100,000 MPa·s, about 100 mPa·s to about 50,000 MPa·s, or about 200 mPa·s to about 20,000 mPa·s.

In various aspects, preparing the Li/Al-LDH substrate using co-precipitation further comprises: combining a mixed salt solution comprising Li and Al with a base solution, thereby forming a mixture comprising an aqueous phase and a solid; and drying the solid. The solid, once dried, can be in the form of a powder. In a further aspect, the mixed salt solution can comprise a Li to Al molar ratio of about 0.1 to about 1.0, about 0.2 to about 1.0, about 0.3 to about 1.0, about 0.1 to about 0.8, about 0.1 to about 0.6, about 0.1 to about 0.4, or about 0.25.

In various aspects, the dissolving solution can comprise DMF. In a further aspect, the dissolving solution can have a temperature of about 333 K. In a still further aspect, dissolving the polymer in a dissolving solution can be done by stirring the polymer and the dissolving solution (e.g., with a stirring rod) for about 1 hour to about 5 hours or about 2 hours to about 3 hours. In a further aspect, the stirring can be done at a rate of about 500 rpm to about 1000 rpm or about 700 rpm to about 800 rpm.

In various aspects, the polymer can be selected from a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), and combinations thereof (e.g., copolymer thereof). In a further aspect, the polymer is polyacrylonitrile.

Electrospinning the Li/Al-LDH-polymer suspension can comprise pumping the Li/Al-LDH-polymer suspension into a high-voltage electric field of an electrospinning apparatus. In various aspects, the Li/Al-LDH-polymer suspension can be pumped at a pumping rate of about 1 mL/h to about 10 mL/h, or about 1 mL/h to about 5 mL/h, or about 3 mL/h to about 5 mL/h. In various aspects, the high-voltage electric field has a voltage of about 1 kV to about 30 kV, or about 5 kV to about 25 kV, or about 10 kV to about 20 kV, or about 17 kV to about 22 kV. In various aspects, the electrospinning is carried out at a humidity of about 10% to about 30%, or about 15% to about 25%, or about 17% to about 22%.

### D. METHODS OF USING THE DISCLOSED COMPOSITIONS

In one aspect, the present disclosure relates to methods of using the disclosed compositions, as disclosed herein throughout. The method of use can comprise: flowing a feedstock solution comprising lithium over a solid comprising a disclosed lithium porous nanosorbent fiber composition, thereby producing a first effluent; flowing an aqueous solution over the solid; and flowing a desorption solution over the solid, thereby producing a second effluent. The feedstock solution can be, for example, a brine (e.g., a salt lake brine). The aqueous solution can include, for example, water (e.g., deionized water) or a low concentration (e.g., about 0.01 M to about 0.1 M) inorganic salt solution (e.g., NaCl and/or NaNO₃). In one aspect, the desorption solution can be an aqueous solution comprising a lithium salt (e.g., LiCl or LiNO₃). In another aspect, the desorption solution can be an aqueous solution comprising no lithium.

In a further aspect, the solid can be a solid bed in a reaction chamber, where the solid bed comprises the disclosed lithium porous nanosorbent fiber composition. Flowing the feedstock solution over the solid can result at least some of the lithium present in the feedstock solution to be adsorbed onto the solid, resulting in the effluent (the solution resulting from the feedstock solution's flowing over and contacting the solid) containing less lithium than the feedstock solution. The first effluent can optionally be flowed over the solid again, and any resulting effluents can be treated in a similar manner, in order to allow the solid to adsorb additional lithium left behind in the solution. The feedstock solution can be flowed over the solid at a flow rate of about 1 mL/min to about 4 mL/min, about 1 mL/min to about 3 mL/min, about 1 mL/min to about 2 mL/min, about 2 mL/min to about 4 mL/min, or about 3 mL/min to about 4 mL/min. Following the adsorption step, a rinsing step can be performed. The aqueous solution can be flowed over the solid at a temperature of about −5° C. to about 5° C., about −5° C. to about 2° C., about −2°° C. to about 5° C., or about −3° C. to about 3° C.

The desorption solution can be flowed over the solid at a flow rate of about 1 mL/min to about 4 mL/min, about 1 mL/min to about 3 mL/min, about 1 mL/min to about 2 mL/min, about 2 mL/min to about 4 mL/min, or about 3 mL/min to about 4 mL/min. Additionally, in one aspect, the desorption solution can be flowed over the solid at a temperature of greater than or equal to about 10° C. or greater than or equal to about 10° C. In a further aspect, the desorption solution can be flowed over the solid at a temperature of about 10° C. to about 85° C., about 10° C. to about 80° C., about 10° C. to about 70° C., about 10° C. to about 60° C., about 10° C. to about 50° C., about 10° C. to about 40° C., about 20° C. to about 85° C., about 20° C. to about 80° C., about 20°° C. to about 70° C., about 20° C. to about 60° C., or about 20° C. to about 50° C. The desorption solution can include a low concentration of a lithium salt. For example, the desorption solution can have a lithium concentration of from about 0 ppm to about 200 ppm, about 1 ppm to about 200 ppm, about 1 ppm to about 150 ppm, about 1 ppm to about 100 ppm, about 1 ppm to about 50 ppm, about 25 ppm to about 200 ppm, about 25 ppm to about 150 ppm, about 25 ppm to about 100 ppm, about 50 ppm to about 200 ppm, about 50 ppm to about 150 ppm, or about 50 ppm to about 100 ppm. In another aspect, the desorption solution can include no lithium (e.g., 0 ppm of lithium). Flowing the desorption solution over the solid can result at least some of the lithium present in the solid to be desorbed into the solution, resulting in the effluent (the solution resulting from the desorption solution's flowing over and contacting the solid) containing more lithium than the desorption solution.

### E. REFERENCES

References are cited herein throughout using the format of superscripted reference number(s) enclosed by parentheses corresponding to one or more of the following numbered references. For example, citation of references numbers 1 and 2 immediately herein below would be indicated in the disclosure as (Refs. 1 and 2).
[Ref. 1] Wang, Q.; Yao, Z.; Wang, J.; Guo, H.; Li, C.; Zhou, D.; Bai, X.; Li, H.; Li, B.; Wagemaker, M.; Zhao, C. Chemical short-range disorder in lithium oxide cathodes. Nature 2024, 629 (8011), 341-347. DOI: 10.1038/s41586-024-07362-8.
[Ref. 2] Wan, H.; Wang, Z.; Zhang, W.; He, X.; Wang, C. Interface design for all-solid-state lithium batteries. Nature 2023, 623 (7988), 739-744. DOI: 10.1038/s41586-023-06653-w.
[Ref. 3] Du, H.; Wang, Y.; Kang, Y.; Zhao, Y.; Tian, Y.; Wang, X.; Tan, Y.; Liang, Z.; Wozny, J.; Li, T.; et al. Side Reactions/Changes in Lithium-Ion Batteries: Mechanisms and Strategies for Creating Safer and Better Batteries. Adv Mater 2024, e2401482. DOI: 10.1002/adma.202401482 From NLM Publisher.
[Ref. 4] Li, X.; Yao, Y.; Guo, B.; Wu, W.; Lu, S.; Qin, W.; Wu, X. Fe (III)/Fe (II) Redox-Based Lithium Extraction/Recovery from Liquid-and Solid-Phase Lithium Resources. ACS Energy Letters 2024, 9 (2), 758-767. DOI: 10.1021/acsenergylett.3c02635.
[Ref. 5] Wei, G.-Y.; Zhao, M.; Sperling, E. A.; Gaines, R. R.; Kalderon-Asael, B.; Shen, J.; Li, C.; Zhang, F.; Li, G.; Zhou, C.; et al. Lithium isotopic constraints on the evolution of continental clay mineral factory and marine oxygenation in the earliest Paleozoic Era. Science Advances 10 (13), eadk2152. DOI: 10.1126/sciadv.adk2152 (accessed 2024 May 8).
[Ref. 6] Schenker, V.; Bayer, P.; Oberschelp, C.; Pfister, S. Is lithium from geothermal brines the sustainable solution for Li-ion batteries? Renewable and Sustainable Energy Reviews 2024, 199, 114456. DOI: https://doi.org/10.1016/j.rser.2024.114456.
[Ref. 7] Wu, Q.; Bu, L.; Zhang, J.; Zhang, K.; Yu, J.; Li, J.; Solange, D.; He, Z.; Nie, Z. Study of the optimization of the stereo-crystallization process with enhanced salinity-gradient solar pond for lithium extraction from Zabuye salt lake in Tibet. Carbonates and Evaporites 2024, 39 (2). DOI: 10.1007/s13146-024-00921-0.
[Ref. 8] Mojid, M. R.; Lee, K. J.; You, J. A review on advances in direct lithium extraction from continental brines: Ion-sieve adsorption and electrochemical methods for varied Mg/Li ratios. Sustainable Materials and Technologies 2024, 40, e00923. DOI: https://doi.org/10.1016/j.susmat.2024.e00923.
[Ref. 9] Xie, X.-Y.; Huo, H.-Q.; Zhang, W.-H.; Zhao, Y.; Ji, Y.-L.; Van der Bruggen, B.; Gao, C.-J. Facile surface modification of cation exchange membranes via Debus-Radziszewski in-situ cross-linking for lithium extraction from salt-lakes. Chemical Engineering Journal 2024, 487, 150617. DOI: https://doi.org/10.1016/j.cej.2024.150617.
[Ref. 10] Alam, M. A.; Muñoz, A. A critical evaluation of the role of a geothermal system in lithium enrichment of brines in the salt flats: A case study from Laguna Verde in the Atacama Region of Chile. Geothermics 2024, 119, 102970. DOI: https://doi.org/10.1016/j.geothermics.2024.102970.
[Ref. 11] Zhou, J.; Xiang, S.; Wang, X.; Shin, D.-M.; Zhou, H. Highly selective lithium extraction from salt lake via carbon-coated lithium vanadium phosphate capacitive electrode. Chemical Journal 2024, 482, 148985. DOI: Engineering https://doi.org/10.1016/j.cej.2024.148985.
[Ref. 12] Chen, J.; Lian, C.; Yu, J.; Lin, S. A directional growth strategy for high layer charge Li/Al-LDHs to reinforce Li+ extraction in low-grade salt lake brines. AlChE Journal 2023, 70 (2). DOI: 10.1002/aic.18280.
[Ref. 13] Zhong, J.; Lin, S.; Yu, J. Li+ adsorption performance and mechanism using lithium/aluminum layered double hydroxides in low grade brines. Desalination 2021, 505. DOI: 10.1016/j.desal.2021.114983.
[Ref. 14] Pan, Y.; Zhang, Y.; Su, H.; Yu, J.; Lin, S. Enhancing lithium extraction from low grade salt lake brines using high powder loading aluminum-based adsorbent granules. Desalination 2024, 117696. DOI: https://doi.org/10.1016/j.desal.2024.117696.
[Ref. 15] Wei, Y.; Wei, S.; Liu, C.; Chen, T.; Tang, Y.; Ma, J.; Yin, K.; Luo, S. Efficient removal of arsenic from groundwater using iron oxide nanoneedle array-decorated biochar fibers with high Fe utilization and fast adsorption kinetics. Water Research 2019, 167, 115107. DOI: https://doi.org/10.1016/j.watres.2019.115107.
[Ref. 16] Li, R.; Yang, W.; Gao, S.; Shang, J.; Li, Q. Hydrous cerium oxides coated glass fiber for efficient and long-lasting arsenic removal from drinking water. Journal of Advanced Ceramics 2021, 10 (2), 247-257. DOI: 10.1007/s40145-020-0435-0.
[Ref. 17] Pan, Y.; Du, J.; Chen, J.; Lian, C.; Lin, S.; Yu, J. Interlayer intercalation of Li/Al-LDHs responsible for high-efficiency boron extraction. Desalination 2022, 539. DOI: 10.1016/j.desal.2022.115966
[Ref. 18] Blochl, P. E. Projector augmented-wave method. Phys Rev B Condens Matter 1994, 50 (24), 17953-17979. DOI: 10.1103/physrevb.50.17953 From NLM PubMed-not-MEDLINE.
[Ref. 19] J.P. Perdew, K. B., M. Ernzerhof. Generalized gradient approximation made simple. Rev. Lett. 1996, 77 (18), 3865-3868.
[Ref. 20] Kondratiev, A.; Ilyushechkin, A. Flow behaviour of crystallising coal ash slags: Shear viscosity, non-Newtonian flow and temperature of critical viscosity. Fuel 2018, 224, 783-800. DOI: https://doi.org/10.1016/j.fuel.2018.03.031.
[Ref. 21] Lv, W.; Mei, Q.; Du, M.; Xiao, J.; Ye, W.; Zheng, Q. Interaction between Poly (vinyl alcohol) and Layered Double Hydroxide (LDH) Particles with Different Topological Shape and Their Application in Electrospinning. The Journal of Physical Chemistry C 2016, 120 (26), 14435-14443. DOI: 10.1021/acs.jpcc.6b04783.
[Ref. 22] Barnes, H. A.; Edwards, M. F.; Woodcock, L. V. Applications of computer simulations to dense suspension rheology. Chemical Engineering Science 1987, 42 (4), 591-608. DOI: https://doi.org/10.1016/0009-2509 (87) 80021-0.
[Ref. 23] Snider, D. M. An Incompressible Three-Dimensional Multiphase Particle-in-Cell Model for Dense Particle Flows. Journal of Computational Physics 2001, 170 (2), 523-549. DOI: https://doi.org/10.1006/jcph.2001.6747.
[Ref. 24] Costa, F. R.; Wagenknecht, U.; Jehnichen, D.; Goad, M. A.; Heinrich, G. Nanocomposites based on polyethylene and Mg—Al layered double hydroxide. Part II. Rheological characterization. Polymer 47 2006, (5), 1649-1660. DOI: https://doi.org/10.1016/j.polymer.2005.12.011.
[Ref. 25] Visser, D. C.; Hoefsloot, H. C. J.; ledema, P. D. Modelling multi-viscosity systems with dissipative particle dynamics. Journal of Computational Physics 2006, 214 (2), 491-504. DOI: https://doi.org/10.1016/j.jcp.2005.09.022.
[Ref. 26] Kretz, V.; Berest, P.; Hulin, J. P.; Salin, D. An experimental study of the effects of density and viscosity contrasts on macrodispersion in porous media. Water Resources Research 2003, 39 (2). DOI: 10.1029/2001wr001244.
[Ref. 27] Rodríguez de Castro, A.; Oostrom, M.; Shokri, N. Effects of shear-thinning fluids on residual oil formation in microfluidic pore networks. Journal of Colloid and Interface Science 2016, 472, 34-43. DOI: https://doi.org/10.1016/j.jcis.2016.03.027.
[Ref. 28] Pourchet, S.; Pochard, I.; Brunel, F.; Perrey, D. Chemistry of the calcite/water interface: Influence of sulfate ions and consequences in terms of cohesion forces. Cement and Concrete Research 2013, 52, 22-30. DOI: https://doi.org/10.1016/j.cemconres.2013.04.002.
[Ref. 29] Naing, K. S. S.; Tabe, Y.; Chikahisa, T. Performance and liquid water distribution in PEFCs with different anisotropic fiber directions of the GDL. Journal of Power Sources 2011, 196 (5), 2584-2594. DOI: https://doi.org/10.1016/j.jpowsour.2010.10.080.
[Ref. 30] Najafi, M.; Avci, H.; Kotek, R. High-performance filaments by melt spinning low viscosity nylon 6 using horizontal isothermal bath process. Polymer Engineering & Science 2015, 55 (11), 2457-2464. DOI: 10.1002/pen.24135.
[Ref. 31] Serrano, J. M.; Liu, T.; Khan, A. U.; Botset, B.; Stovall, B. J.; Xu, Z.; Guo, D.; Cao, K.; Hao, X.; Cheng, S.; Liu, G. Composition Design of Block Copolymers for Porous Carbon Fibers. Chemistry of Materials 2019, 31 (21), 8898-8907. DOI: 10.1021/acs.chemmater.9b02918.
[Ref. 32] Zhou, Z.; Liu, T.; Khan, A. U.; Liu, G. Block copolymer-based porous carbon fibers. Science Advances 5 (2), eaau6852. DOI: 10.1126/sciadv.aau6852 (accessed 2024 Apr. 22).
[Ref. 33] Zhou, Z.; Liu, T.; Khan, A. U.; Liu, G. Controlling the physical and electrochemical properties of block copolymer-based porous carbon fibers by pyrolysis temperature. Molecular Systems Design & Engineering 2020, 5 (1), 153-165, 10.1039/C9ME00066F. DOI: 10.1039/C9ME00066F.
[Ref. 34] Reardon, B. J.; Hubbard, C. R. A Review of the XRD Data of the Phases Present in the CaO—SrO—CuO System. Powder Diffraction 1992, 7 (3), 142-148. DOI: 10.1017/S0885715600018492 From Cambridge University Press Cambridge Core.
[Ref. 35] Sun, S.; Zhou, F.; Pan, F.; Wang, M.; Mao, J. Hydrazine Hydrate-Initiated GO/PAN Composite Fiber Cyclization Reaction to Achieve Chemical Stabilization of PAN. ACS Sustainable Chemistry & Engineering 2023, 11 (39), 14481-14486. DOI: 10.1021/acssuschemeng.3c03476.
[Ref. 36] Li, L.; Liu, K.; Lin, Y.; Wen, W.; Ding, S.; Liu, M.; Zhou, C.; Luo, B. Abundant nucleation sites-available liquid crystal hydrogel mimics bone ECM mineralization to boost osteogenesis. Composites Part B: Engineering 2024, 275, 111340. DOI: https://doi.org/10.1016/j.compositesb.2024.111340.
[Ref. 37] Zhu, H.; Chen, Y.; He, B.; Chen, Q.; Malik, H.; Wang, Y.; He, J.; Ma, B.; Wang, X.; Zhang, H.; Liu, Y. Effects of NalO4 treatment on the chemical and physical properties of polyacrylonitrile fibers. International Journal of Polymer Analysis and Characterization 2024, 29 (1), 1-14. DOI: 10.1080/1023666X.2023.2295630.
[Ref. 38] Chen, J.; Du, J.; Yu, J.; Lin, S. A one-step regeneration method in-situ for deactivated aluminum-based lithium adsorbent used in high Mg2+/Li+ brines. Desalination 2023, 554. DOI: 10.1016/j.desal.2023.116491.
[Ref. 39] Wang, Q.; Bai, W.; Lu, X.; Wang, J.; Pakdel, E.; Yu, Z.; Cui, Y.; Liu, Q. Thermally oxidized PAN as photocatalyst support layer for VOCs removal. The Journal of The Textile Institute, 1-9. DOI: 10.1080/00405000.2023.2240058.
[Ref. 40] Sudapalli, A.; Shimpi, N. Investigation of the Photocatalytic Activity of Electrospun and Surface-Modified PAN/α-FeOOH Nanofibers for the Degradation of Hazardous Azo Dyes. Langmuir 2023, 39 (44), 15517-15534. DOI: 10.1021/acs.langmuir.3c01779.
[Ref. 41] Kanani-Jazi, M. H.; Akbari, S. Quantitative XPS analysis of amine-terminated dendritic functionalized halloysite nanotubes decorated on PAN nanofibrous membrane and adsorption/filtration of Cr (VI). Chemical Engineering Journal 2024, 482, 148746. DOI: https://doi.org/10.1016/j.cej.2024.148746.
[Ref. 42] Li, Z.; Ma, Y.; Guo, X.; Cao, Y.; Jiang, Q.; Gao, M.; Liu, X.; Tsang, D. C. W.; Jiang, Z.; Shi, B. Composite fiber as a multifunctional catalyst support for the upgradation of lignin-based chemicals. Green Chemistry 2024, 10.1039/D3GC04579J. DOI: 10.1039/D3GC04579J.
[Ref. 43] Pan, Y.; Yin, S.; Yu, J.; Lin, S. Efficient Step-by-Step Desorption to Reduce Boron in Brine Lithium Extraction. Industrial & Engineering Chemistry Research 2024, 63 (1), 471-479. DOI: 10.1021/acs.iecr.3c03081.
[Ref. 44] Baudino, L.; Santos, C.; Pirri, C. F.; La Mantia, F.; Lamberti, A. Recent advances in the lithium recovery from water resources: From passive to electrochemical methods. Advanced Science 2022, 9 (27), 2201380.
[Ref. 45] Zhang, P.; Wang, X.; Zhang, Y.; Wei, Y.; Shen, N.; Chen, S.; Xu, B. Burgeoning Silicon/MXene Nanocomposites for Lithium Ion Batteries: A Review. Advanced Functional Materials 2024. DOI: 10.1002/adfm.202402307.
[Ref. 46] Alkhedher, M.; Al Tahhan, A. B.; Yousaf, J.; Ghazal, M.; Shahbazian-Yassar, R.; Ramadan, M. Electrochemical and thermal modeling of lithium-ion batteries: A review of coupled approaches for improved thermal performance and safety lithium-ion batteries. Journal of Energy Storage 2024, 86, 111172. DOI: https://doi.org/10.1016/j.est.2024.111172.
[Ref. 47] Kumar, R.; Das, K. Lithium battery prognostics and health management for electric vehicle application—A perspective review. Sustainable Energy Technologies and Assessments 2024, 65, 103766.
[Ref. 48] Wali, S. B.; Hannan, M. A.; Ker, P. J.; Rahman, S. A.; Le, K. N.; Begum, R. A.; Tiong, S. K.; Mahlia, T. M. I. Grid-connected lithium-ion battery energy storage system towards sustainable energy: A patent landscape analysis and technology updates. Journal of Energy Storage 2024, 77, 109986. DOI: https://doi.org/10.1016/j.est.2023.109986.
[Ref. 49]Xue, J. X.; Liu, F. Q.; Xiang, T. Q.; Jia, S. X.; Zhou, J. J.; Li, L. In Situ Forming Gel Polymer Electrolyte for High Energy-Density Lithium Metal Batteries. Small 2024, 20 (4), 2307553.
[Ref. 50]Dugamin, E. J.; Richard, A.; Cathelineau, M.; Boiron, M.-C.; Despinois, F.; Brisset, A. Groundwater in sedimentary basins as potential lithium resource: a global prospective study. Scientific reports 2021, 11 (1), 21091.
[Ref. 51] Kim, M. S.; Cha, D.; Lee, S. M.; Jeong, H.; Lee, C. Prediction of brine evaporation rate in a pond: Development of different models under controlled meteorological conditions and comparative evaluation. Desalination 2023, 551, 116415. DOI: https://doi.org/10.1016/j.desal.2023.116415.
[Ref. 52] Lalasari, L. H.; Sulistiyono, E.; Harjanto, S.; Irawan, Y.; Firdiyono, F.; Arini, T.; Andriyah, L.; Suharyanto, A.; Natasha, N. C.; Yunita, F. E. The Effect of pH and Sodium Silicate Dosage on the Separation of Magnesium and Lithium from Artificial Brine Water Using Chemical Precipitation Techniques. Metalurgi 2023, 38 (3), 101-108.
[Ref. 53] Guo, L.-P.; Guo, Z.-Y.; Wang, J.; Zhang, P.-P.; Huang, Z.-H.; Ji, Z.-Y. Flexible lithium selective composite membrane for direct lithium extraction from high Na/Li ratio brine. Journal of Membrane Science 2024, 703, 122843.
[Ref. 54] Raiguel, S.; Nguyen, V. T.; Reis Rodrigues, I.; Deferm, C.; Riaño, S.; Binnemans, K. Recovery of lithium from simulated nanofiltration-treated seawater desalination brine using solvent extraction and selective precipitation. Solvent Extraction and Ion Exchange 2023, 41 (4), 425-448.
[Ref. 55] Luo, G.; Li, X.; Chen, L.; Gu, J.; Huang, Y.; Sun, J.; Liu, H.; Chao, Y.; Zhu, W.; Liu, Z. Electrochemical recovery lithium from brine via taming surface wettability of regeneration spent batteries cathode materials. Applied Energy 2023, 337. DOI: 10.1016/j.apenergy.2023.120890.
[Ref. 56] Boroumand, Y.; Razmjou, A. Adsorption-type aluminium-based direct lithium extraction: The effect of heat, salinity and lithium content. Desalination 2024, 577, 117406. DOI: https://doi.org/10.1016/j.desal.2024.117406.
[Ref. 57] Kameliya, J.; Verma, A.; Dutta, P.; Arora, C.; Vyas, S.; Varma, R. S. Layered double hydroxide materials: A review on their preparation, characterization, and applications. Inorganics 2023, 11 (3), 121.
[Ref. 58] Zhang, R.; Guo, Y.; Yu, J.; Lin, S. Interlayer confinement imprinting to enhance the feasibility of Li/Al-LDHs in lithium extraction from sulfate-type brines. Applied Surface Science 2023, 639, 158241.
[Ref. 59] Pan, Y.; Zhang, Y.; Su, H.; Yu, J.; Lin, S. Enhancing lithium extraction from low grade salt lake brines using high powder loading aluminum-based adsorbent granules. Desalination 2024, 117696. DOI: https://doi.org/10.1016/j.desal.2024.117696.
[Ref. 60] Malik, S.; Muhammad, K.; Waheed, Y. Nanotechnology: A revolution in modern industry. Molecules 2023, 28 (2), 661.
[Ref. 61] Mohammed, N.; Nawar, S. H.; Etawy, M. S.; Nassar, G. E.; Hassabo, A. G. Nanotechnology and its applications in industry and product design. Journal of Textiles, Coloration and Polymer Science 2024, 21 (2), 273-284.
[Ref. 62] Kumar, A.; Jayeoye, T. J.; Mohite, P.; Singh, S.; Rajput, T.; Munde, S.; Eze, F. N.; Chidrawar, V. R.; Puri, A.; Prajapati, B. G. Sustainable and consumer-centric nanotechnology-based materials: An update on the multifaceted applications, risks and tremendous opportunities. Nano-Structures & Nano-Objects 2024, 38, 101148.
[Ref. 63] Behpour, M.; Shadi, M.; Nojavan, S. Preparation of an efficient magnetic nano-sorbent based on modified cellulose and carboxylated carbon nano-tubes for extraction of pesticides from food and agricultural water samples before GC-FID analysis. Food Chemistry 2023, 407, 135067. DOI: https://doi.org/10.1016/j.foodchem.2022.135067.
[Ref. 64] Ji, D.; Lin, Y.; Guo, X.; Ramasubramanian, B.; Wang, R.; Radacsi, N.; Jose, R.; Qin, X.; Ramakrishna, S. Electrospinning of nanofibres. Nature Reviews Methods Primers 2024, 4 (1), 1.
[Ref. 65] Chen, D.; Zhao, X.; Shi, M.; Fu, X.; Hu, W.; Shi, X.; Zhao, R.; Zhu, G. Enhanced and selective uranium extraction onto electrospun nanofibers by regulating the functional groups and photothermal conversion performance. Chemical Engineering Journal 2024, 480, 148108. DOI: https://doi.org/10.1016/j.cej.2023.148108.
[Ref. 66] Li, X.; Wang, Z.; Zhang, H.; Zhang, W.; Jiang, J.; Guo, R. An ion-sieve-tailored biomimetic porous nanofiber as an efficient adsorbent for extraction of lithium from brine. New Journal of Chemistry 2023, 47 (9), 4187-4191.
[Ref. 67] Clark; Robert, M. J. E. e.; Technology. Evaluating the cost and performance of field-scale granular activated carbon systems. 1987, 21 (6), 573.
[Ref. 68] Thomas; Henry, C. J. J. o. t. A. C. S. Heterogeneous Ion Exchange in a Flowing System. 1944, 66 (10), 1664-1666.
[Ref. 69] Recepoglu, Y.; Kabay, N.; Ipek, I.; Yilmaz; Arda, M. Packed bed column dynamic study for boron removal from geothermal brine by a chelating fiber and breakthrough curve analysis by using mathematical models. Desalination 2018, 437, 1-6.
[Ref. 70] Yan, G.; Viraraghavan, T. Heavy metal removal in a biosorption column by immobilized M. rouxii biomass. Bioresource Technology 2001, 78 (3), 243-249. DOI: https://doi.org/10.1016/S0960-8524 (01) 00020-7.
[Ref. 71] Han, L.; Wang, Y.-F.; Zhou, X.-H.; Zhu, L.; Shan, X.-Y.; Cui, W.-Q.; Gao, Y.; Lyu, L.-H. Highly Compressible and Lightweight Al2O3/PCNF@ANF Aerogels for Effective Oil Adsorption and Separation. Fibers and Polymers 2024, 25 (6), 2375-2387. DOI: 10.1007/s12221-024-00539-y.
[Ref. 72] Pan, X.; Luo, X.; Li, J.; Zhang, X.; Yu, X.; Zhou, C.; Chen, B.; Liu, Y. Superhydrophobicity and high corrosion resistance of secondary alkane sulphonate (SAS) modified Li—Al LDH film in-situ grown on aluminum alloy. Corrosion Communications 2023, 9, 27-35. DOI: https://doi.org/10.1016/j.corcom.2022.05.005.
[Ref. 73] Pan, Y.; Du, J.; Chen, J.; Lian, C.; Lin, S.; Yu, J. Interlayer intercalation of Li/Al-LDHs responsible for high-efficiency boron extraction. Desalination 2022, 539. DOI: 10.1016/j.desal.2022.115966.
[Ref. 74] Pan, Y.; Ji, B.; Zhang, W. Charge transfer-driven enhanced lithium extraction using poly (acrylic) acid-modified layered double hydroxide. Chemical Engineering Journal 2024, 494, 152939. DOI: https://doi.org/10.1016/j.cej.2024.152939.
[Ref. 75] Lyu, S.; Zhang, X.; Huang, S.; Wang, S.; Xiao, M.; Han, D.; Meng, Y. Long-Term Stable Cycling of Dendrite-Free Lithium Metal Batteries Using ZIF-90@PP Composite Separator. In Nanomaterials, 2024; Vol. 14.
[Ref. 76] Chen, J.; Lian, C.; Yu, J.; Lin, S. A directional growth strategy for high layer charge Li/Al-LDHs to reinforce Li+ extraction in low-grade salt lake brines. AlChE Journal 2023, 70 (2). DOI: 10.1002/aic.18280.
[Ref. 77] Chennam, P. K.; Kachlík, M.; Říhová, M.; Čičmancová, V.; Maca, K.; Macak, J. M. Synthesis of centrifugally spun polyacrylonitrile-carbon fibers. Journal of Materials Research and Technology 2024, 28, 2199-2205. DOI: https://doi.org/10.1016/j.jmrt.2023.12.146.
[Ref. 78] Li, Y.; Hai, C.; Huo, J.; Pan, W.; Chen, T.; Li, X.; He, X.; Sun, Y.; Dong, S.; Ma, L.; et al. Performance activation mechanism of aluminum-based layered double hydroxides adsorbents for recovering Li+ by pH modulating. Chemical Engineering Journal 2024, 494, 152919. DOI: https://doi.org/10.1016/j.cej.2024.152919.
[Ref. 79] Wang, L.; Gao, L.; Zuo, C.; Tan, W.; Ren, Y.; Liu, X. A novel phosphorus/nitrogen-containing polyacrylonitrile fiber with excellent flame retardancy and mechanical properties. Polymer Degradation and Stability 2024, 223, 110716. DOI: https://doi.org/10.1016/j.polymdegradstab.2024.110716.
[Ref. 80] Silva, M. C.; Crespo, L. H. S.; Cazetta, A. L.; Silva, T. L.; Spessato, L.; Almeida, V. C. Activated carbon fibers of high surface area from corn husk: Mono and multicomponent adsorption studies of Pb2+ and Cu2+ ions from aqueous solution. Journal of Molecular Liquids 2024, 405, 124919. DOI: https://doi.org/10.1016/j.molliq.2024.124919.
[Ref. 81] Zhang, X.; Liang, Y.; You, T.; Tian, L.; Xu, G.; Yang, C.; Xiao, J.; Tang, M. The influence of activated carbon fiber paper structure on adsorption performance of cyclohexane. Separation and Purification Technology 2024, 348, 127740. DOI: https://doi.org/10.1016/j.seppur.2024.127740.
[Ref. 82] Pan, Y. n.; Ji, B.; Zhang, W.; Xia, Y.; Li, Q.; Rena, B. Selective extraction of lithium from shale gas produced water using an aluminum-based adsorbent. Green and Smart Mining Engineering 2024. DOI: https://doi.org/10.1016/j.gsme.2024.05.002.
[Ref. 83] Zhong, J.; Lin, S.; Yu, J. Li+ adsorption performance and mechanism using lithium/aluminum layered double hydroxides in low grade brines. Desalination 2021, 505, 114983. DOI: https://doi.org/10.1016/j.desal.2021.114983.
[Ref. 84] Tian, Y.; Yang, W.; Xie, J.; Zhang, F.; Yang, C.; Liu, Z.; Xu, L.; Zhao, Z. Separation effect of Li+, Na+, and Mg2+with alumina-lithium LDH doped with amorphous titanium dioxide. Journal of Water Process Engineering 2024, 60, 105256. DOI: https://doi.org/10.1016/j.jwpe.2024.105256.
[Ref. 85] Ding, T.; Zheng, M.; Lin, Y. Adsorption of Li(I) Ions through New High-Performance Electrospun PAN/Kaolin Nanofibers: A Combined Experimental and Theoretical Calculation. ACS Omega 2022, 7 (13), 11430-11439. DOI: 10.1021/acsomega.2c00658.
[Ref. 86] Ye, Z.; Xu, D.; Zhong, J.; Gao, S.; Wang, J.; Zhang, Y.; Xu, H.; Li, Y.; Li, W. Influence of Soil Colloids on the Transport of Cd2+ and Pb2+ under Different pH and Ionic Strength Conditions. In Agronomy, 2024; Vol. 14.
[Ref. 87] de Oliveira, J. T.; Estumano, D. C.; Féris, L. A. Resolution methods for adsorption models, batch and continuous mode, and its impact on process implementation: An experimental and statistical comparison. Journal of Water Process Engineering 2024, 58, 104888. DOI: https://doi.org/10.1016/j.jwpe.2024.104888.
[Ref. 88] Iroh, I. N.; Okeh, O. C.; Igbokwe, V. C.; Ezugworie, F. N.; Onyema, V. O.; Onwosi, C. O. Congo red removal from aqueous solution by a consortium of Aspergillus sp. immobilized on activated carbon in a packed bed column: modelling of the breakthrough curves. Bioremediation Journal, 1-19. DOI: 10.1080/10889868.2024.2337175.
[Ref. 89] Toffoli de Oliveira, J.; da Luz Arsufi, A. B.; Cardoso Estumano, D.; Feris, L. A. Bayesian Computational Technique for Modeling Caffeine Adsorption in a Fixed-Bed Column: Use of the Maximum Adsorption Capacity Deterministically and Experimental Design. Industrial & Engineering Chemistry Research 2023, 62 (18), 7127-7137. DOI: 10.1021/acs.iecr.3c00303.
[Ref. 90] Ordonez, D.; Valencia, A.; Chang, N.-B. Exploring shared adsorption capacity and thermodynamics for simultaneous removal of microcystin and phosphorus via green sorption media in eutrophic water. Sustainable Materials and Technologies 2023, 38, e00777. DOI: https://doi.org/10.1016/j.susmat.2023.e00777.
[Ref. 91] García-Sánchez, J. T.; Valderrama-Zapata, R.; Acevedo-Córdoba, L. F.; Pérez-Martínez, D.; Rincón-Ortiz, S.; Baldovino-Medrano, V. G. Calculation of Mass Transfer Limitations for a Gas-Phase Reaction in an Isothermal Fixed Bed Reactor: Tutorial and Sensitivity Analysis. ACS Catalysis 2023, 13 (10), 6905-6918. DOI: 10.1021/acscatal.3c01282.
[Ref. 92] Jing, Z.; Qiwei, L.; Sen, L.; Jianguo, Y. Washing and desorption procedures research on granulated lithium aluminum layered double hydroxides for lithium recovery from low-grade brine. Chemical Industry and Engineering Progress 2021, 40 (8), 4638.
[Ref. 93] Carneiro, M. A.; Silva, T. A.; Teixeira, P. J. S.; Boaventura, R. A. R.; Botelho, C. M. S.; Pintor, A. M. A. New insights on antimony removal and recovery from water and wastewater using iron-coated cork granulates: Desorption on batch and fixed-bed column systems. Chemical Engineering Science 2024, 296, 120207. DOI: https://doi.org/10.1016/j.ces.2024.120207.

### F. ASPECTS

The following listing of exemplary aspects supports and is supported by the disclosure provided herein.
Aspect 1. A lithium porous nanosorbent fiber composition comprising: an LDH (Layered Double Hydroxide) substrate; and a polymer attached to the LDH substrate; wherein the lithium porous nanosorbent fiber composition has a fibrous structure.
Aspect 2. The lithium porous nanosorbent fiber composition of aspect 1, wherein the fibrous structure of the lithium porous nanosorbent fiber composition is formed by an electrospinning fabrication process.
Aspect 3. The lithium porous nanosorbent fiber composition of aspect 1 or aspect 2, wherein the LDH substrate is Li/Al-LDH.
Aspect 4. The lithium porous nanosorbent fiber composition of any one of aspects 1-3, wherein the polymer is selected from a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), and combinations thereof.
Aspect 5. The lithium porous nanosorbent fiber composition of aspect 4, wherein the polymer is selected from polyacrylonitrile (PAN), polyvinylidene fluoride (PVDF), polyvinyl chloride (PVC), and combinations thereof.
Aspect 6. The lithium porous nanosorbent fiber composition of aspect 4, wherein the polymer is polyacrylonitrile.
Aspect 7. The lithium porous nanosorbent fiber composition of aspect 4, wherein the polymer is polyvinylidene fluoride.
Aspect 8. The lithium porous nanosorbent fiber composition of aspect 4, wherein the polymer is polyvinyl chloride.
Aspect 9. The lithium porous nanosorbent fiber composition of aspect 4, wherein the polymer is polyethylene glycol.
Aspect 10. The lithium porous nanosorbent fiber composition of aspect 4, wherein the polymer is polyacrylic acid.
Aspect 11. The lithium porous nanosorbent fiber composition of aspect 4, wherein the polymer is polylactic acid.
Aspect 12. The lithium porous nanosorbent fiber composition of aspect 4, wherein the polymer is polypropylene.
Aspect 13. The lithium porous nanosorbent fiber composition of aspect 4, wherein the polymer is poly (ethylene terephthalate).
Aspect 14. The lithium porous nanosorbent fiber composition of aspect 4, wherein the polymer is polystyrene.
Aspect 15. The lithium porous nanosorbent fiber composition of any one of aspects 1-14, wherein the fibrous structure of the lithium porous nanosorbent fiber composition is porous.
Aspect 16. The lithium porous nanosorbent fiber composition of any one of aspects 1-15, wherein the polymer has a molecular weight from about 10,000 Da to about 500,000 Da.
Aspect 17. The lithium porous nanosorbent fiber composition of aspect 16, wherein the polymer has a molecular weight from about 100,000 Da to about 300,000 Da.
Aspect 18. The lithium porous nanosorbent fiber composition of aspect 16, wherein the polymer has a molecular weight from about 125,000 Da to about 175,000 Da.
Aspect 19. The lithium porous nanosorbent fiber composition of any one of aspects 1-18, wherein the lithium porous nanosorbent fiber composition comprises a plurality of fibers, wherein an individual fiber of the plurality of fibers has a diameter of from about 50 nm to about 2000 nm.
Aspect 20. The lithium porous nanosorbent fiber composition of aspect 19, wherein the individual fiber of the plurality of fibers has a diameter of from about 100 nm to about 600 nm.
Aspect 21. The lithium porous nanosorbent fiber composition of aspect 19, wherein the individual fiber of the plurality of fibers has a diameter of from about 100 nm to about 200 nm.
Aspect 22. The lithium porous nanosorbent fiber composition of any one of aspects 1-21, wherein the lithium porous nanosorbent fiber composition has a lithium adsorption capacity of about 0.1 mg/g to about 50 mg/g.
Aspect 23. The lithium porous nanosorbent fiber composition of aspect 22, wherein the lithium porous nanosorbent fiber composition has a lithium adsorption capacity of about 0.1 mg/g to about 40 mg/g.
Aspect 24. The lithium porous nanosorbent fiber composition of aspect 22, wherein the lithium porous nanosorbent fiber composition has a lithium adsorption capacity of about 5 mg/g to about 30 mg/g.
Aspect 25. The lithium porous nanosorbent fiber composition of any one of aspects 1-24, wherein the concentration of the LDH substrate in the lithium porous nanosorbent fiber composition is from about 20 wt/v % to about 80 wt/v %.
Aspect 26. The lithium porous nanosorbent fiber composition of any one of aspects 1-25, wherein the lithium porous nanosorbent fiber composition has a weight ratio of the LDH substrate to the polymer of from about 1:1 to about 1:100.
Aspect 27. The lithium porous nanosorbent fiber composition of aspect 26, wherein the weight ratio of the LDH substrate to the polymer is from about 1:1 to about 1:50.
Aspect 28. The lithium porous nanosorbent fiber composition of aspect 26, wherein the weight ratio of the LDH substrate to the polymer is from about 1:1 to about 1:20.
Aspect 29. The lithium porous nanosorbent fiber composition of aspect 26, wherein the weight ratio of the LDH substrate to the polymer is from about 1:1 to about 1:10.
Aspect 30. The lithium porous nanosorbent fiber composition of aspect 26, wherein the weight ratio of the LDH substrate to the polymer is from about 1:1 to about 1:5.
Aspect 31. The lithium porous nanosorbent fiber composition of aspect 26, wherein the weight ratio of the LDH substrate to the polymer is from about 1:1 to about 1:2.
Aspect 32. The lithium porous nanosorbent fiber composition of any one of aspects 1-31, wherein the polymer is a block copolymer comprising two or more blocks; and wherein each individual block is independently selected from a polymer block comprising a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), or combinations thereof.
Aspect 33. The lithium porous nanosorbent fiber composition of aspect 32, wherein each individual block comprises two or more of a PAN, a PVDF, a PVC, or combinations thereof.
Aspect 34. The lithium porous nanosorbent fiber composition of any one of aspects 1-31, wherein the polymer is a gradient copolymer comprising a first gradient block comprising a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), or combinations thereof; and wherein the gradient copolymer comprises a higher concentration of the first gradient block at a first terminus of the gradient copolymer and a lower concentration of the first gradient block at a second terminus of the gradient copolymer distal to the first terminus.
Aspect 35. The lithium porous nanosorbent fiber composition of aspect 34, wherein the first gradient block is selected from PAN, PVDF, PVC, and combinations thereof.
Aspect 36. The lithium porous nanosorbent fiber composition of any one of aspects 1-35, wherein the fibrous structure comprises electrospun fibers.
Aspect 37. The lithium porous nanosorbent fiber composition of any one of aspects 1-36, wherein the lithium porous nanosorbent fiber composition has a yield stress of at least about 0.5 MPa.
Aspect 38. The lithium porous nanosorbent fiber composition of any one of aspects 1-36, wherein the lithium porous nanosorbent fiber composition has a yield stress of about 0.5 MPa to about 1.0 MPa.
Aspect 39. The lithium porous nanosorbent fiber composition of any one of aspects 1-38, wherein the lithium porous nanosorbent fiber composition has a tensile strength of at least about 2.0 MPa.
Aspect 40. The lithium porous nanosorbent fiber composition of any one of aspects 1-38, wherein the lithium porous nanosorbent fiber composition has a tensile strength of about 2.0 MPa to about 4.0 MPa.
Aspect 41. The lithium porous nanosorbent fiber composition of any one of aspects 1-40, wherein the lithium porous nanosorbent fiber composition has an elongation at break of at least about 10%.
Aspect 42. The lithium porous nanosorbent fiber composition of any one of aspects 1-40, wherein the lithium porous nanosorbent fiber composition has an elongation at break of about 10% to about 30%.
Aspect 43. The lithium porous nanosorbent fiber composition of any one of aspects 1-42, wherein the lithium porous nanosorbent fiber composition has a porosity of about 5% to about 30%.
Aspect 44. The lithium porous nanosorbent fiber composition of any one of aspects 1-43, wherein the lithium porous nanosorbent fiber composition has a surface area of about 5 m2/g to about 60 m2/g.
Aspect 45. A method for fabrication of porous nanosorbent fibers, the method comprising: a. preparing a Li/Al-LDH substrate using co-precipitation; b. dissolving a polymer in a dissolving solution, thereby creating a polymer suspension; c. adding the Li/Al-LDH substrate to the polymer suspension, thereby forming a Li/Al-LDH-polymer suspension; d. electrospinning the Li/Al-LDH-polymer suspension, thereby forming a fibrous product; and e. drying the fibrous product.
Aspect 46. The method of aspect 44, wherein preparing the Li/Al-LDH substrate using co-precipitation comprises: i. combining a mixed salt solution comprising Li and Al with a base solution, thereby forming a mixture comprising an aqueous phase and a solid; and ii. drying the solid.
Aspect 47. The method of aspect 46, wherein the mixed salt solution comprises a Li to Al molar ratio of about 0.1 to about 1.0.
Aspect 48. The method of any one of aspects 44-47, wherein the dissolving solution comprises DMF.
Aspect 49. The method of any one of aspects 44-48, wherein the dissolving solution has a temperature of about 333 K.
Aspect 50. The method of any one of aspects 44-49, wherein dissolving the polymer in the dissolving solution comprises stirring the polymer and the dissolving solution for about 1 hour to about 5 hours.
Aspect 51. The method of any one of aspects 44-49, wherein dissolving the polymer in the dissolving solution comprises stirring the polymer and the dissolving solution for about 2 hours to about 3 hours.
Aspect 52. The method of aspect 50 or aspect 51, wherein the polymer and the dissolving solution are stirred at a rate of about 500 rpm to about 1000 rpm.
Aspect 53. The method of aspect 50 or aspect 51, wherein the polymer and the dissolving solution are stirred at a rate of about 700 rpm to about 800 rpm.
Aspect 54. The method of aspect 50 or aspect 51, wherein the polymer and the dissolving solution are stirred at a rate of about 800 rpm.
Aspect 55. The method of any one of aspects 44-54, wherein the polymer is selected from a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), and combinations thereof.
Aspect 56. The method of aspect 55, wherein the polymer is PAN.
Aspect 57. The method of any one of aspects 44-56, wherein electrospinning the Li/Al-LDH-polymer suspension comprises pumping the Li/Al-LDH-polymer suspension into a high-voltage electric field of an electrospinning apparatus.
Aspect 58. The method of aspect 57, wherein the pumping is carried out at a pumping rate of about 1 mL/h to about 10 mL/h.
Aspect 59. The method of aspect 57 or aspect 58, wherein the high-voltage electric field has a voltage of about 1 kV to about 30 kV.
Aspect 60. The method of any one of aspects 44-59, wherein the electrospinning is carried out at a humidity about 10% to about 30%.
Aspect 61. The method of any one of aspects 44-60, wherein adding the Li/Al-LDH substrate to the polymer suspension is done at a LDH to polymer ratio of about 0.1:1 to about 10:1.
Aspect 62. The method of any one of aspects 44-61, wherein the Li/Al-LDH-polymer suspension has a viscosity of about 100 mPa·s to about 100,000 mPa·s.
Aspect 63. A method, comprising: a. flowing a feedstock solution comprising lithium over a solid comprising the lithium porous nanosorbent fiber composition of any one of aspects 1-43, thereby producing a first effluent; b. flowing an aqueous solution over the solid; and c. flowing a desorption solution over the solid, thereby producing a second effluent.
Aspect 64. The method of aspect 63, further comprising collecting the second effluent.
Aspect 65. The method of aspect 63 or aspect 64, further comprising flowing the first effluent over the solid prior to flowing the aqueous solution over the solid.
Aspect 66. The method of any one of aspects 63-65, wherein the feedstock solution is a brine solution.
Aspect 67. The method of any one of aspects 63-66, wherein flowing the feedstock solution over the solid is done at a flow rate of about 1 mL/min to about 4 mL/min.
Aspect 68. The method of any one of aspects 63-67, wherein flowing the aqueous solution over the solid is done at a temperature of about −5° C. to about 5° C.
Aspect 69. The method of any one of aspects 63-68, wherein flowing the desorption solution over the solid is done at a flow rate of about 1 mL/min to about 4 mL/min.
Aspect 70. The method of any one of aspects 63-69, wherein the desorption solution is an aqueous solution comprising no lithium.
Aspect 71. The method of any one of aspects 63-69, wherein the desorption solution is an aqueous solution comprising a lithium concentration of about 1 ppm to about 200 ppm.
Aspect 72. The method of any one of aspects 63-70, wherein the second effluent comprises lithium.
Aspect 73. The method of any one of aspects 63-72, wherein the second effluent comprises a greater concentration of lithium than the desorption solution.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### G. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Lithium Porous Nanosorbent Fibers

The lithium/aluminum layered double hydroxide (Li/Al-LDH) adsorbent, known for its two-dimensional structure and specific selectivity for Li⁺ ions, is widely used in lithium extraction from industrial sources. This adsorbent is produced using various synthesis methods, including co-precipitation, hydrothermal reaction, sol-gel, and mechanochemical synthesis, to create powdered forms of Li/Al-LDH. On the other hand, many Li/Al-LDH granules have been produced by molding process through wrapping powder. These granules feature enhanced mechanical strength, facilitating recycling, handling, and transportation. Pan developed a novel high-mixing reactor with antisolvent extrusion granulation strategy to develop Li/Al-LDH granules with ultra-high powder loading. These granules exhibited an impressive adsorption capacity of 4,710.12 mg/L when used to treat low-grade brine, significantly optimizing efficiency in practical applications. Nevertheless, although there is research on the powder and granular forms of Li/Al-LDH adsorbents, studies focusing on fiber form are notably limited.

Fiber-based adsorbents are increasingly recognized as viable options for applications such as wastewater treatment and resource ion recovery. Their distinctive fibrous structure facilitates rapid fluid passage through their microstructure, significantly reducing diffusion distances-crucial for applications that demand quick filtration and purification. Therefore, leveraging the unique properties of fibrous materials could significantly enhance the extraction of lithium resources from brines. However, research into the application of fiber-based adsorbents for lithium extraction and recovery from aqueous systems remains relatively underexplored. Comprehensive exploration of this area could catalyze advancements in the field, promoting more sustainable and efficient lithium extraction techniques suited for various industrial applications.

Materials and Methods. LiCl, AlCl₃·6H₂O, NaOH, HCl, polyacrylonitrile (PAN), and N, N-dimethylformamide (DMF) were used. All the chemicals were purchased from Thermo Fisher Scientific, USA and directly used without further purification. A synthetic brine was employed to assess lithium adsorption performance. The detailed composition and raw pH value of the brine is given in Table 1. The PH levels during specific adsorption experiments were controlled using HCl and NaOH solution.

TABLE 1
Detailed composition (mg/L) and pH value of the synthetic brine.

| Li | Na | Mg | K | Ca | pH value |
|---|---|---|---|---|---|
| 1,000 | 120,000 | 20 | 25,000 | 0.32 | 5.03 |

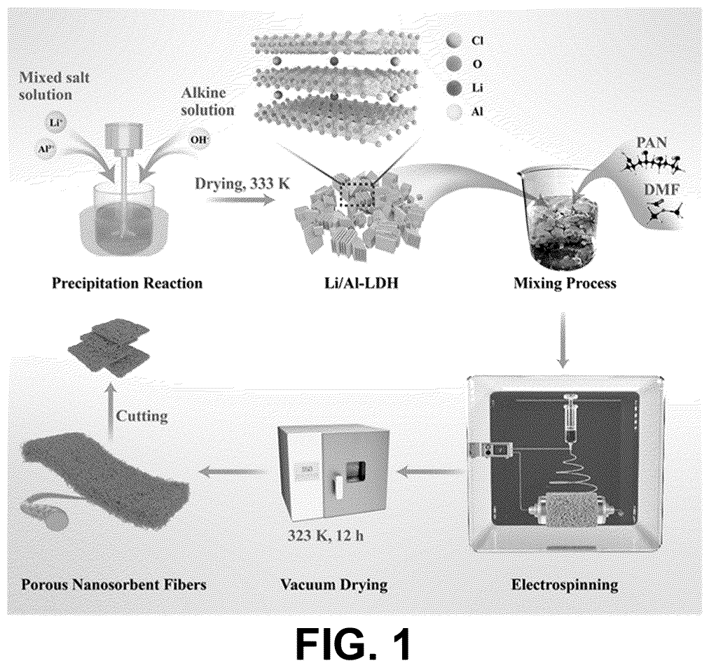

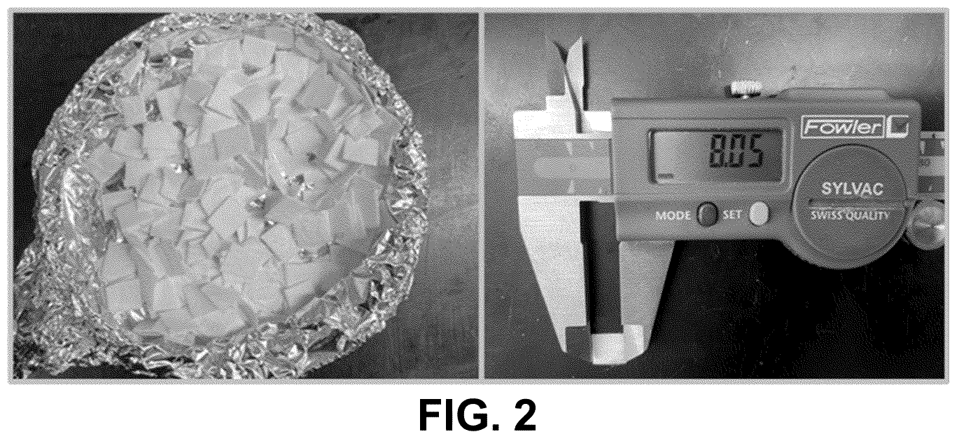

Fabrication of Li/Al-LDH and Porous Nanosorbent Fibers. The Li/Al-LDH was synthesized using the one-step co-precipitation method¹⁷. In this process, as shown in FIG. 1, a mixed salt solution with a Li to Al molar ratio of approximately 0.25 was gradually introduced into a base solution with a high alkaline concentration, initiating the co-precipitation reaction. The reaction was conducted in a jacketed glass reactor under continuous stirring. The resulting product was washed either with deionized water or ethanol, followed by drying at 333 K for 24 hours to obtain the final powder product. On the other hand, a specific quantity of PAN was dissolved in a DMF solution at 333 K by stirring at 800 rpm for 2 hours to achieve a homogeneous PAN solution. Following this, a certain amount of Li/Al-LDH powder was introduced into the solution and stirred at 1500 rpm for 1 hour to create a suspension. After that, the suspension was loaded into a 10 ml syringe and positioned at the inlet of the electrospinning machine. It was uniformly pumped into the high-voltage electric field under specified conditions of speed, humidity, and voltage. The resulting fibers were collected at a distance of 40 cm from the nozzle. Subsequently, the product was vacuum dried at 323 K for 12 hours. The final dried products were cut into square flakes with 8 mm sides to obtain the Li/Al-LDH porous nanosorbent fibers (Li-PNFs). The specific manipulation parameters are provided in Table 2, while the visual representation of the product can be found in FIG. 2. The nanosorbent fibers, prepared from suspensions with varying LDH contents, were named Li-PNFs-1, Li-PNFs-2, Li-PNFs-3, Li-PNFs-4, and Li-PNFs-5, respectively (see Table 2).

TABLE 2
Experimental parameters.

| | DMF | PAN | LDH powder | Speed | Voltage | Humidity | Distance |
|---|---|---|---|---|---|---|---|
| Sample | (mL) | (g) | (g) | (mL/h) | (kV) | (%) | (cm) |
| Li—PNFs-1 | 20 | 2 | 2.0 | ~4 | 20 | ~20 | 40 |
| Li—PNFs-2 | 20 | 2 | 2.5 | ~4 | 20 | ~20 | 40 |
| Li—PNFs-3 | 20 | 2 | 3.0 | ~4 | 20 | ~20 | 40 |
| Li—PNFs-4 | 20 | 2 | 3.5 | ~4 | 20 | ~20 | 40 |
| Li—PNFs-5 | 20 | 2 | 4.0 | ~4 | 20 | ~20 | 40 |

Characterizations. Viscosity was measured using a TA Discovery Hybrid Rheometer HR-3 with a 1000-micrometer gap and a shear rate ranging from 0.0001 1/s to 2,000 1/s. Dynamic Mechanical Analysis (DMA) was conducted at 28° C. using a DMA Q800 analyzer. The dynamic contact angle was tested with a Theta Flow Tensiometer. Specific surface area and pore size of Li-PNFs were analyzed using N₂ adsorption-desorption isotherms at 77 K with a Micromeritics-3Flex analyzer, employing the Brunner-Emmett-Teller (BET) and Barrett-Joyner-Halenda (BJH) methods. Scanning Electron Microscopy (SEM) and Energy-Dispersive X-ray Spectroscopy (EDS) were performed to analyze morphology and elemental composition, respectively. The crystalline structure was assessed using X-ray diffraction (XRD) from 5° to 80° with Ni-filtered Cu—Ka radiation. Fourier Transform Infrared Spectroscopy (FTIR) analyses were conducted using a Thermo Fisher Scientific Nicolet instrument with samples prepared as KBr pellets. A Thermogravimetric Analyzer (TGA 5500, TA Instrument, USA), featuring a high-temperature furnace, was used at a heating rate of 20° C./min under a nitrogen atmosphere flowing at 20 mL/min. X-ray Photoelectron Spectroscopy (XPS) analysis was carried out using an advanced PHI Quantera Hybrid system. Ion concentrations in solutions were determined by inductively coupled plasma mass spectrometry (ICP-MS).

Calculations. The density functional theory (DFT) calculations were carried out with the CASTEP code. The Perdew-Burke-Ernzerhof (PBE) functional within generalized gradient approximation (GGA) was used to process the exchange-correlation, while the projector augmented-wave pseudopotential (PAW) was applied with a kinetic energy cut-off of 381.0 eV, which was utilized to describe the expansion of the electronic eigenfunction^{18, 19}. The Brillouin-zone integration was sampled by a Γ-centered 10×10×10 Monkhorst-Pack k-point. All atomic positions were fully relaxed with SCF tolerance of 1×10⁻⁵ eV. The electronic minimizer used density mixing.

The adsorption energy (Eq. (1)) of the system was predicted from the difference between the energies of the species before and after adsorption.

$${E}_{a d s} = {E}_{t o t} - {E}_{0} - {E}_{b a s e} \qquad ( 1 )$$

where Eₜₒₜ is the total energy of the adsorption system, E, the energy of adsorbent surface, and E_{base} the energy of the adsorbate.

Adsorption Experiments. Lithium adsorption experiments were conducted to evaluate the efficacy of Li-PNFs. For each experiment, 50 mg of fibers were introduced into 100 ml of brines. The mixture was then agitated at 300 rpm for 4 hours in a water-bath shaker, facilitating sample collection. Initially, the adsorption experiments were performed on brines with varying lithium concentrations, specifically 100 mg/L, 300 mg/L, 600 mg/L, and 1000 mg/L, to determine the fiber's adsorption capability across different lithium concentration gradients. Additionally, to assess the impact of pH on lithium adsorption, brines with varying pH levels were also tested. The influence of fiber dosage on lithium adsorption was further examined using different dosage levels of 30 mg/100 mL, 50 mg/100 mL, and 70 mg/100 mL. Kinetic studies of the adsorption process were performed at ambient temperature with a fiber dosage of 50 mg/100 mL. Isotherm experiments related to adsorption were also carried out at ambient temperature. The lithium adsorption capacity was calculated using Eq. (2).

$$q = \frac{v \cdot ( {C}_{0} - {C}_{t} )}{m} \qquad ( 2 )$$

where C₀ (mg/L) and Cₜ (mg/L) refer to the ion concentration before and after adsorption, respectively. m (g) is the mass of the added fiber. v (L) is the volume of the feed brines. Details on the kinetic and isotherm fitting methods can be found in the Supporting Information.

To examine adsorption selectivity, solutions containing two metal components with a molar ratio of Me: Li=1:1 were used, where Me denotes either Na or K. The distribution coefficient K_{Me} (L/g) and selectivity factor α_{Li/Me} were calculated as Eq. (3) and Eq. (4), respectively:

$${K}_{M e} = \frac{( {C}_{0} - {C}_{e} ) \cdot v}{{C}_{e} \cdot m} \qquad ( 3 )$$

$${α}_{L i / M e} = \frac{{K}_{L i}}{{K}_{M e}} \qquad ( 4 )$$

where C₀ (mg/L) and Cₑ (mg/L) refer to the initial ion concentration and equilibrium ion concentration, respectively, m (g) is the fiber mass, v (L) is the solution volume. The subscript Mₑ of K_{Me} and α_{Li/Me} means the metal ions in the solution.

The adsorption-desorption cycle process was conducted to assess the reusability of the nanosorbent fiber. The desorption procedure was conducted at ambient temperature. Following adsorption, the fiber loaded with lithium was vacuum-dried at 323 K for 2 hours. It was treated in a fixed-bed shaker with deionized water at a solid/liquid ratio of 50 mg/100 mL for 2 hours under neutral conditions, resulting in regeneration of the fiber. To assess the stability of lithium adsorption performance and the fiber's structural integrity, cyclic experiments involving repeated adsorption/desorption phases were conducted.

Fixed-bed column experiments were conducted to assess lithium dynamic extraction performance. A 10 mm×30 cm transparent glass chromatography column was utilized, packed with around 20.00 g of adsorbent. The adsorption process, employing a bottom-up feed, operated at a controlled rate of 6 bed volume (BV)/h. Samples were collected at regular intervals corresponding to the bed volume. Following adsorption, a top-down water washing process was implemented to rinse bed gaps, drain adsorbent liquid, and stabilize adsorbent properties. Throughout this stage, the incoming feeding rate of deionized water at 0° C. was maintained at 12 BV/h. Subsequently, the final desorption process mirrored the adsorption process in both feed mode and rate, utilizing a low-concentration lithium solution.

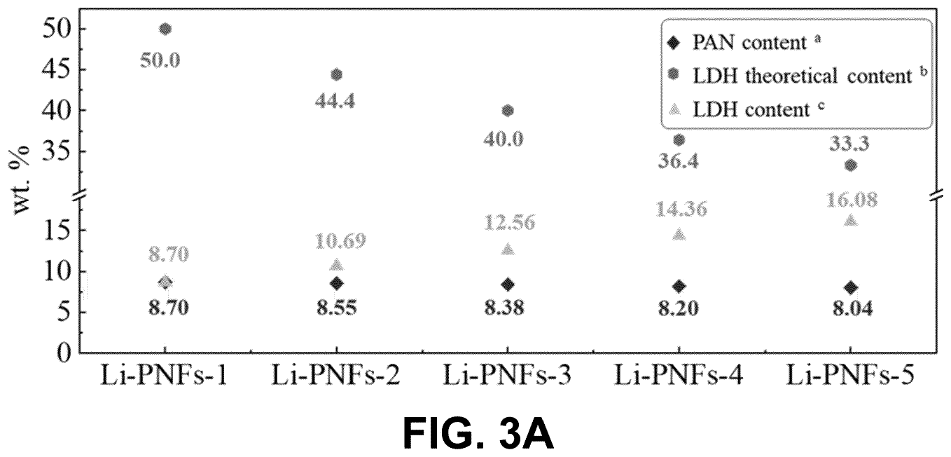

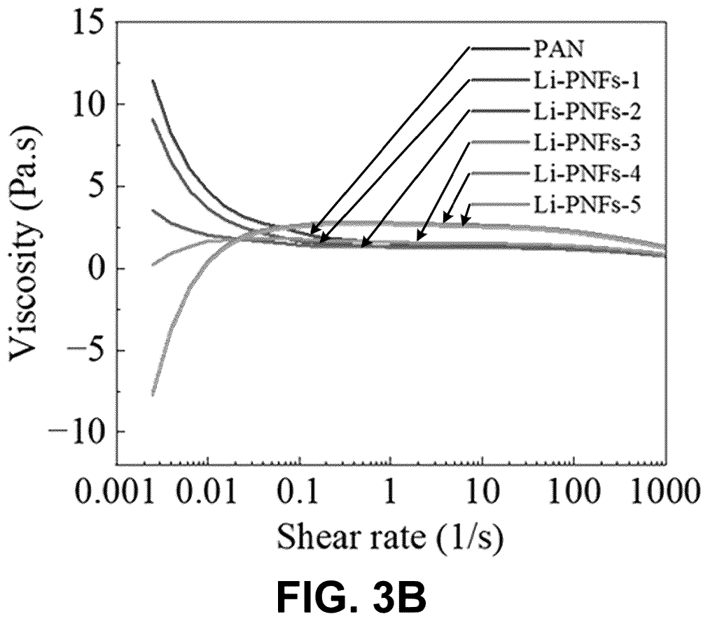

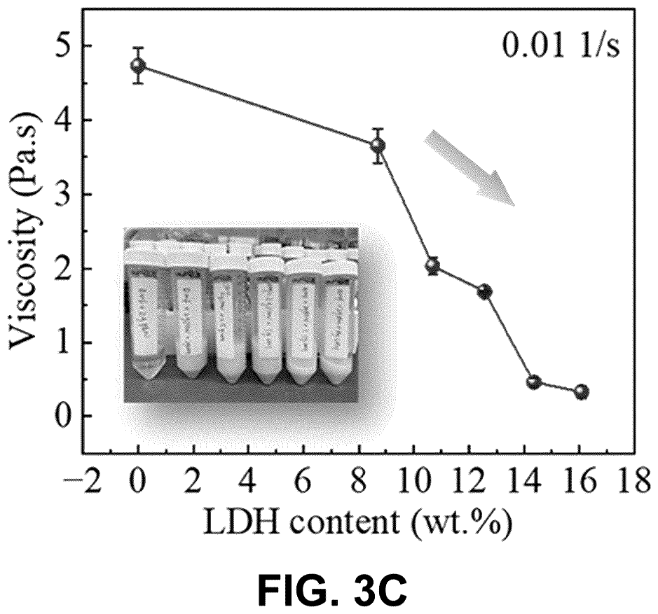

Rheological Behavior of PAN/LDH Composite Suspensions. To examine the interaction of the LDH particles with the organic solution and the effect of the mobility of the PAN/LDH composite suspensions on the spinning effect, rheological behavior of the suspensions was investigated. The PAN content and the theoretical and actual precursor LDH content of different composite suspensions are given in FIG. 3A, showing the concentration of each component in the suspensions of the different fiber precursors. The viscosities of these suspensions are illustrated in FIGS. 3B-C. As investigated, each composite suspension exhibited non-Newtonian behavior, demonstrating pronounced shear thinning even at low shear rates²⁰.

Specifically, for suspensions containing 8.7 wt. % and 10.69 wt. % of LDH, a sharp decline in viscosity was noted at shear rates below 0.5 1/s, attributed to the disruption of hydrogen bonds among PAN macromolecule chains²¹. Beyond a shear rate of 0.5 1/s, the viscosities stabilized across different suspensions regardless of further increases in shear rate, indicating a flow equilibrium where the spatial arrangement and interactions within the suspensions ceased to significantly alter²². Conversely, suspensions containing 12.56 wt. % LDH or more showed a rise in viscosity with an increasing shear rate, gradually approaching a steady state. At shear rates under 0.5 1/s, this viscosity increment was primarily due to denser LDH particle distributions and enhanced particle interactions at higher LDH contents. As shear rates ascended, these interactions might become more pronounced, causing a tighter particle configuration and, consequently, a rise in viscosity²³. Eventually, the suspensions attained a flow equilibrium state.

Additionally, when the LDH content was low (≤10.69 wt. %), adding more LDH led to a decrease in the overall viscosity profile. In comparison, LDH contents greater than 10.69 wt. % caused the viscosity profile to increase. This phenomenon primarily arose from the differential impact of LDH particles on the suspensions' structure and dynamics at varying LDH levels²⁴. At lower contents, introducing LDH particles tended to weaken particle interactions, facilitating easier dispersion, and resulting in a more fluid structure. Consequently, the suspensions became more flowable, reflected by a downward shift in the viscosity profile due to reduced friction and particle interactions. On the other hand, at higher LDH contents, the particle interactions intensified, leading to a denser structural arrangement. The resulted increase in particle friction translated to an upward movement in the viscosity profile²⁵. Furthermore, higher contents of LDH promoted particle aggregation, creating larger clusters that contributed to the increased viscosities.

The viscosity of PAN/LDH composite suspensions with varying LDH contents at a shear rate of 0.01 1/s is illustrated in FIG. 3C. Intriguingly, an increase in LDH content led to a reduction in viscosity at this low shear rate. This trend primarily stemmed from enhanced dispersion of LDH particles within the suspension as their concentration increased. Improved dispersion lessened particle interactions, facilitating easier movement at lower shear rates and thereby decreasing viscosity. Furthermore, higher LDH contents could modify the spatial arrangement of particles within the suspensions²⁶. Additionally, at elevated LDH content levels, the shear forces might overpower particle interactions, inducing a shear thinning effect²⁷. In order to ensure better spinning results as well as better dispersion of LDH particles, low LDH content was prioritized as a parameter to be included for utilization.

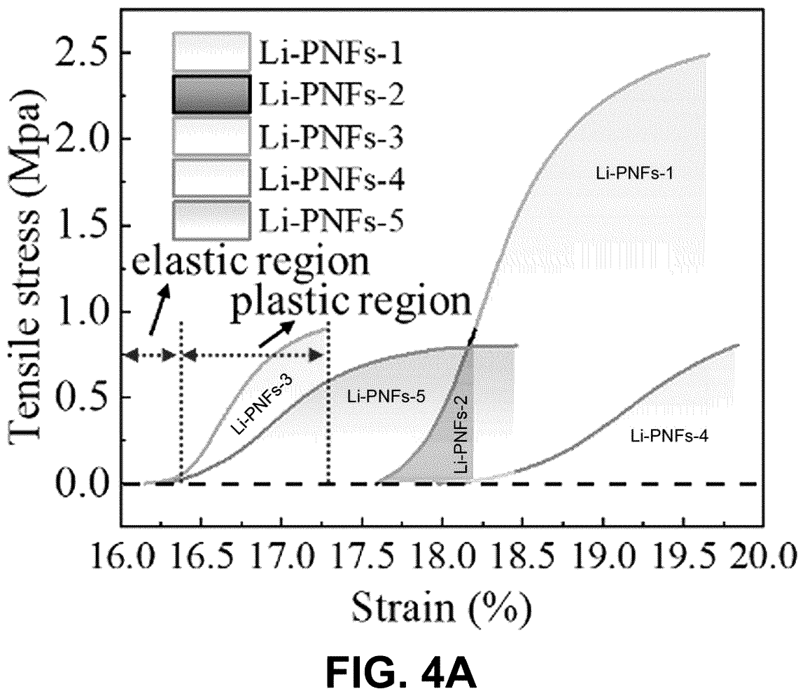

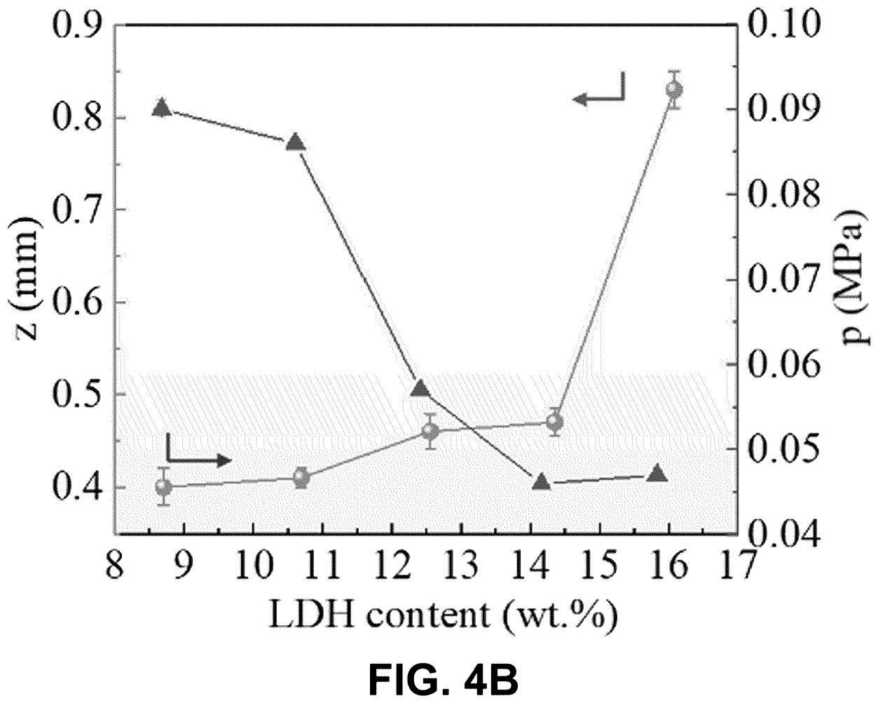

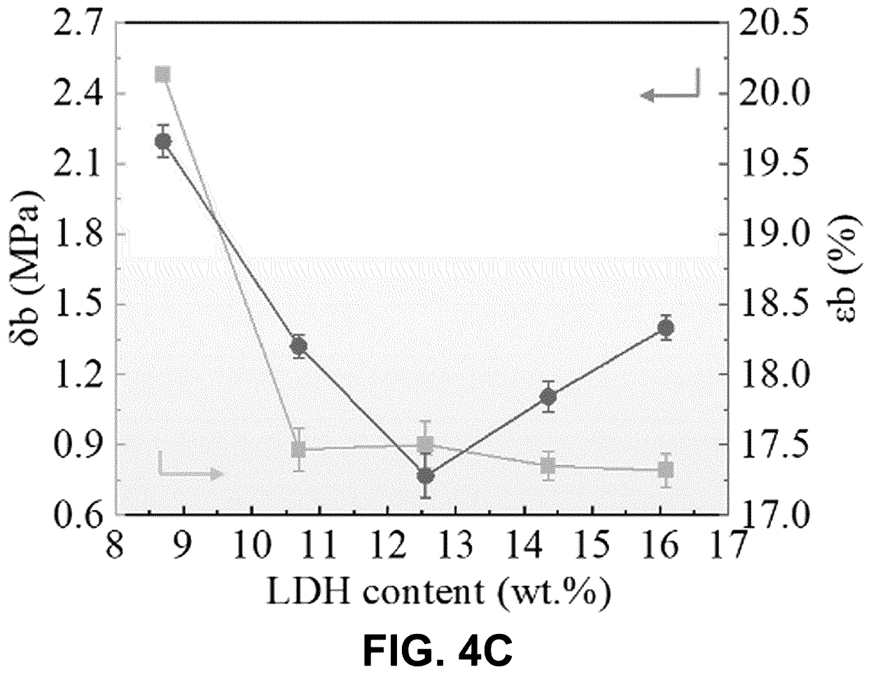

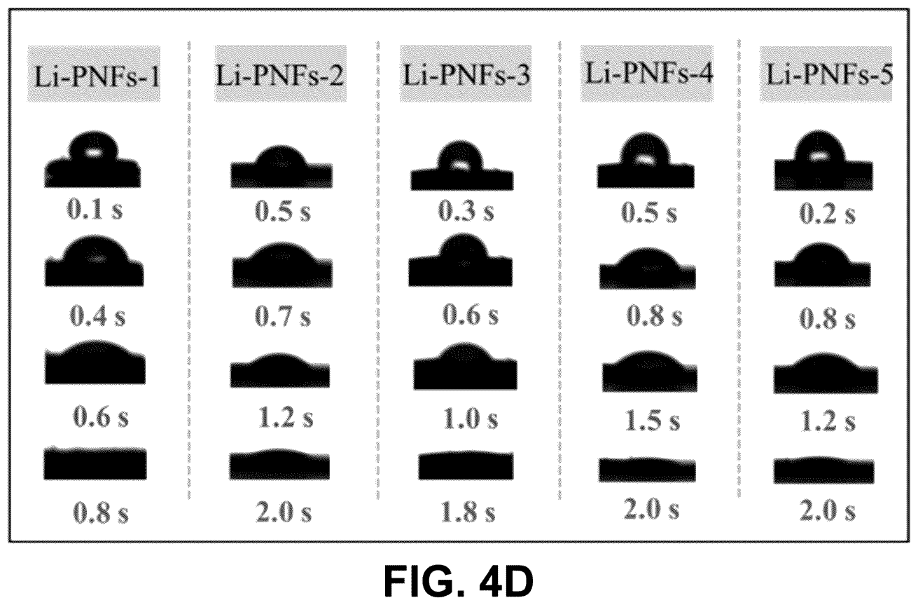

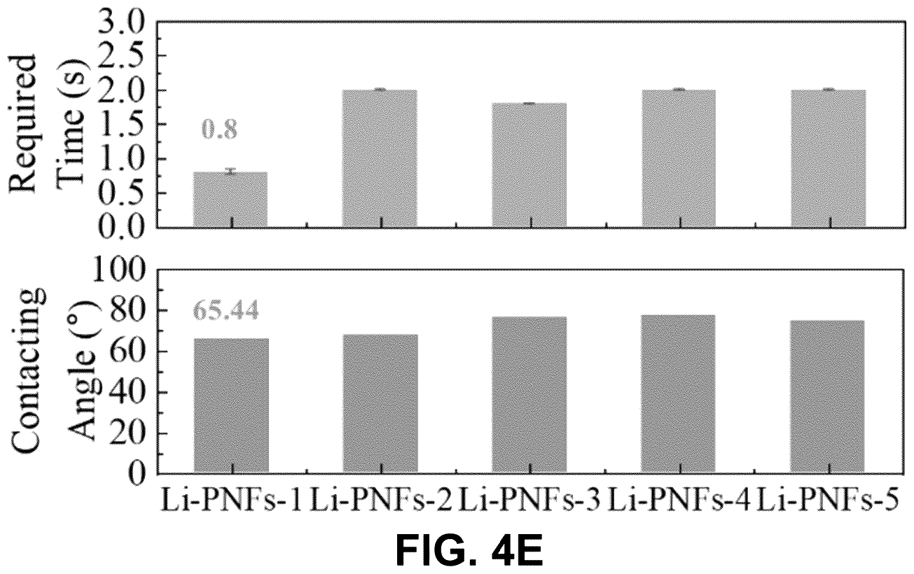

Mechanical Strength and Hydrophilicity. To understand the mechanical behavior of various fibers prepared from the aforementioned PAN/LDH composite suspensions, DMA tests were performed, with stress-strain curves presented in FIG. 4A. The initial gradual phase of the curves corresponds to the elastic region, demonstrating the material's capacity to return to its original shape once the applied force is removed (consider the curve of Li-PNFs-3 as an example). Beyond the yield stress p, the material begins to undergo irreversible deformation. FIG. 4B displays how the p varies with different LDH contents. Specifically, the Li-PNFs-1 product demonstrated optimal shape stability with a p reaching as high as 0.09 MPa. This phenomenon could be attributed to the likelihood of achieving optimal dispersion at the low LDH content, where LDH particles were evenly distributed throughout the matrix material, thus offering the most significant reinforcement. At low content, LDH particles could effectively distribute applied stresses, enhancing the material's overall strength and p. Moreover, an increase in LDH content beyond this point might led to a saturation or reduction of the interfacial interactions, adversely affecting the composite's mechanical performance²⁸. The optimal dispersion of LDH at lower content helped to minimize stress concentration points, leading to a more even stress distribution under load and consequently elevating the p.

The thickness z of the fiber flakes, which varied with the LDH content as depicted in FIG. 4B, tended to increase as the LDH content rose. This phenomenon was primarily due to a larger filling volume accommodating more LDH particles. Furthermore, this trend was associated with the viscosity of the PAN/LDH suspension. As previously discussed, an increase in the LDH content resulted in a decrease in viscosity at a shear rate of 0.1 1/s, leading to thicker flake formation. This occurred because a lower viscosity during the spinning process allowed the spinning fluid to flow more smoothly through the spinneret, making it more prone to forming and solidifying into thicker sheets, thereby producing thicker fibers²⁹. Additionally, a decrease in viscosity might influence the stretching and orientation phases of fiber production. Specifically, lower viscosity could cause fibers to be less stretched during the process, culminating in thicker flakes after solidification and curing³⁰.

Upon transitioning into the plastic region as indicated in the curve of FIG. 4A, the material experienced substantial plastic deformation before arriving at the fracture point. By calculating the area under the curve, toughness values of the various materials were determined. Comparative analysis showed that the toughness ranks in descending order as follows: Li-PNFs-1>Li-PNFs-5>Li-PNFs-4>Li-PNFs-3>Li-PNFs-2. Besides, FIG. 4C displays the tensile strength δ_{b} and elongation ε_{b} at break of the various Li-PNFs, illustrating a clear trend where δ_{b} diminished as LDH content increased. Notably, at a minimal LDH content of 8.07%, Li-PNFs-1 achieved δ_{b} of 2.48 MPa. This effect was largely attributed to the role of LDH content in facilitating the stretching and orientation of polymer chains during spinning. Optimal alignment of polymer molecular chains enhanced intermolecular forces, thus boosting the fiber's tensile strength. Furthermore, the ε_{b} in FIG. 4C indicates that & initially decreased with an increase in LDH content under low ranges, but it began to increase as LDH content continued to rise. Achieving an ε_{b} of 19.66% when LDH content was as low as 8.07% was primarily due to improved fluidity and orientation of the polymer chains at this point, aligning with previous conclusions.

The dynamic contact angles, presented in FIGS. 4D-E, show that the contact angle of all the fibers is less than 90° and decreases progressively as the contact time increases, confirming their hydrophilic nature. Notably, the contact angle of Li-PNFs-1 was only 65.44°, the lowest among all the fibers. Moreover, Li-PNFs-1 reached a contact angle of 0° in just 0.8 seconds, demonstrating the highest hydrophilicity among the fibers tested. This characteristic is favorable for enhancing the efficiency of lithium recovery from brines since highly hydrophilic materials have better contact efficiency and lower the energy barrier of ions on the surface of the material. Overall, Li-PNFs-1 demonstrated remarkably high mechanical strength and hydrophilicity, which would facilitate Li⁺ ion recovery in solution systems while maintaining its structural integrity.

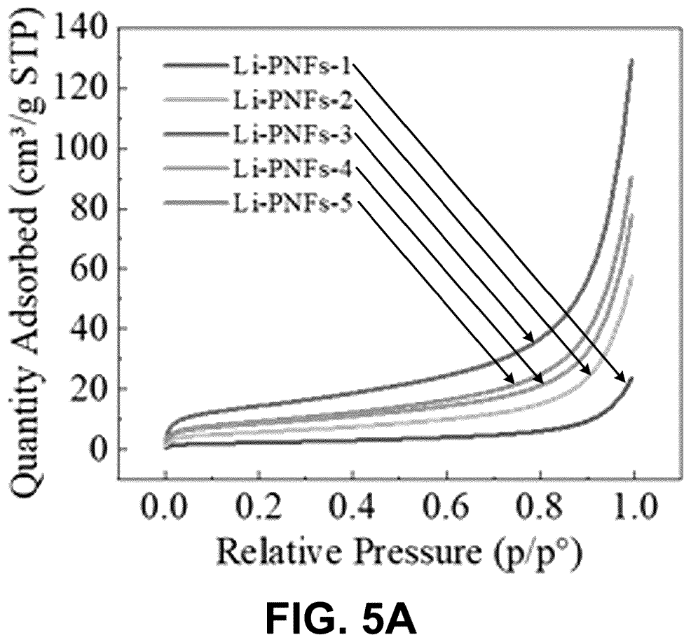

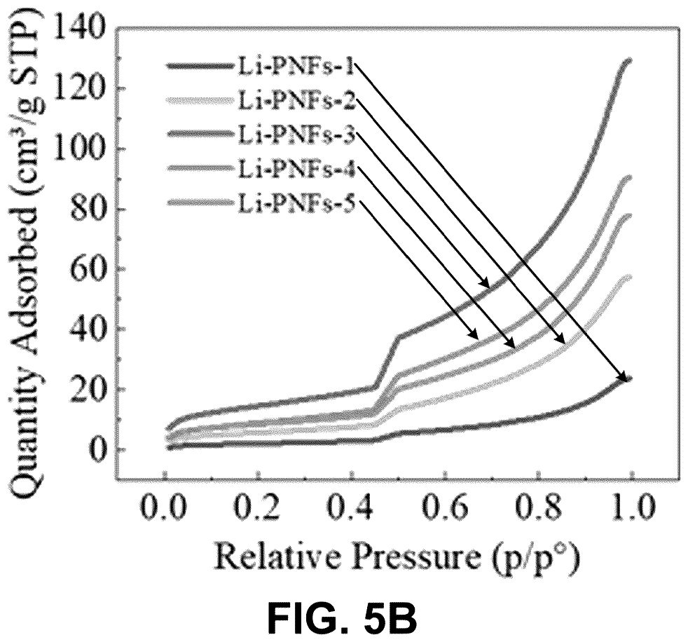

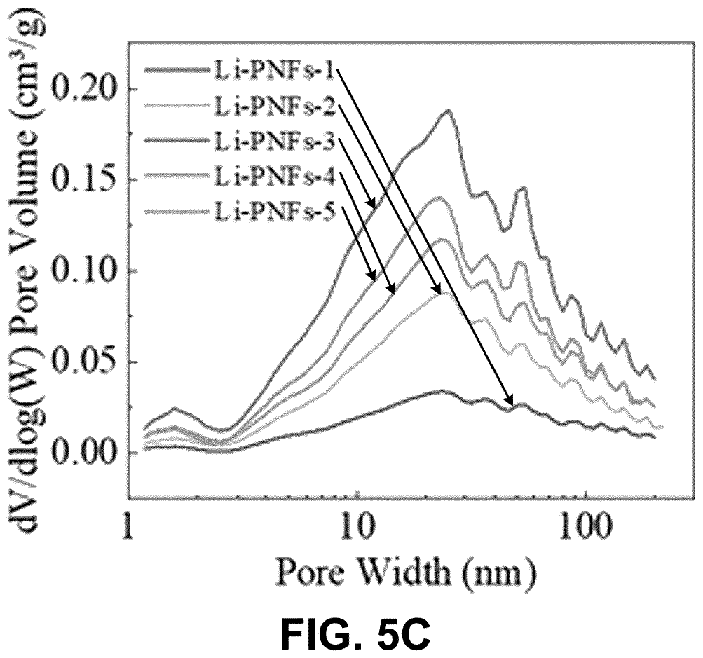

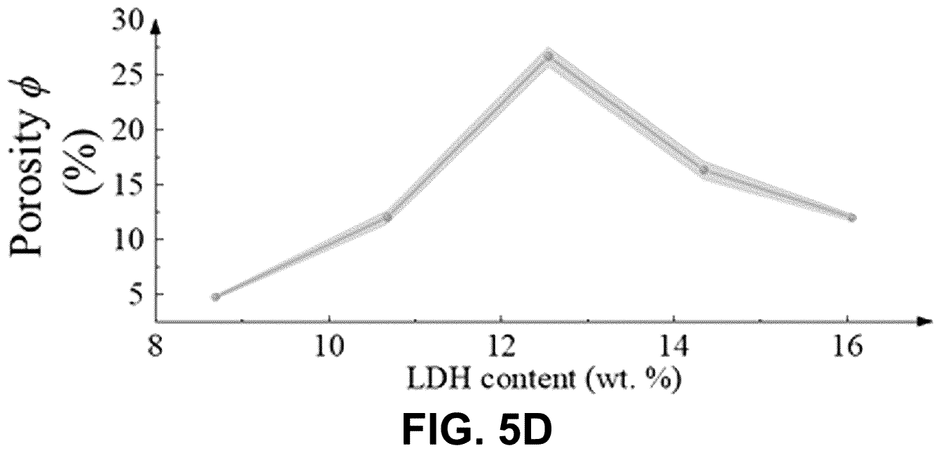

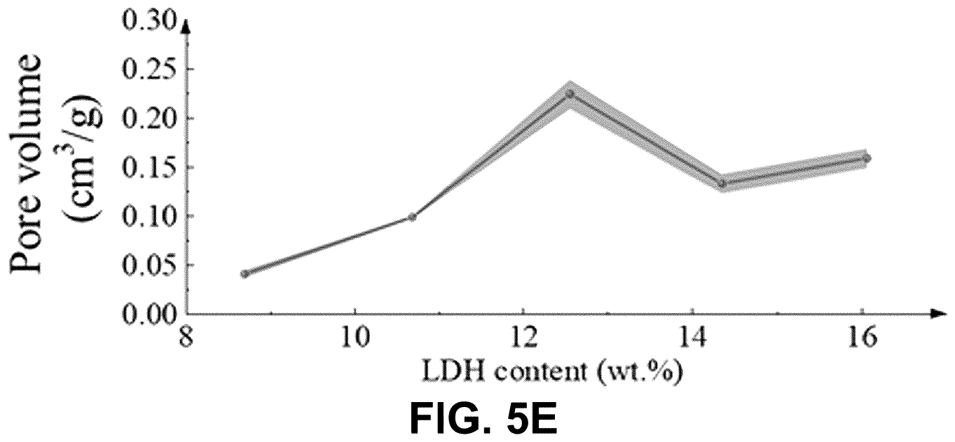

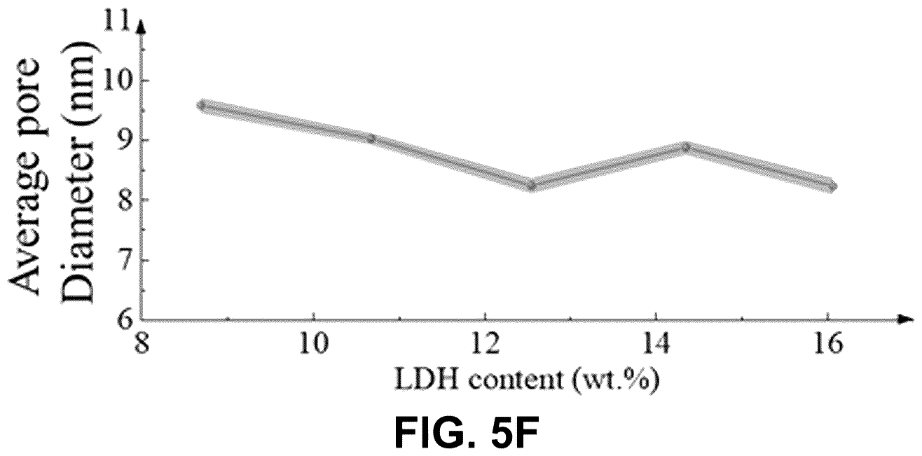

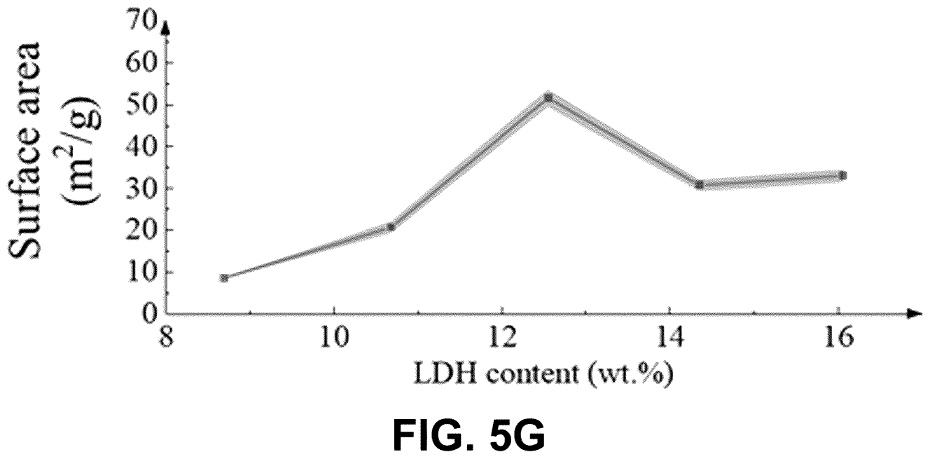

N₂ Adsorption/Desorption. To understand the pore structure and distribution of the different Li-PNFs, N₂ adsorption/desorption experiments were conducted, as shown in FIGS. 5A-B. Notably, the results illustrated a gradual increase in N₂ adsorption with increasing relative pressure, followed by a notable surge around 0.5 relative pressure. This behavior categorized the N₂ adsorption-desorption curves of these fibers as IUPAC Type IV, indicative of adsorption layer formation at medium relative pressures and a hysteresis loop at the end of the curve, demonstrating capillary condensation. Furthermore, the comparative analysis of N₂ adsorption and desorption capacities across different fibers showed a ranking of Li-PNFs-3>Li-PNFs-5>Li-PNFs-4>Li-PNFs-2>Li-PNFs-1, highlighting variations in pore numbers, sizes, and specific surface areas among the fibers. FIG. 5C, employing nonlocal density functional theory (NLDFT), revealed the pore size distribution with a peak at approximately 1.9 nm in the micropore range and a distinct peak at 24.9 nm in the mesopore range³¹⁻³³.

Additionally, as given in FIGS. 5D-E, all Li-PNFs possessed large void volumes and showed significant porosity, with the maximum porosity ϕ reaching 27.03% at 12.56 wt. % LDH content. On the other hand, FIGS. 5F-G compares the average pore sizes and surface areas among the different Li-PNFs, noting that all fibers exhibited an average pore size larger than 8 nm and a high surface area. Notably, Li-PNFs-3, with 12.56 wt. % LDH content, demonstrated the highest specific surface area and the smallest average pore size, correlating with its superior N₂ adsorption-desorption capacity. In conclusion, these Li-PNFs exhibited a layered porous structure featuring micropores, mesopores, and inter-fiber voids, especially Li-PNFs-3. This hierarchical porous architecture facilitated easy access of Li⁺ ions to the surface sites of the fibers, enhancing their functionality.

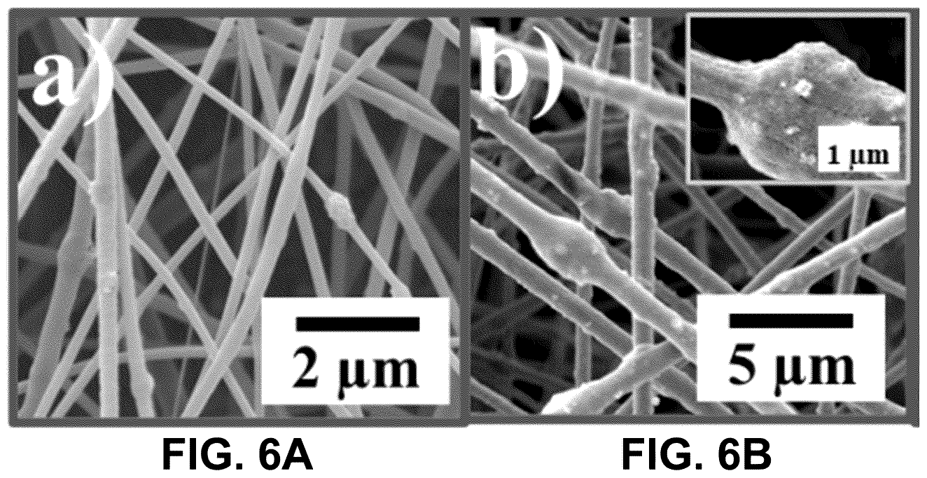

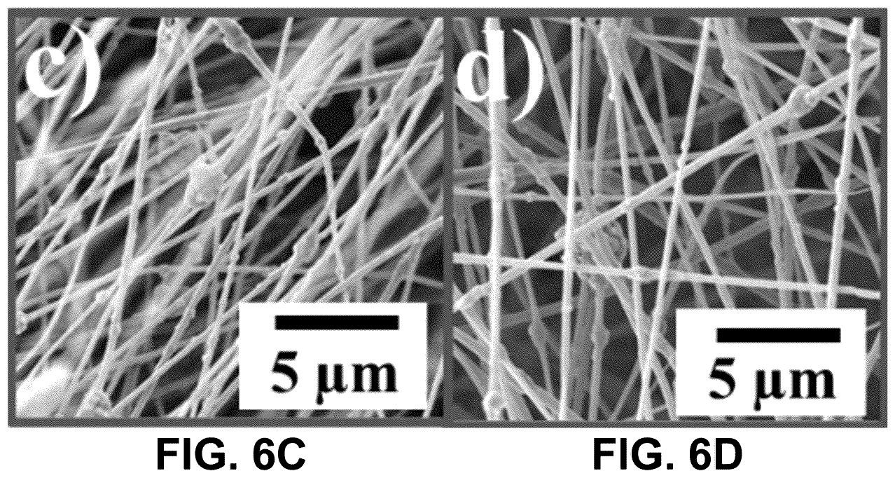

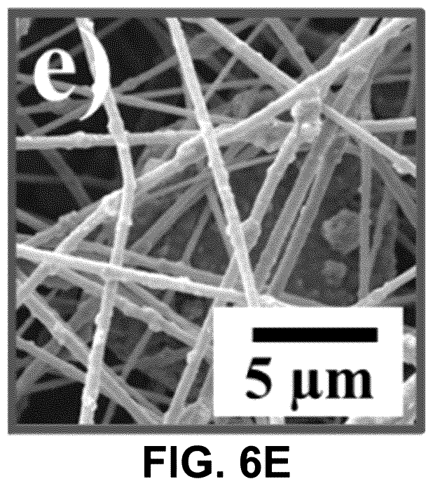

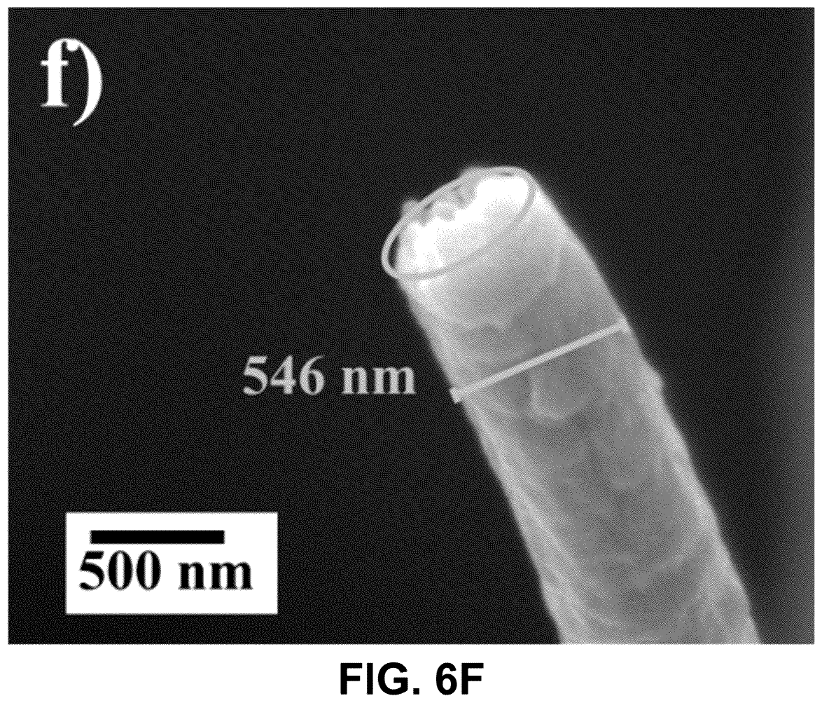

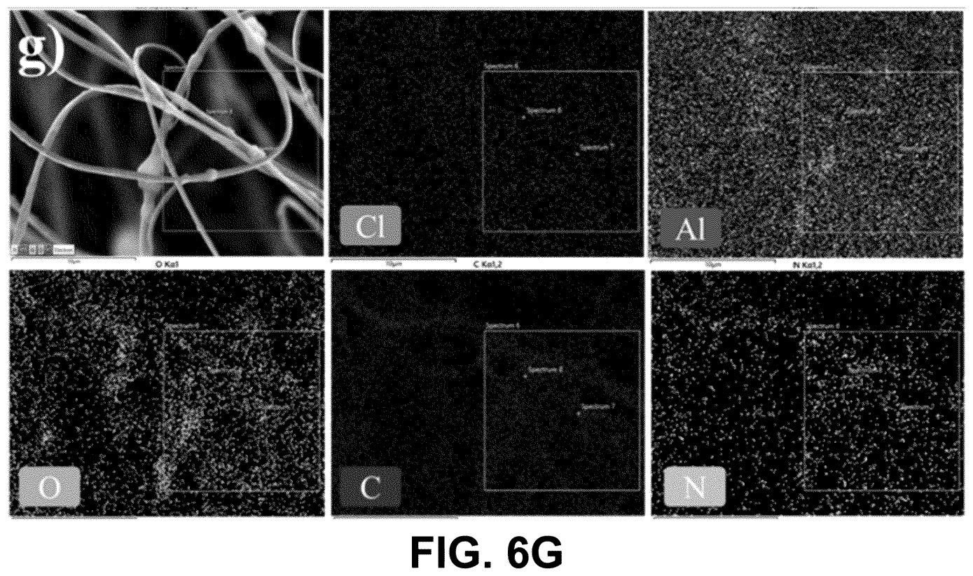

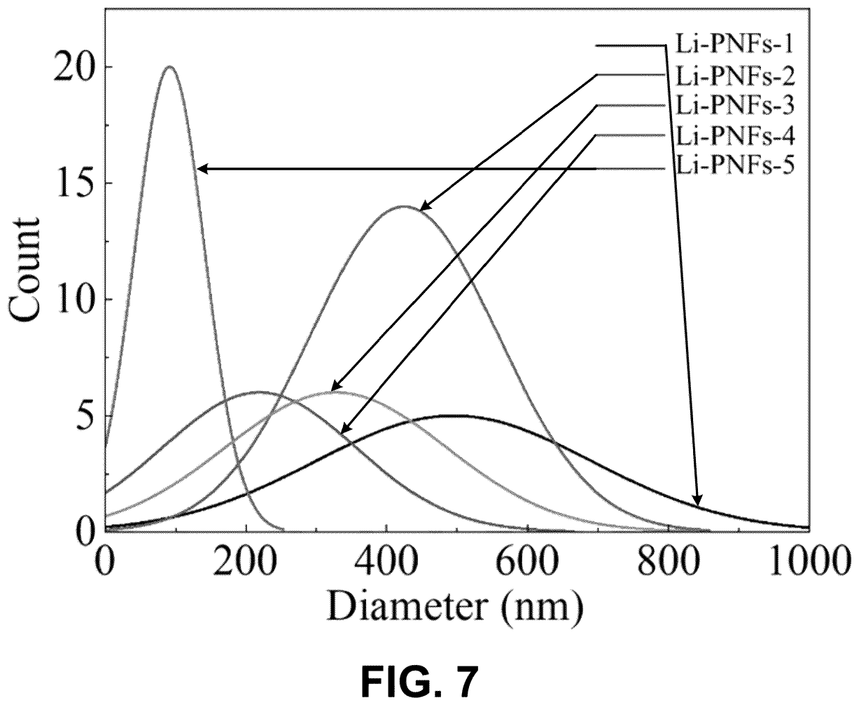

Morphologies. To visualize the morphology of different Li-PNFs, electron microscopic images are shown in FIG. 6A-E. It is evident that as the LDH content increased, the surface of the originally smooth rhizomatous fibers developed increasingly porous and granular protrusions. Notably, larger and more rapid protrusions were observed in Li-PNFs-2. Moreover, with the higher LDH content, the arrangement of the fibers became more disordered. In contrast, Li-PNFs-1 exhibited a smoother and more uniform structure without these disorganized protrusions, and the fibers were distributed more regularly in space. The fiber diameter analysis in FIG. 7 indicates that as LDH content rose, fiber diameters decreased, primarily due to the lower viscosity of the PAN/LDH composite suspension. Furthermore, the diameter of Li-PNFs-1 fibers mostly ranged between 400 nm and 600 nm, demonstrating superior uniformity. This uniformity not only promoted the formation of a regular pore structure, enhancing the ability of adsorption media to penetrate and circulate, but also reduced the pressure drop when fluids pass through the material, thereby increasing the efficiency and effectiveness of adsorption application. To comprehensively examine the microscopic morphology and elemental distribution of Li-PNFs-1, high-resolution electron micrographs and EDS results are presented in FIG. 6F-G. The fiber diameter at the ports of Li-PNFs-1 was measured at 546 nm, featuring a hairy and uneven texture. The primary components of Li-PNFs-1 included Cl, Al, O, C, and N, with these elements being uniformly distributed across the analyzed regions.

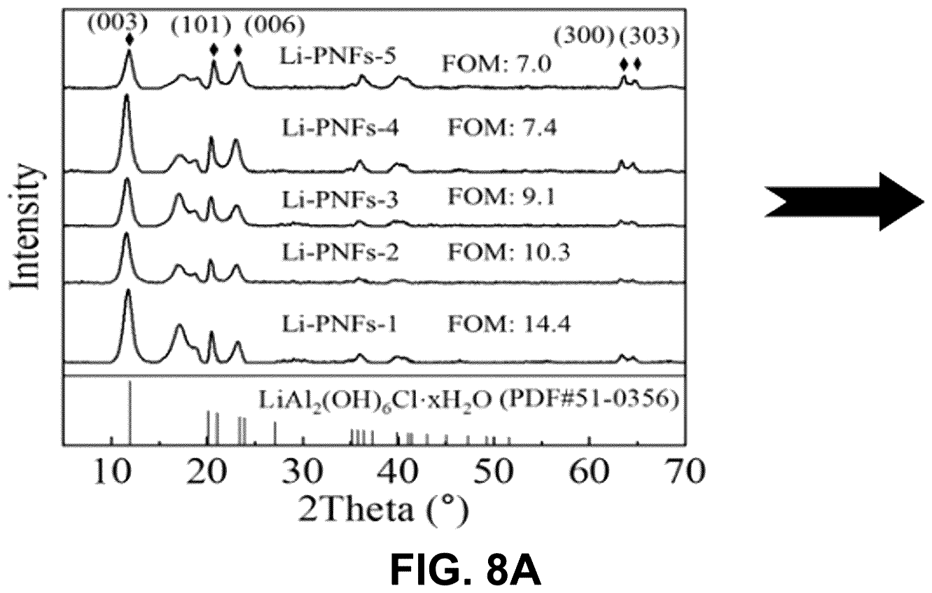

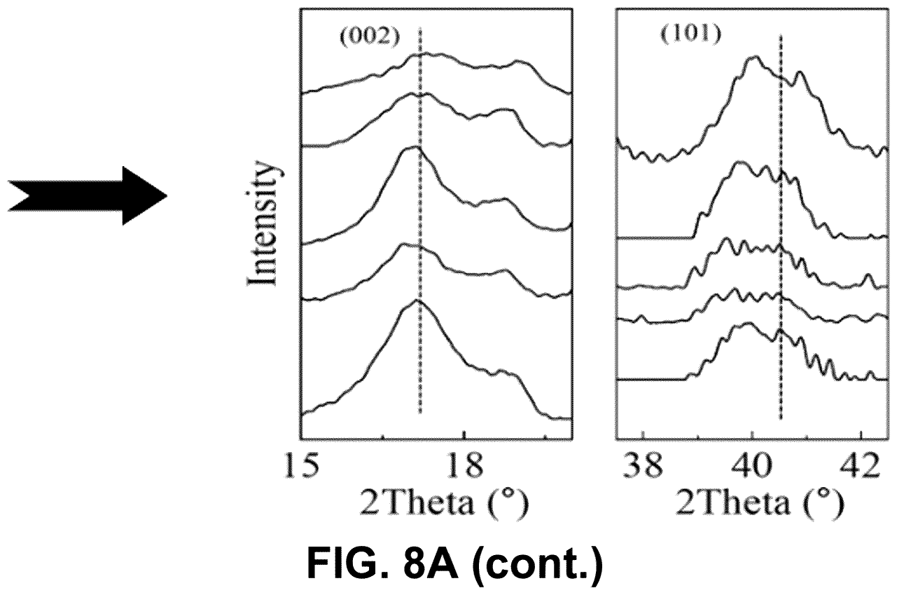

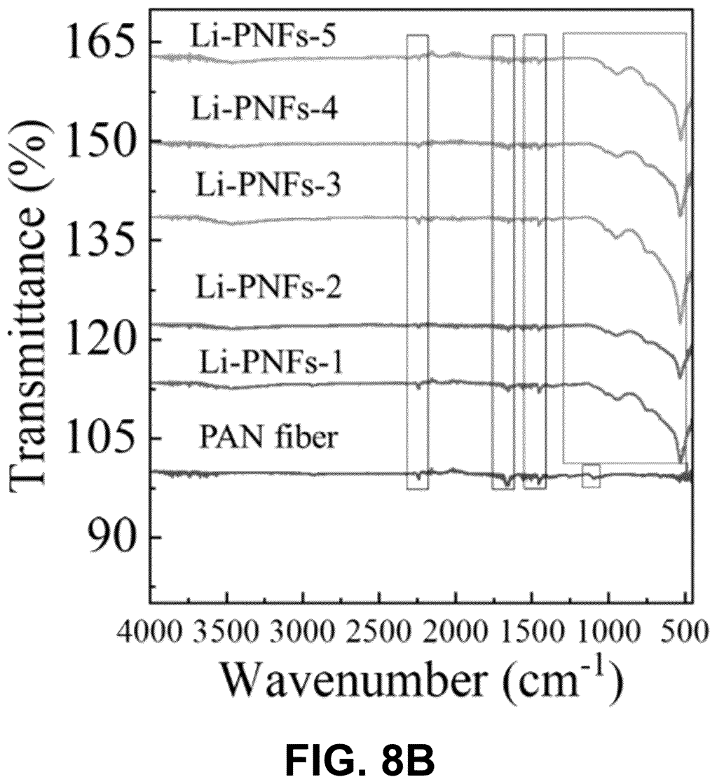

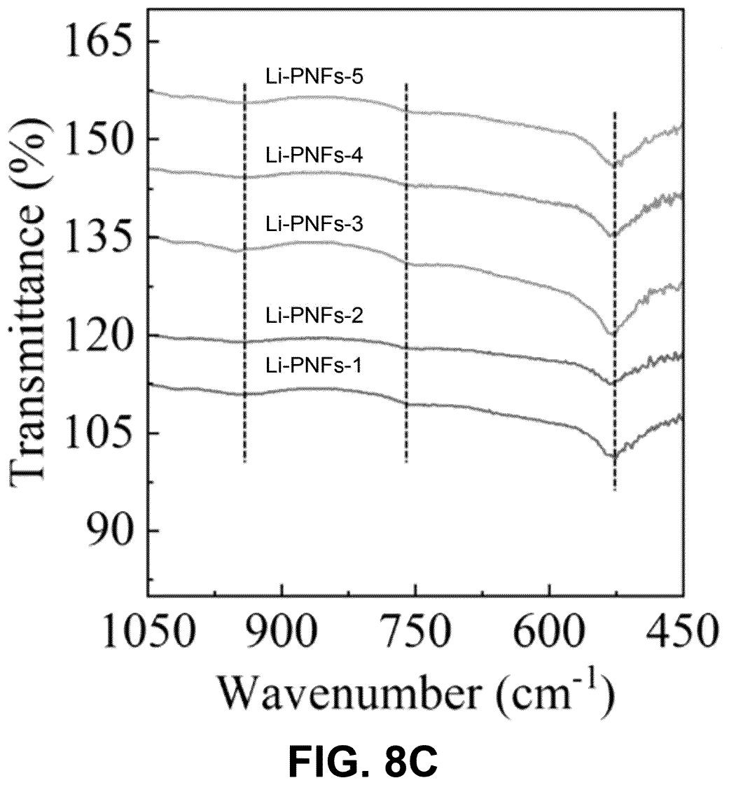

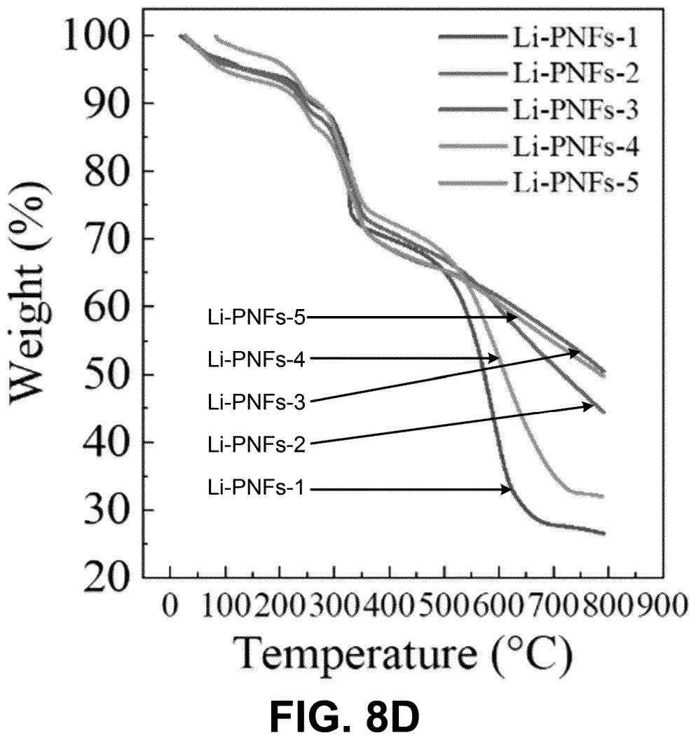

Composition Analysis and Mechanism. A detailed comparison of the chemical composition and structure of different Li-PNFs is provided in FIG. 8. In FIG. 8A, the XRD spectra displayed crystal facets such as (003), (101), (006), (300), and (303) across all fibers, indicating the presence of Li/Al₂(OH)₆Cl·xH₂O. Additionally, the d-spacing relationship of d₍₀₀₃₎=2d₍₀₀₆₎ confirmed that these new LDH-based fibers retained a regular layered structure. The Figure of Merit (FOM) value suggested that the crystal structure of Li-PNFs-1 closely aligned with the standard reference, pointing to a more accurately represented Li/Al₂(OH)₆Cl·xH₂O structure within this fiber, thus featuring a better theoretical lithium adsorption performance³⁴. Furthermore, the spectrum revealed two crystal facets, (002) and (101), associated with PAN crystal structure, confirming the existence of a PAN structure in these fibers³⁵. To delve deeper into the crystal cell volume and size of the Li-PNFs, the cell parameters are presented in Table 3. Notably, the reduced cell parameters and smaller volume observed in Li-PNFs-1 could primarily be attributed to the low LDH content. This lower concentration of LDH resulted in fewer crystal nucleation sites, allowing the crystals to grow in a more orderly fashion and leading to the development of a smaller cellular structure³⁶. Additionally, the lower LDH content meant that fewer inorganic fillers were involved in the construction of the cells and the polymer molecules might be more likely to form their inherently more compact cell structure.

TABLE 3
Crystal cell parameters of the different Li-PNFs.

| | a (Å) | b (Å) | c (Å) | V (Å³) |
|---|---|---|---|---|
| Li-PNFs-1 | 4.98815 | 4.98815 | 5.01606 | 124.81 |
| Li-PNFs-2 | 5.00391 | 5.00391 | 5.00391 | 125.29 |
| Li-PNFs-3 | 5.00709 | 5.00709 | 5.00727 | 125.54 |
| Li-PNFs-4 | 4.99803 | 4.99803 | 4.99803 | 124.85 |
| Li-PNFs-5 | 4.99444 | 4.97444 | 4.99894 | 125.70 |

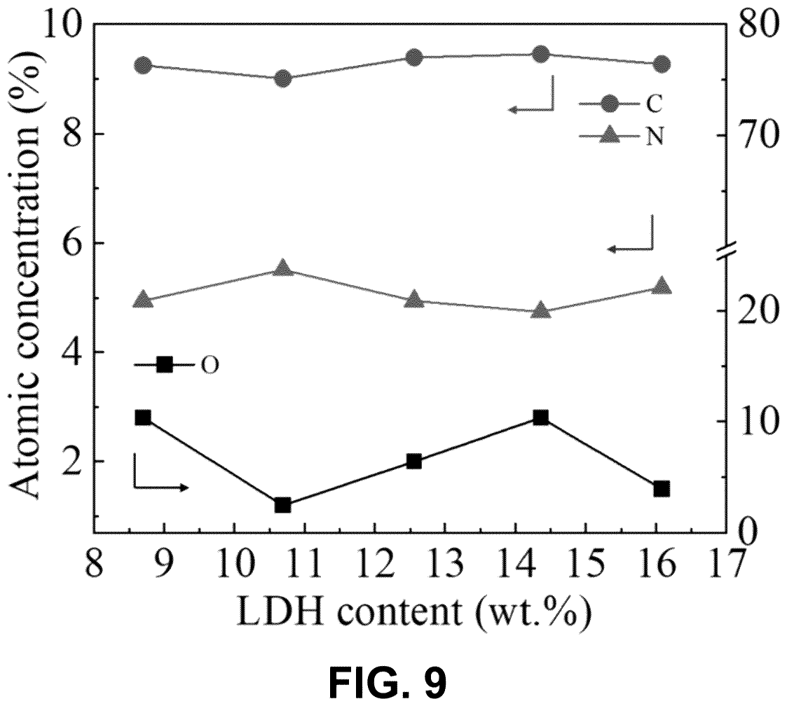

The FTIR spectra of different fibers are presented in FIG. 8B-C. Clearly, the peaks at 2240 cm⁻¹, 1670 cm⁻¹, and 1458 cm⁻¹ were indicative of the C≡N stretch, C═O telescoping vibration, and C—H bending vibration in PAN, respectively³⁷. Additionally, within the range of 450-1050 cm⁻¹, three peaks were observed at 957 cm⁻¹, 752 cm⁻¹, and 532 cm⁻¹, corresponding to the —OH vibration, Al—O oscillation, and Al—O deformation vibration, associated with the structure of Li/Al-LDH³⁸. Additionally, the atomic concentrations depicted in FIG. 9 reveal that the concentrations of C atoms and N atoms in all fibers stayed relatively stable, whereas the O atom concentration exhibited significant variation in response to changes in LDH content. Furthermore, Li-PNFs-1 exhibited the highest concentration of oxygen atoms. This was primarily because this low content of LDH diminished its shielding effect over the oxygen-containing functional groups in the PAN. Besides, this led to a greater dispersion of PAN on the surface, thereby exposing more of the carboxyl and ester groups that contain O atoms.

The TGA results presented in FIG. 8D show that the weight loss of these fibers occurs in four distinct stages. The initial stage, from room temperature to 180° C., was primarily due to the loss of water molecules and DMF. The second stage, from 180° C. to 270° C., involved the degradation of hydrogen cyanide (HCN), carbon dioxide and carbon monoxide³⁹. This was followed by the pyrolysis or oxidation of LDH interlayer ions in the temperature range 400° C.-800° C. The final stage concluded at 800° C., characterized by the decomposition of components within the LDH interlayer structure and the release of other nitrogen-containing organic compounds from the PAN. Detailed weight loss data of each stage for each Li-PNFs are provided in Table 4. Significantly, the fourth stage of Li-PNFs-1, which included the further decomposition of the PAN/LDH structure, exhibited the highest weight loss of 45.74%. This substantial reduction was primarily attributed to the altered decomposition kinetics of PAN/LDH with reduced LDH content and a weakened thermal stabilization effect. Consequently, more organic matter underwent decomposition.

TABLE 4
Weight loss of the different phases for the different Li-PNFs.

| | Weight loss (%) | | | | |
|---|---|---|---|---|---|
| | Li-PNFs-1 | Li-PNFs-2 | Li-PNFs-3 | Li-PNFs-4 | Li-PNFs-5 |
| Phase I | 6.08 | 5.82 | 4.39 | 3.04 | 6.87 |
| Phase II | 5.06 | 6.49 | 7.30 | 7.04 | 7.15 |
| Phase III | 18.59 | 16.71 | 18.68 | 17.36 | 17.11 |
| Phase IV | 43.07 | 26.76 | 18.52 | 40.81 | 45.74 |

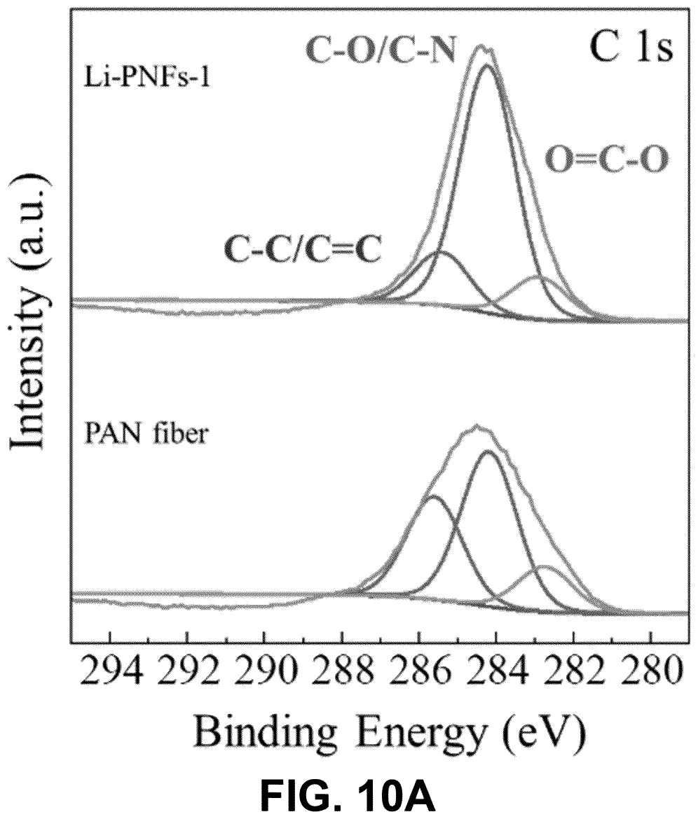

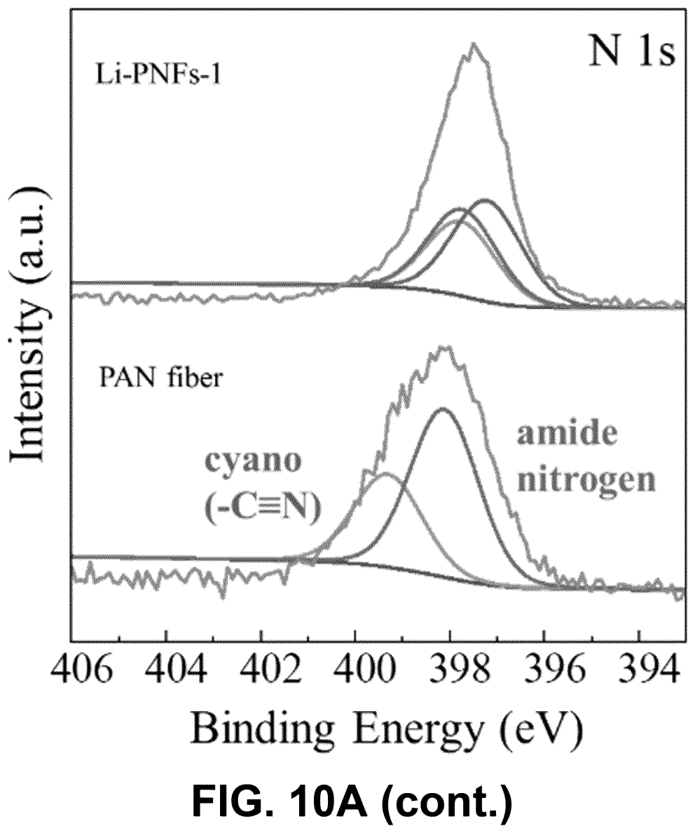

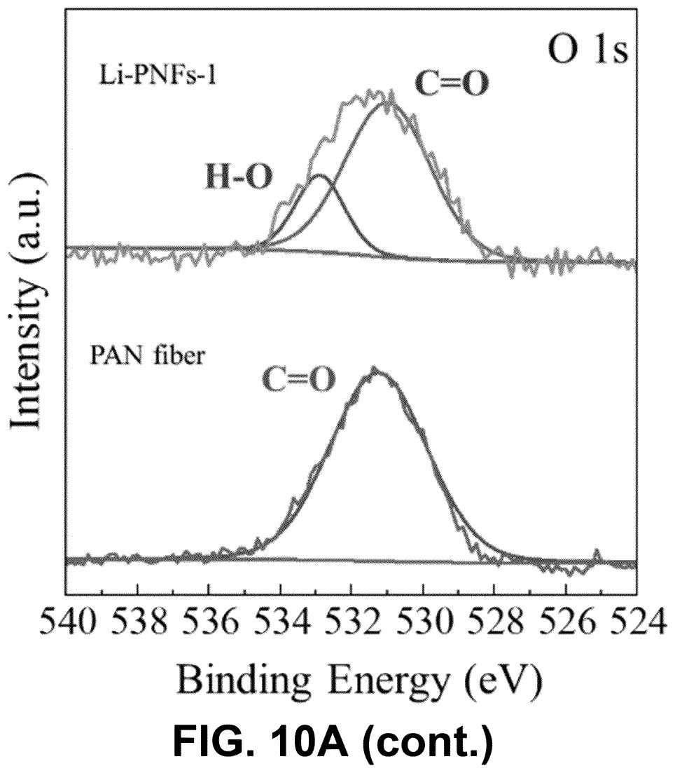

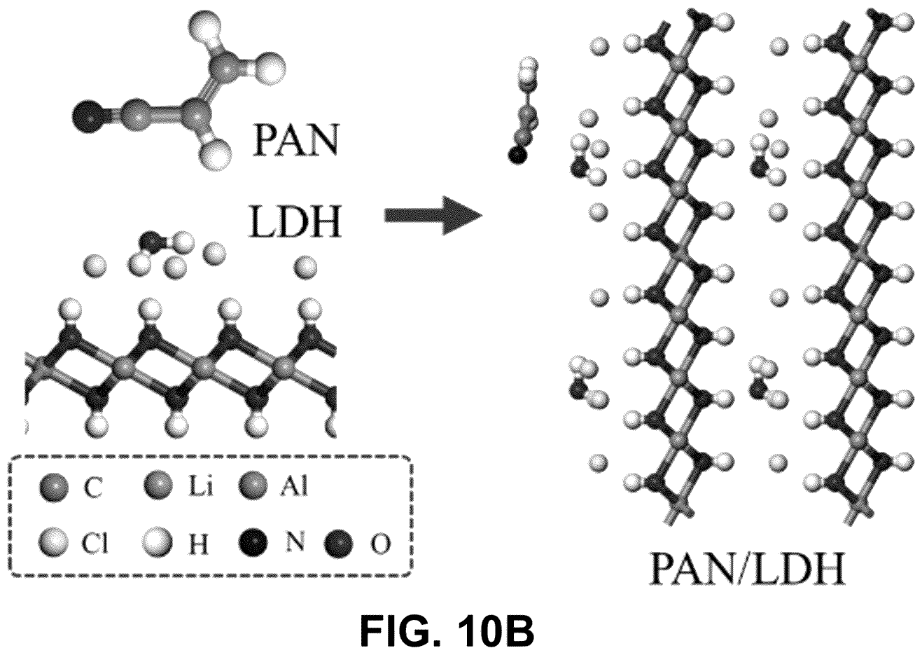

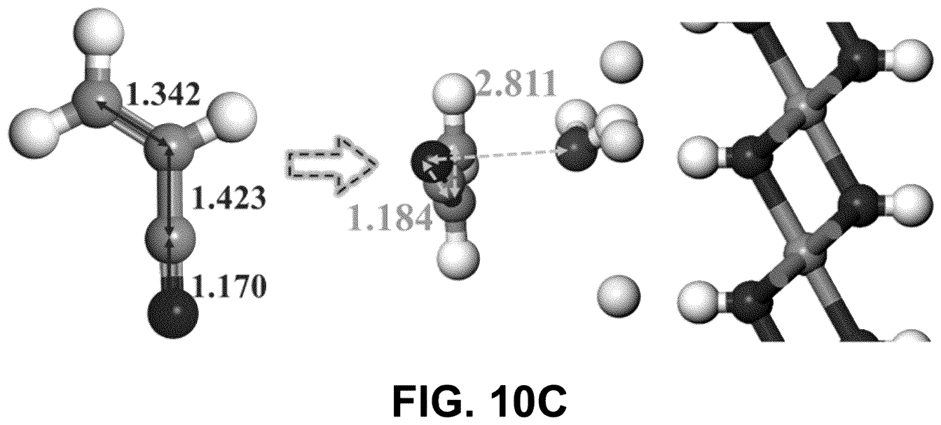

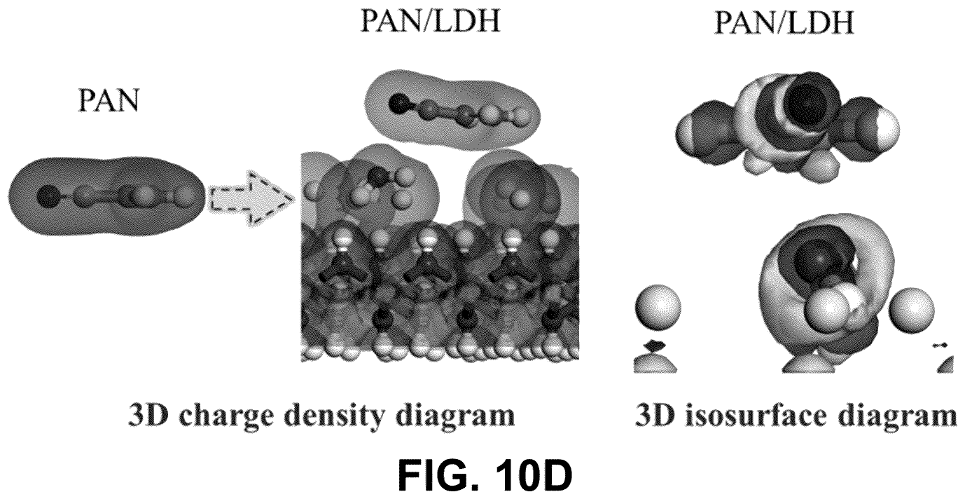

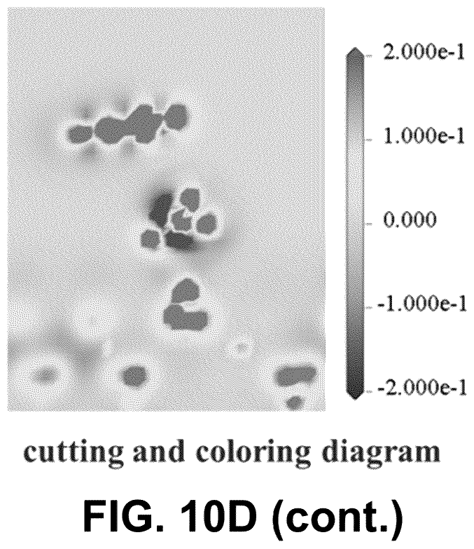

In order to clarify the mechanism of LDH interaction with PAN solution in Li-PNFs-1, FIG. 10A presents high-resolution XPS spectral analysis for the chemical environments of C, N, and O atoms. Remarkably, in the PAN fiber, the peaks indicative of C—C/C═C, C—O/C—N, and O═C—O occurred at 285.40 eV, 284.21 eV, and 282.89 eV, respectively⁴⁰. For Li-PNFs-1, these peaks were slightly shifted, likely due to the interaction between the layered LDH and PAN, which altered the chemical environments of these atoms. On the other hand, peaks in N 1s spectrum for PAN fiber, corresponding to cyano and amide nitrogen were found at 399.21 eV and 398.11 eV⁴¹. Upon integration of the LDH structure, these peaks shifted, and a new peak emerged at 397.21 eV. This new peak's appearance and the shifts were attributed to polar interactions: the polar —C≡N groups might form hydrogen bonds with water molecules present in the LDH interlayers, impacting the electronic environment of N atom⁴². This also affected the spatial arrangement of the PAN chain segments and their intermolecular interactions. In addition, the O 1s spectrum in these two fibers were also discussed. The C═O peak at 530.98 eV, corresponding to C₃H₇NO, remained unchanged by the introduction of LDH. However, for Li-PNFs-1, an additional peak at 532.89 eV, assigned to H—O bond, suggesting the formation of OH— groups in the LDH structure that coordinate with Al³⁺ ions. In conclusion, while the introduction of LDH did not alter the original chemical states of C, N, and O, it influenced the spatial configurations and intermolecular interactions within the fibers.

TABLE 5
Calculated energy of PAN/LDH structure.

| E_{base} | E₀ | Eₜₒₜ | E_{ads} (Ha) | E_{ads} (eV) |
|---|---|---|---|---|
| −24498.99 | −170.66 | −24669.73 | −0.072 | −1.95 |

To elucidate the molecular interaction between PAN and LDH structures, the most stable configuration was identified following energy minimization, as depicted in FIG. 10B. It was evident that the cyano group of the PAN unit established a new hydrogen bond with water molecules within the LDH layer. FIG. 10C illustrates the alterations in the geometric configuration before and after PAN's interaction with LDH. Notably, there was a significant modification in the spatial arrangement of C, N, and O atoms, with the bond length between N and C increasing from 0.117 nm to 0.1184 nm. Similarly, the bond lengths for C—C single and C—C triple bonds adjusted from 0.1423 nm and 0.1342 nm to 0.1433 nm and 0.1349 nm, respectively. The bond length for the newly formed N—O bonds was 0.2822 nm. Furthermore, Table 5 presents the energy values post-optimization, indicating a binding energy of −1.95 eV between PAN and LDH, which confirmed the chemical stability of their interaction. Additionally, to assess the impact on the electrochemical environment surrounding the N atoms in PAN, variations in charge density and differential charge density are depicted in FIG. 10D. This analysis showed a shift in electron density, with an increase noted in the blue regions and a decrease in the yellow regions. The charge distribution was also altered, where increased charge was represented by red areas and decreased charge by blue. In summary, the interaction between PAN and LDH resulted in a chemically stable structure facilitated by hydrogen bonding. While the original chemical states of C, N, and O atoms remained unchanged, there were notable changes in the geometrical spatial structure, intermolecular interactions, and the electrochemical environment of the N atoms.

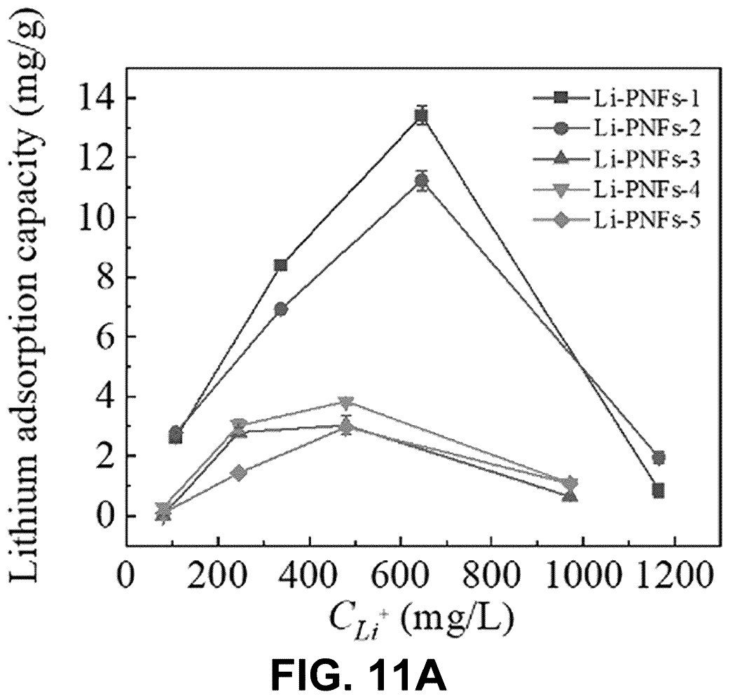

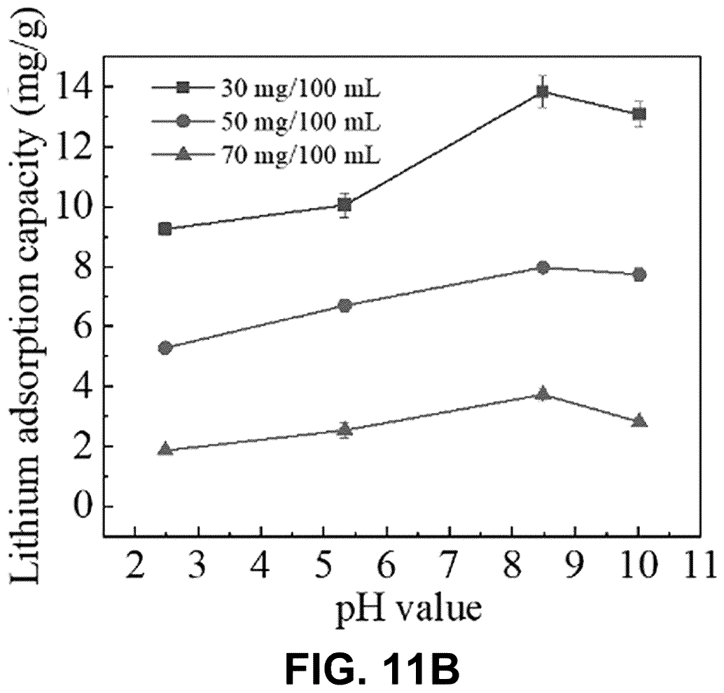

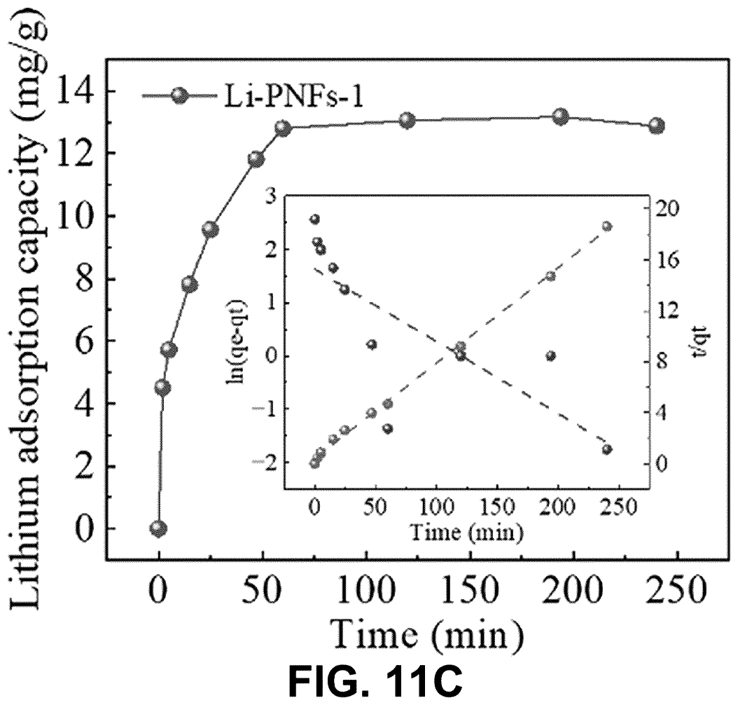

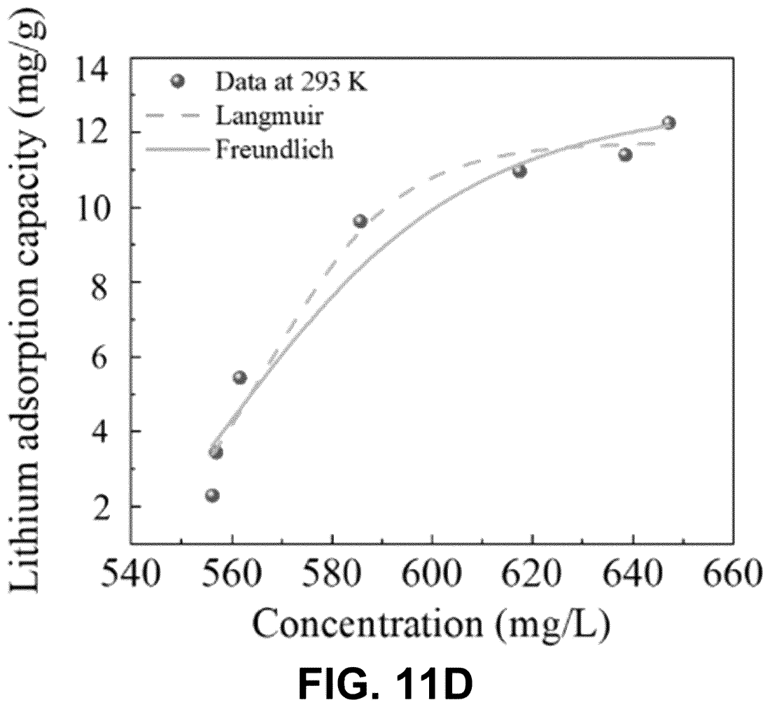

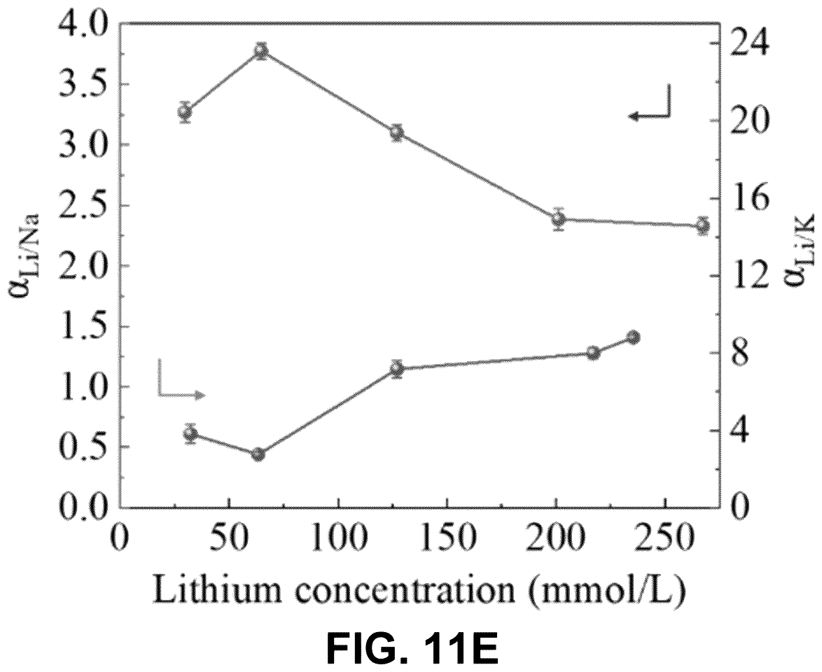

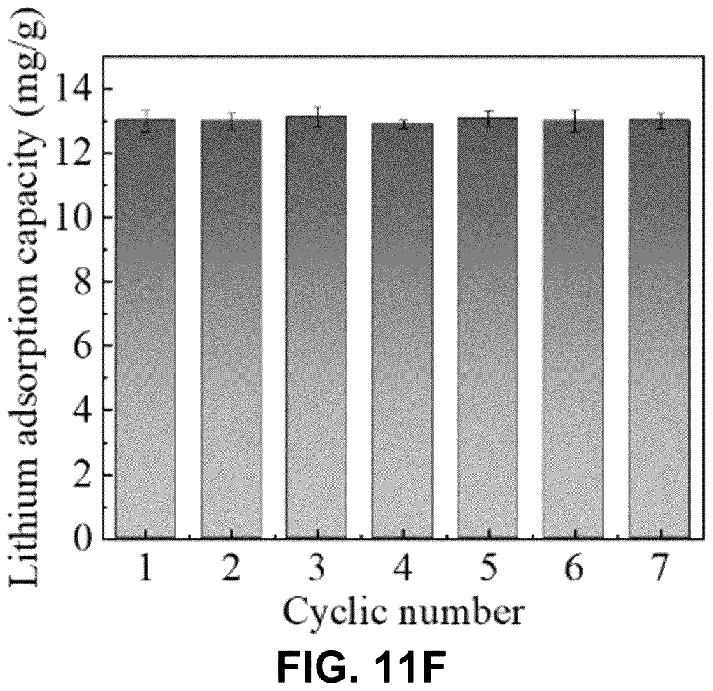

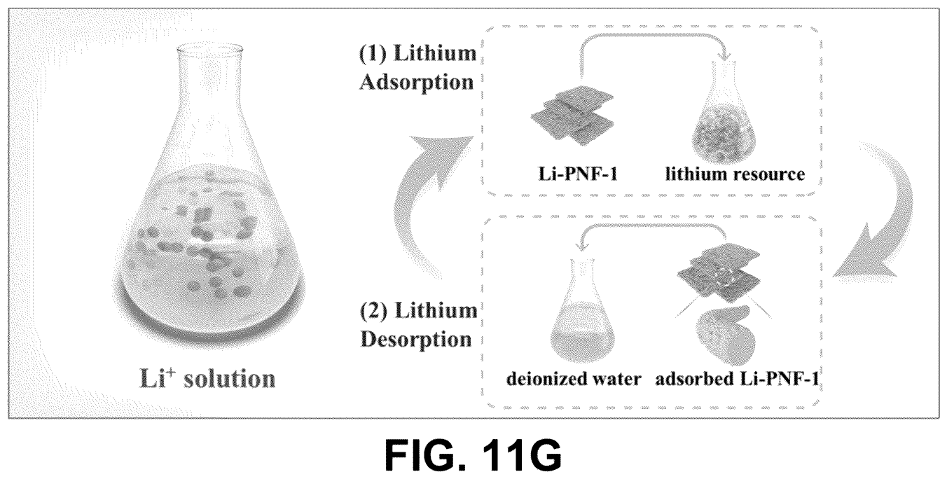

Lithium Extraction. To assess the lithium extraction performance of Li-PNFs, lithium adsorption experiments were carried out in systems containing different initial Li⁺ concentrations, and the results are shown in FIG. 11A. The adsorption behavior of various Li⁻ PNFs demonstrated a pattern where it first increased and then decreased with the increasing Li⁺ concentration. This pattern was primarily attributed to the enhanced driving force for lithium adsorption as the concentration of Li⁺ ions increases initially. Conversely, at higher concentrations, the decrease in adsorption was mainly due to the oversaturation of adsorption sites and detrimental changes in the chemical environment of the adsorption medium. These changes, triggered by high concentrations of Li⁺ ions, led to the desorption of previously adsorbed Li⁺ ions. Specifically, the Li-PNFs-1 exhibited the most effective lithium adsorption, achieving a maximum capacity of 13.45 mg/g at an initial Li⁺ concentration of approximately 600 mg/L. This superior performance was primarily attributed to an optimal Li/Al-LDH content within the fiber, facilitating a more uniform dispersion of adsorption sites across the fiber, thereby preventing the aggregation and reduced effective surface area observed with higher LDH concentrations.

On the other hand, the influence of pH and fiber dosage is illustrated in FIG. 11B, showing that a lower amount of fiber resulted in higher adsorption levels. This effect was attributed to the fact that using fewer fibers led to a higher concentration of Li⁺ ions available in the system, enhancing the driving force for adsorption⁴³. Additionally, the adsorption effect initially increased and then decreased with the rising pH, reaching an optimal level under weakly alkaline conditions. This peak in adsorption efficiency was mainly attributed to the amide group in PAN achieving its optimal protonation state in these conditions, which most effectively facilitated the interaction between PAN/LDH and Li⁺ ions.

To further elucidate the lithium adsorption mechanism, lithium adsorption isotherm and kinetics using Li-PNFs-1 are presented in FIG. 11C-D. The lithium adsorption reached equilibrium within 60 min, stabilizing at 13.00 mg/g. This behavior aligned with the pseudo-second-order model, indicating that the adsorption process involved chemical reactions, with adsorption rates depending on the availability of adsorption sites and the chemical bonds formed during the adsorption⁴⁴. The adsorption isotherm at 293 K followed the Langmuir model, suggesting that the adsorbent's surface contained homogeneous adsorption sites, each capable of adsorbing only one molecule⁴⁵. Once an adsorption site was occupied, no additional molecules could be adsorbed at that site. Moreover, the adsorption equilibrium remained constant and did not fluctuate with temperature changes. The adsorption selectivity is highlighted in FIG. 11E, demonstrating Li-PNFs-1's effective selectivity for Li⁺ and its greater selectivity for Li⁺ over K⁺ compared to Na⁺, which was primarily due to the larger ionic radius of K⁺ relative to Na⁺.

The adsorption-desorption cycling performance of materials is crucial for evaluating their suitability for recycling and industrial applications. FIG. 11F illustrates the adsorption capacity when Li-PNFs-1 was subjected to seven cycles. Notably, the lithium adsorption capacity of Li-PNFs-1 remained stable at 13.00 mg/g even after seven cycles, underscoring the material's excellent recyclability and regeneration potential. This stability provided compelling evidence of the industrial adoptability of Li-PNFs-1, showcasing its consistent performance over multiple cycles. A schematic diagram illustrating the utilization of Li-PNFs-1 in the lithium extraction process is presented in FIG. 11G. During the adsorption phase, Li⁺ ions were effectively captured by the nanosorbent under specific conditions. Subsequently, the adsorbed nanosorbent underwent desorption using deionized water to release the Li⁺ ions into the surroundings. Following this, the Li-enriched solution was reclaimed for recycling, while the regenerated Li-PNFs-1 could be reintegrated into subsequent adsorption and desorption cycles.

### 2. Compositions and Methods for Fibrous Polymer-Modified Layered Double Hydroxide

Introduction. As the demand for renewable energy grows and the world pivots toward a low-carbon future, the need for crucial energy elements is intensifying^{44, 45}. Lithium, in particular, holds a role in contemporary technology, chiefly in the realms of lithium-ion battery development, the electric vehicle revolution, and the integration with renewable energy systems such as grid storage⁴⁶⁻⁴⁸. Lithium's high energy density and robust electrochemical stability are properties that greatly enhance these applications, positioning it as a central element in shifting industries from fossil fuel reliance to clean, green energy solutions⁴⁹. Notably, global lithium consumption is projected to surge from 37 kilotons in 2016 to 380,000 kilotons by 2028⁵⁰. Consequently, the extraction and recovery of lithium from natural and spent resources has become a critical focus of contemporary research.

Numerous techniques are available for extracting lithium from liquid resources like brine, each with distinct advantages and challenges. These methods include evaporation ponds, chemical precipitation, membrane separation, solvent extraction, electrochemical methods, and adsorption separation. The evaporation pond method uses solar energy, making it low-cost but time-intensive and environmentally harmful, causing water table depletion and soil salinization⁵¹. Chemical precipitation yields high lithium recovery by adding reagents to produce lithium carbonate, but it is expensive and environmentally polluting⁵². Membrane separation, through reverse osmosis or nanofiltration, offers precise control but faces challenges with long-term membrane stability and contamination⁵³. Solvent extraction uses organic solvents to extract lithium ions, posing significant environmental risks⁵⁴. Electrochemical methods, including electrolysis and electrodialysis, are energy-efficient and effective but require advanced technical expertise and sophisticated equipment⁵⁵.

Layered double hydroxides (LDHs) are a class of compounds distinguished by their layered structure, consisting of a cationic metal hydroxide layer and a negatively charged anionic layer⁵⁷. This structure allows for the insertion of various ions and molecules into the platelets and interlayers, granting LDHs high ion-exchange capacity and structural tunability. Among these compounds, Li/Al-LDH is notable for its specific Li⁺ adsorption capacity. Its chemical formula is LiAl₂(OH)₆A_{x/n}·mH₂O, where A represents the exchangeable anion. Zhang et. al devised an interlayer confinement imprinting method to successfully improve the lithium adsorption performance in low-grade sulfate-type brines by preparing Li/Al-LDH imprinted with SO₄²⁻ (ILDH)⁵⁸. Pan et.al developed a novel Li/Al-LDH granules by using PVC and PMMA as binder, improving the volumetric adsorption capacity up to 4,710.12 mg/L from Qarhan salt lake brine⁵⁹. However, there are still challenges in improving the Li⁺ mass transfer and adsorption rate, as well as in ensuring the dispersion and mechanical strength of Li/Al-LDH. Therefore, there is a need for Li/Al-LDH material with enhanced adsorption efficiency and greater material stability.

Nanotechnology, involving the study and application of the unique physical, chemical, and biological properties exhibited by materials at the nanoscale (ranging from 1 to 100 nm), has made recent advancements⁶⁰. It has improved the synthesis and preparation of materials, leading to diverse applications in electronics, energy, medicine, and environmental fields⁶¹. For instance, by leveraging nanotechnology, the structure and surface properties of adsorbent materials, including nano-oxides, carbon-based nanomaterials, and nanocomposites, can be optimized to enhance their performance⁶². Behpour et al. directly synthesized a carboxamide-functionalized magnetic nanocomposite, Fe₃O₄@SiO₂—NH₂@Dialdehyde cellulose (DAC)@CNT-COOH and used it as an adsorbent for the successful synergistic extraction of seven agricultural pesticides and herbicides from vegetable, fruit, and water samples⁶³.

Electrospinning is a nanotechnology technique that prepares nanofibers from a solution or melts using electrostatic forces. By applying high voltage, the solution or melt forms a jet stream that is stretched and solidified under the influence of an electric field, producing fibers with nanometer-scale diameters⁶⁴. When applied to adsorption and ion extraction, these nanofibers offer numerous advantages, including excellent adsorption rates, tunable pore structures, and multifunctionality with surface modifiability. Chen et al. synthesized hyperbranched amidoxime group-grafted photothermal electrospun fibers (AOPEI-C-PAN fibers) using electrospinning. These fibers were employed for the adsorption and extraction of uranium resources from seawater, achieving an adsorption capacity of 9.54 mg/g⁶⁵. Besides, Li et.al prepared a lithium-ion sieve (H_{1.6}Mn_{1.6}O₄) with a porous nanofiber structure imitating the loofah skeleton through electrospinning and high-temperature calcination. This material exhibited a 94.44% higher Li⁺ adsorption rate and 33.90% higher adsorption capacity, indicating an extraordinary potential for extracting Li⁺ from salt lake brine⁶⁶. Inspired by these studies, applying nanotechnology, particularly electrospinning, to the synthesis and enhancement of conventional Li/Al-LDH materials holds significant promise and certainly makes a great contribution to lithium extraction field.

Herein is discussed extracting lithium from brine using electrospun-Li/Al-LDH porous nanosorbent fibers (Li-PNFs) within a fixed-bed continuous adsorption/desorption system. Initially, the microstructures and crystal atomic configurations of the Li-PNFs were analyzed using Transmission Electron Microscopy (TEM), high-resolution transmission electron microscopy (HRTEM) with high-angle annular dark-field imaging (HAADF). Simultaneously, wide-angle X-ray diffraction (XRD), Fourier Transform Infrared Spectroscopy (FTIR), and Brunner-Emmett-Teller (BET) analyses were employed to compare the chemical compositions and physical pore size distributions of Li-PNFs and Li/Al-LDH. The static adsorption capacity of the Li/Al-LDH adsorbent was also assessed and juxtaposed with that of Li-PNFs. Density Functional Theory (DFT) calculations corroborated the enhanced binding capacity of these fibers for lithium. Later, the dynamics of the fixed-bed adsorption process are examined, including the impact of feed flow rate, initial lithium concentration, and bed height on fluid penetration. Empirical model fitting was utilized to predict adsorption penetration curves under various conditions, underscoring the practicality of Li-PNFs as lithium adsorbents. Additionally, investigations into the effects of feed flow rate, lithium concentration in the desorption solution, and temperature during the desorption stage informed the optimization strategies for lithium recovery are presented.

Material and fabrication of the Li-PNFs. To develop the Li/Al-LDH powdered adsorbent, LiCl, AlCl₃·6H₂O, and NaOH were procured from Thermo Fisher Scientific, USA, and utilized through a co-precipitation method⁵⁹. A portion of the Li/Al-LDH powder was used as an adsorbent for comparison, while another portion was used to prepare Li/Al-LDH nanosorbent fibers. For this fibrillation, polyacrylonitrile (PAN) and N, N-dimethylformamide (DMF), both procured from Thermo Fisher Scientific, USA, were utilized as the binder and solvent, respectively. Initially, a precise amount of PAN was dissolved in a DMF solution at 333 K with continuous stirring at 800 rpm for 2 hours to obtain a homogeneous PAN solution, maintaining a liquid-to-solid ratio of DMF to PAN at 10 mL/1 g. Subsequently, a specific quantity of Li/Al-LDH powder was introduced into the solution and stirred at 1500 rpm for 1 hour to form a suspension, with an LDH content of 8.70 wt. %. The prepared suspension was then loaded into a 10 ml syringe and fed into the electrospinning machine. The solution was uniformly pumped into the high-voltage electric field at a rate of 4 mL/h, under conditions of 20% humidity and 20 kV voltage. The resulting fibers were collected at 40 cm from the nozzle and subsequently vacuum dried at 323 K for 12 hours. The final dried product was cut into square flakes with 8 mm sides, yielding the Li-PNFs. The remaining Li/Al-LDH powder was employed as a comparison subject to demonstrate the application advantages of Li-PNFs.

For the synthesis of synthetic brine, LiCl, NaCl, KCl, CaCl₂, and MgCl₂·6H₂O were used, all purchased from Thermo Fisher Scientific, USA, and utilized without further purification. The detailed composition of the synthetic brine is provided in Table 6.

TABLE 6
Elemental composition (mg/L) and pH value of the synthetic brine.

| Li | Na | Mg | K | Ca | pH value |
|---|---|---|---|---|---|
| 800 | 120,000 | 20 | 25,000 | 0.32 | 5.00 |

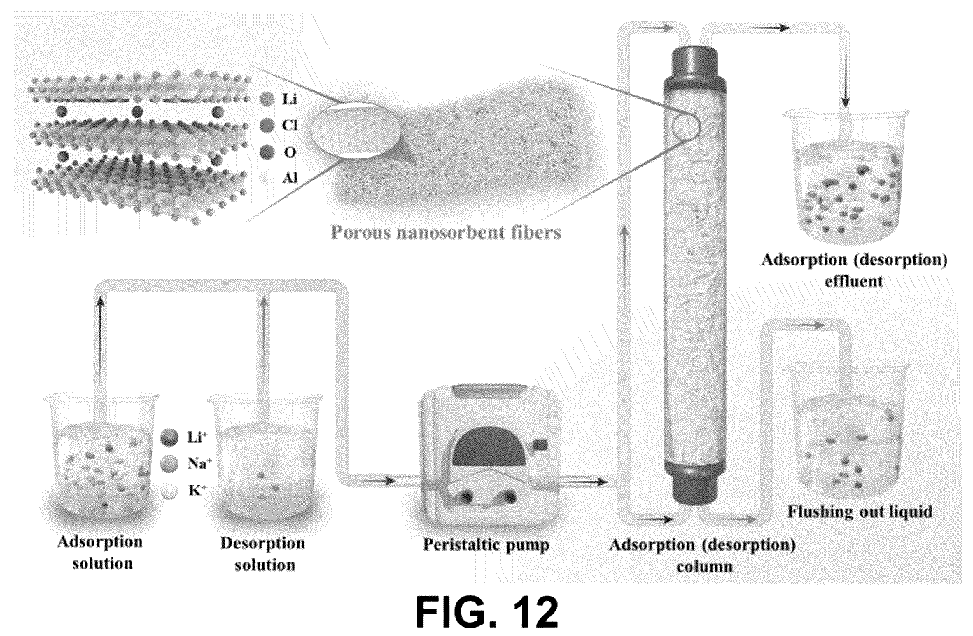

Fixed-bed adsorption and desorption. 3.10 grams of the prepared Li-PNFs were packed as uniformly as possible into a glass chromatography column with dimensions of 10 mm in diameter and 30 cm in height. Fixed-bed adsorption and desorption experiments were conducted subsequently. As illustrated in FIG. 12, synthetic brine was initially pumped into the chromatographic column from the bottom at a controlled uniform flow rate. The brine traversed through the bed to the top of the column, where the effluent was collected to monitor adsorption effectiveness by measuring the lithium concentration. Following the adsorption stage, the bed was rinsed from top to bottom using deionized water at 0° C. This step was performed in order to stabilize the properties of the adsorbent fibers and remove any residual brine within the interstices of the fibers. The final stage involved fixed-bed desorption, utilizing a solution containing a low concentration of Li⁺ ions to elute the lithium adsorbed onto the fibers. The desorption process was conducted from the bottom to up with the effluent collected at the top of the column. The desorption effectiveness was evaluated by analyzing the lithium concentration and volume of the effluent.

During the adsorption stage, the effect of varying feed flow rates (Q: 1.80 mL/min, 2.56 mL/min, and 3.14 mL/min), initial Li⁺ concentrations (600 mg/L, 700 mg/L, and 800 mg/L), and different bed heights (BH: 20 cm, 25 cm, and 30 cm) were systematically examined. Detailed experimental parameters for these investigations are provided in Table 7. During the rinsing stage, a 0° C. wash solution was introduced into the bed at a flow rate of 6.4 mL/min and maintained for 10 min. In the subsequent desorption stage, the influences of different feed flow rates (Q: 1.80 mL/min, 2.56 mL/min, and 3.14 mL/min), Li⁺ concentrations in the desorption solution (0 mg/L, 100 mg/L, and 200 mg/L), and temperatures (T: 20° C., 40°° C., and 60° C.) were explored. The specific experimental conditions for these studies are detailed in Table 8.

TABLE 7
Experimental parameters of fixed-bed adsorption phase.

| Serial | Initial Li⁺ concentration | Packing | BH | Q |
|---|---|---|---|---|
| number | in synthetic brine (mg/L) | amount (g) | (cm) | (mL/min) |
| 1 | 600 | 3.10 | 30 | 1.80 |
| 2 | 600 | 3.10 | 30 | 2.36 |
| 3 | 600 | 3.10 | 30 | 3.14 |
| 4 | 600 | 3.10 | 30 | 1.80 |
| 5 | 700 | 3.10 | 30 | 1.80 |
| 6 | 800 | 3.10 | 30 | 1.80 |
| 7 | 800 | 3.10 | 20 | 1.80 |
| 8 | 800 | 3.10 | 25 | 1.80 |
| 9 | 800 | 3.10 | 30 | 1.80 |

TABLE 8
Experimental parameters of fixed-bed desorption phase.

| Serial | Li⁺ concentration in | T | Q |
|---|---|---|---|
| number | desorption solution (mg/L) | (° C.) | (mL/min) |
| 10 | 0 | 20 | 1.80 |
| 11 | 0 | 20 | 2.36 |
| 12 | 0 | 20 | 3.14 |
| 13 | 0 | 20 | 1.80 |
| 14 | 100 | 20 | 1.80 |
| 15 | 200 | 20 | 1.80 |
| 16 | 0 | 20 | 1.80 |
| 17 | 0 | 40 | 1.80 |
| 18 | 0 | 60 | 1.80 |

The adsorption breakthrough curve is a critical indicator for evaluating the performance of a fixed bed. It reflects the adsorption equilibrium relationship between the brine and the Li-PNFs, as well as the adsorption kinetics and mass transfer mechanisms. In this study, the breakthrough curve represents the variation of Cₜ/C₀ over time t, providing insights into the dynamic adsorption behavior within the system. In addition, the lithium extraction rate Eᵣ (%) was calculated using the following equation:

$${E}_{r} = 100 \times \frac{{C}_{0} - {C}_{final}}{{C}_{0}} \qquad ( 1 )$$

where C_{final} (mg/L) refers to the lithium concentration in the total final adsorption effluent, C₀ (mg/L) is the initial lithium feed concentration.

Besides, the lithium recovery rate Rt (%) in the desorption stage can be employed to evaluate the lithium desorption efficiency. The calculation was followed by Eq. (2):

$${R}_{t} = 100 \times \frac{v \cdot {C}_{d}}{{q}_{total}} \qquad ( 2 )$$

where v (L) refers to the volume of the total desorption effluent at time t, C_{d} (mg/L) means the Li⁺ concentration in the total desorption effluent at time t, qₜₒₜₐₗ (mg) is the total amount of lithium adsorbed in the adsorption stage, which can be calculated using Eq. (3):

$${q}_{total} = {v}_{0} \cdot {C}_{0} - {C}_{final} \cdot {V}_{final} \qquad ( 3 )$$

where c₀ (mg/L) and c_{final} (mg/L) mean the initial lithium concentration in the total adsorption solution and the final lithium concentration in the adsorption effluent, respectively; v₀ (L) and v_{final} (L) refer to the volume of the total adsorption solution and the finial adsorption effluent, respectively.

Characterizations. To conduct a thorough structure analysis of Li-PNFs, a combination of advanced microscopy and spectroscopic techniques was employed. TEM and HRTEM with HAADF were utilized to examine the detailed nanostructure of the fibers. The TEM images were further analyzed using the Image J software, which facilitated precise quantification and visualization of the structural details. Besides, XRD analysis was performed using a Bruker D8 diffractometer. The measurements were carried out over a 2θ range from 5° to 80°, operating at 40 kV and 40 mA. FTIR analyses were also conducted using KBr pellets to investigate the chemical bonding and functional groups within the Li-PNFs. To assess the specific surface area and pore size distribution of the Li-PNFs, N₂ adsorption-desorption isotherms were measured at 77 K using a Micromeritics 3Flex surface characterization analyzer. The BET method was employed to determine specific surface area, providing insights into the extent of the surface available for adsorption. Additionally, the Barrett-Joyner-Halenda (BJH) method was used to analyze pore size distribution, offering a detailed understanding of the porosity and pore structure. All samples requiring Li⁺ concentration analysis was measured via an inductively coupled plasma-optical emission spectrometry unit (ICP-OES, model number 5900) manufactured by Agilent, USA.

Empirical models fitting. Various empirical models have been employed to fit lithium adsorption breakthrough curves. The Clark model, originally developed to describe the adsorption of organics by activated carbon, has been applied in this context⁶⁷. This model considers mass transfer coefficients and Freundlich adsorption isotherm constants, making it versatile for a wide range of adsorption processes. The linear form of the Clark model equation is presented in Eq. (4):

$$\frac{{c}_{0}}{{c}_{t}} = {( \frac{1}{1 + A \cdot {e}^{- r \cdot t}} )}^{1 / n - 1} \qquad ( 4 )$$

where n is the Freundlich adsorption isotherm model constant, and A and r (1/h) are Clark model constants. The model constants A and r can be calculated by fitting the slope and intercept of the linear equation Eq. (5):

$$ln ( {( \frac{{c}_{0}}{{c}_{t}} )}^{1 / n - 1} - 1 ) = - r \cdot t + ln A \qquad ( 5 )$$

The Thomas model is one of the most commonly used analytical models for dynamic adsorption processes⁶⁸. It assumes that the adsorption equilibrium follows the Langmuir adsorption isotherm, and that the adsorption kinetics adhere to a second-order reversible kinetic equation, applicable in scenarios where internal and external diffusion are minimal. The Thomas model equation is expressed as Eq. (6):

$$\frac{{c}_{0}}{{c}_{t}} = \frac{1}{1 + exp ( ( {k}_{T} \cdot {q}_{0} \cdot m / Q ) - {k}_{T} \cdot {c}_{0} \cdot t )} \qquad ( 6 )$$

Its linear equation can be expressed as Eq. (7):

$$ln ( \frac{{c}_{0}}{{c}_{t}} - 1 ) = \frac{{k}_{T} \cdot {q}_{0} \cdot m}{Q} - {k}_{T} \cdot {c}_{0} \cdot t \qquad ( 7 )$$

where k_{T} (L/(g·h)) is the rate constant of the Thomas model, and q₀ (mg/g) is the maximum concentration of adsorbate in the adsorbent particles.

In addition, the Yoon-Nelson model is a straightforward empirical model that can be applied without considering the specific parameters of the adsorbent, solution, or fixed bed⁶⁹. It assumes that the penetration time of the adsorbent is related to the ratio of its initial and residual concentrations, simplifying its application. The Yoon-Nelson model is expressed in Eq. (8) and can be used to determine the adsorption rate of the adsorbent within the system.

$$\frac{{c}_{t}}{{c}_{0}} = \frac{1}{1 + exp [ {K}_{YN} \cdot ( τ - t ) ]} \qquad ( 8 )$$

Its linear equation can be expressed as Eq. (9):

$$ln ( \frac{{c}_{0}}{{c}_{0} - {c}_{t}} ) = {K}_{YN} \cdot t - τ \cdot {K}_{YN} \qquad ( 9 )$$

where k_{YN} (1/h) is the rate constant of the Thomas model, and τ (h) is the time required for the adsorbate in the effluent to rise to half of the initial concentration.

Finally, the Modified-Dose-Response model is an adaptation of the Thomas model, designed to reduce its error through a simple modification⁷⁰. The equation for the Modified-Dose-Response model is presented in Eq. (10).

$$\frac{{c}_{t}}{{c}_{0}} = 1 - \frac{1}{1 + {( \frac{{c}_{0} \cdot Q \cdot t}{{q}_{Y} \cdot m} )}^{{a}_{Y}}} \qquad ( 10 )$$

Its linear equation can be expressed as Eq. (11):

$$ln ( \frac{{c}_{t}}{{c}_{0} - {c}_{t}} ) = {a}_{Y} ln t + {a}_{Y} ln \frac{{c}_{0} \cdot Q}{{q}_{Y} \cdot m} \qquad ( 11 )$$

where a_{Y} is the constant of this model, and q_{Y} (mg/g) is the maximum concentration of adsorbent in the adsorbent particles.

DFT calculations. DFT calculations were performed using the Cambridge Serial Total Energy Package code. The Perdew-Burke-Ernzerhof functional within the generalized gradient approximation was used for exchange-correlation, and the projector augmented-wave pseudopotential with a kinetic energy cut-off of 381.0 eV described the electronic eigenfunctions. Brillouin-zone integration employed a Γ-centered 10×10×10 Monkhorst-Pack k-point mesh. All atomic positions were fully relaxed with a self-consistent field (SCF) tolerance of 1×10⁻⁵ eV, and the electronic minimization used density mixing. Besides, in this study, Li⁺ binding energy of three different sites was predicted from the difference between the energies of the species before and after adsorption (Eq. (12)).

$${E}_{ads} = {E}_{tot} - {E}_{0} - {E}_{base} \qquad ( 12 )$$

where Eₜₒₜ (eV) is the total energy of adsorption system, E₀ (eV) the energy of adsorbent surface, and E_{base} (eV) the energy of the adsorbate.

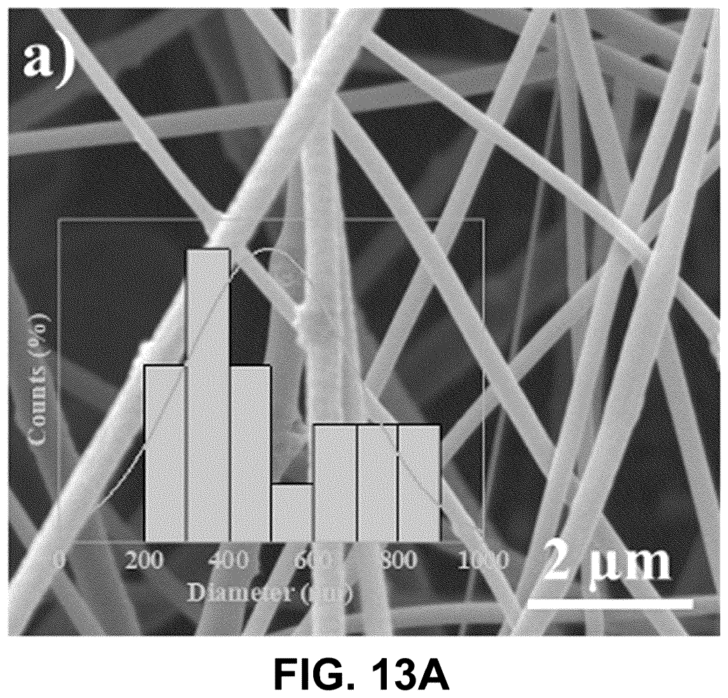

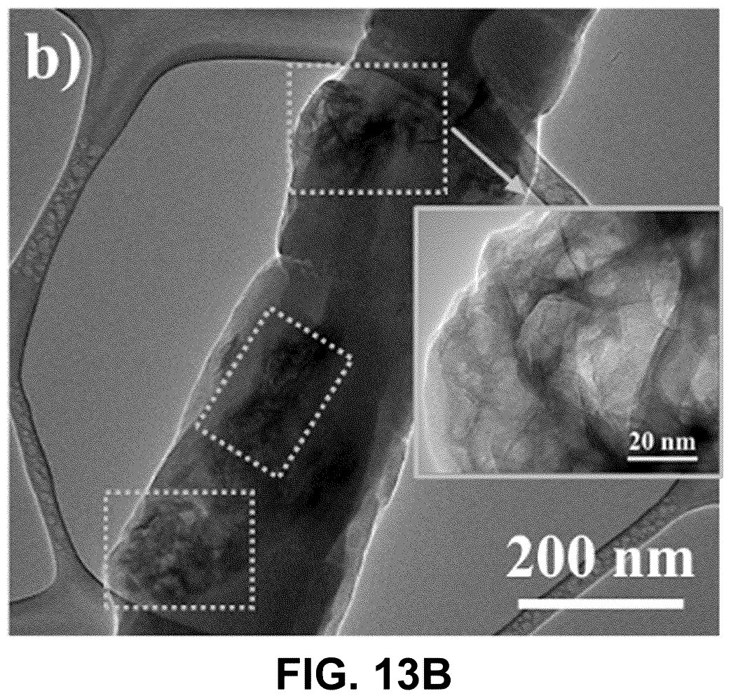

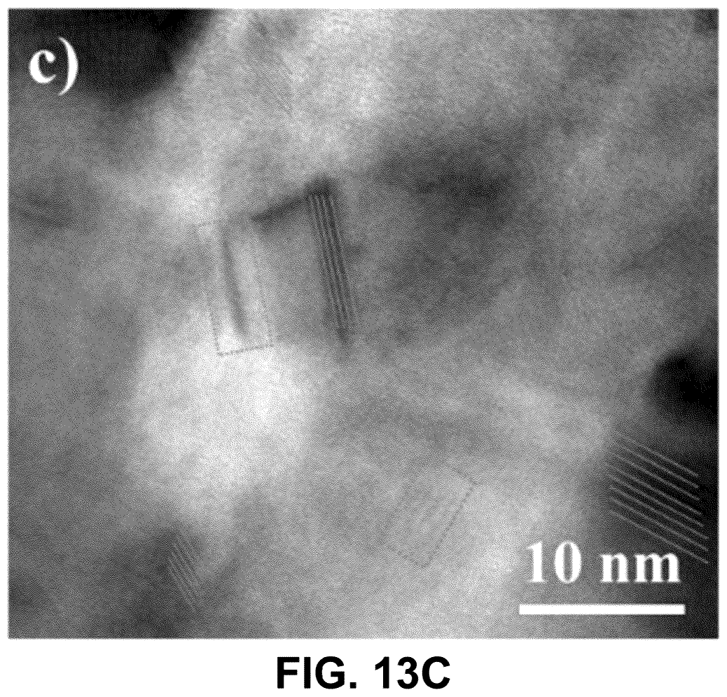

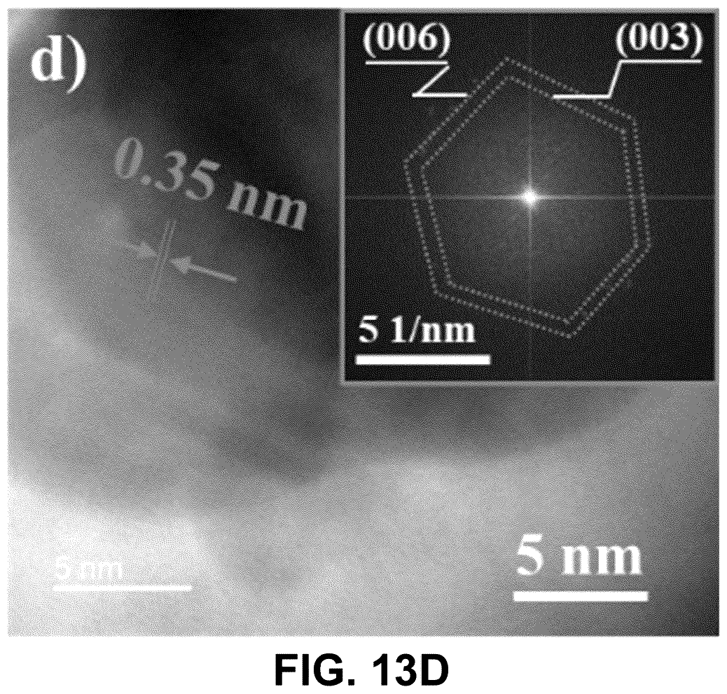

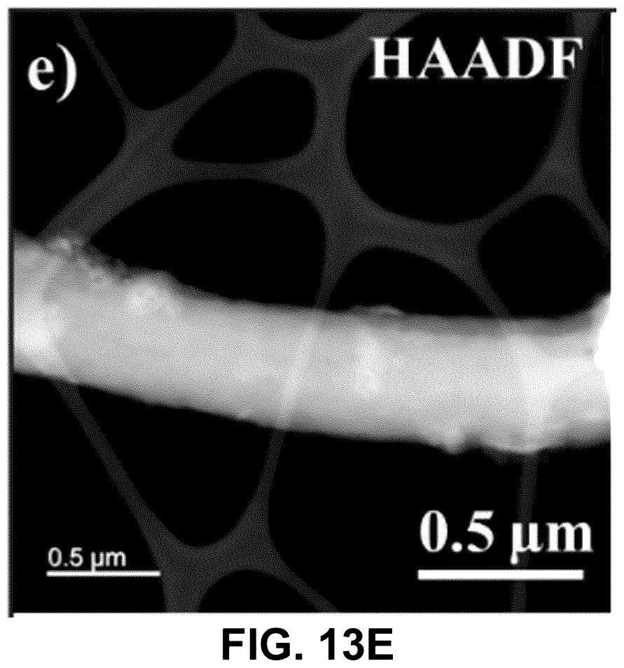

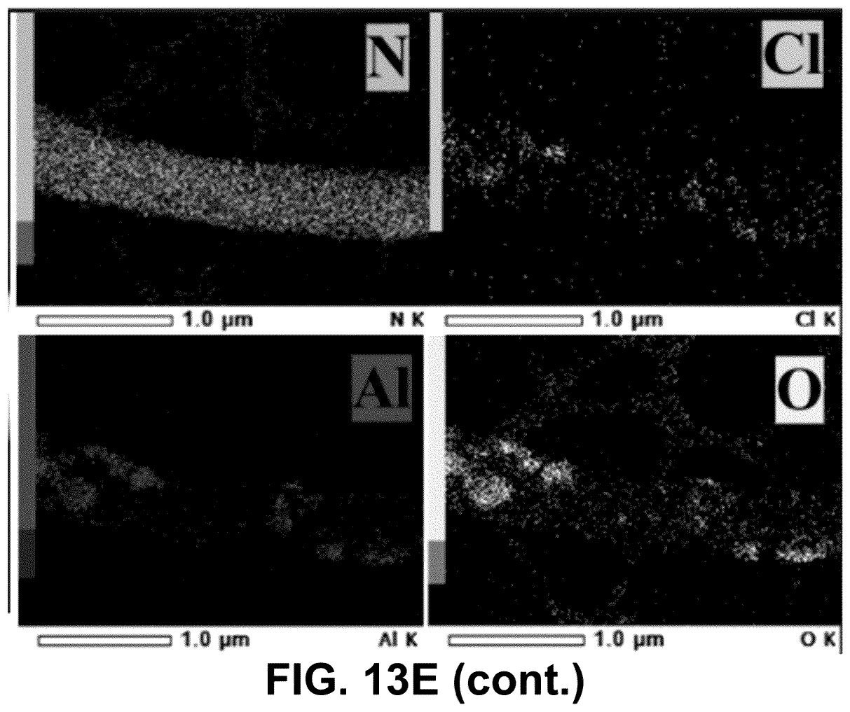

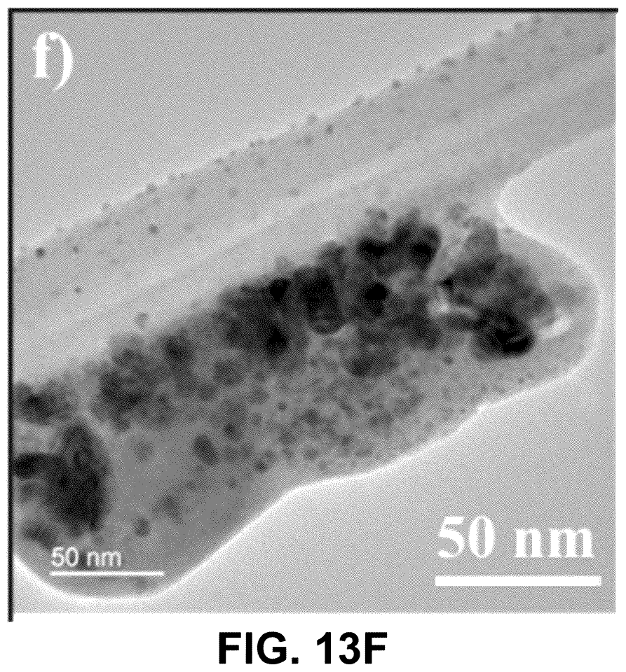

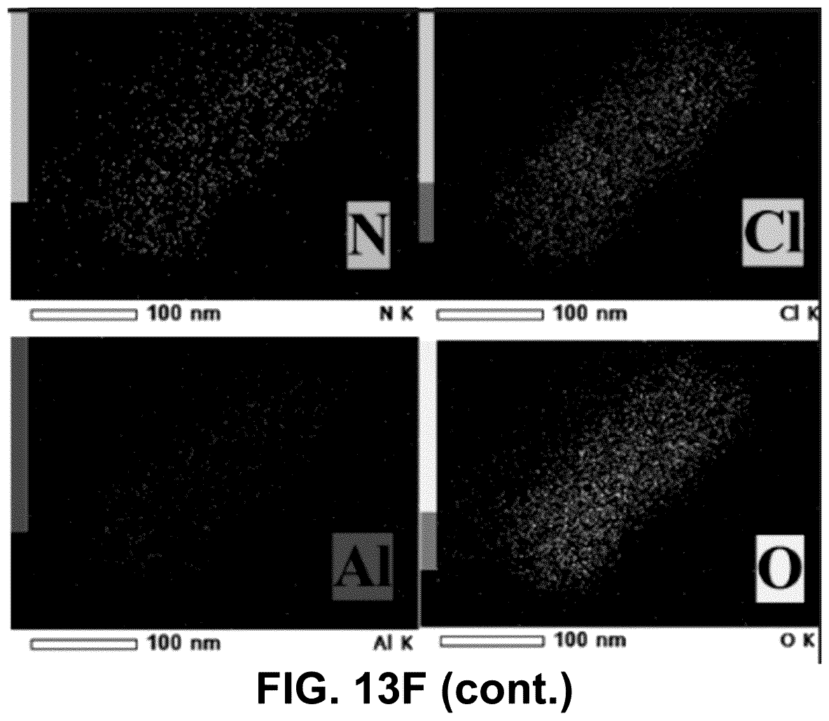

Physiochemical properties. The morphology and internal structure of Li-PNFs was assessed, as well as determine the orientation of specific crystals, electron microscopy coupled with SAED was employed. As illustrated in FIG. 13A, the SEM image reveals that the Li-PNFs formed a three-dimensional interconnected mesh with predominantly smooth fibers having diameters around 500 nm⁷¹. The TEM image in FIG. 13B shows the internal microstructure at higher magnification, where needle-like Li/A-LDH aggregates are visible on the fibers⁷². These aggregates were either vertically distributed or horizontally aligned along the fiber structure. Besides, the HRTEM image in FIG. 13C demonstrates that these needle-like Li/Al-LDH aggregates possessed a layer-by-layer configuration, which is clearly visible in some areas and less so in others due to their irregular three-dimensional arrangement⁷³. The HAADF image in FIG. 13D confirms that the characteristic interlayer distance is approximately 0.35 nm. Additionally, these needle-like Li/A-LDH aggregates exhibited a regular hexagonal crystal structure, showcasing typical (003) and (006) crystal faces^{74, 75}.

EDS mapping, as depicted in FIG. 13E and FIG. 13F, was performed on different regions of the fibers. It showed that nitrogen (N) atoms were uniformly distributed along a section of the fiber, whereas chlorine (Cl), aluminum (Al), and oxygen (O), representing Li/A-LDH, were nonuniformly distributed, indicating an uneven distribution of Li/A-LDH on the PAN-based fiber. The Cl distribution was particularly less noticeable, likely because Cl ions primarily existed in the interlayers of Li/Al-LDH, making them difficult to detect⁷⁶. FIG. 13F provides the elemental distribution in another region, where needle-like Li/Al-LDH aggregates extend beyond the fiber. Here, a uniform distribution of N, O, Al, and O was observed, differing slightly from the Li/Al-LDH encapsulated within the fiber. In summary, the Li-PNFs fibers, approximately 500 nm in diameter, exhibited a three-dimensional interconnected network with needle-like Li/Al-LDH irregularly embedded within the PAN-based fiber in a layered configuration, and some Li/Al-LDH needles extended out from the fiber.

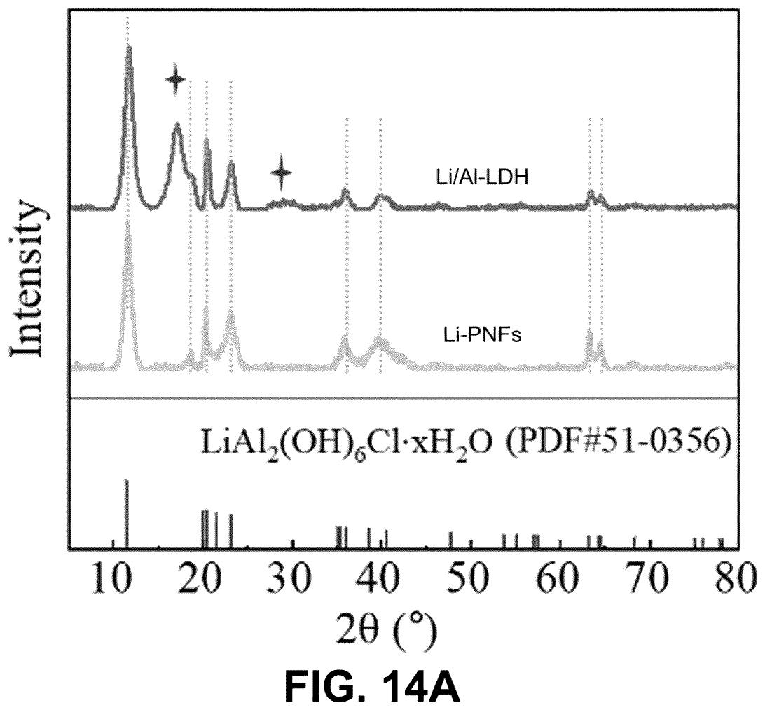

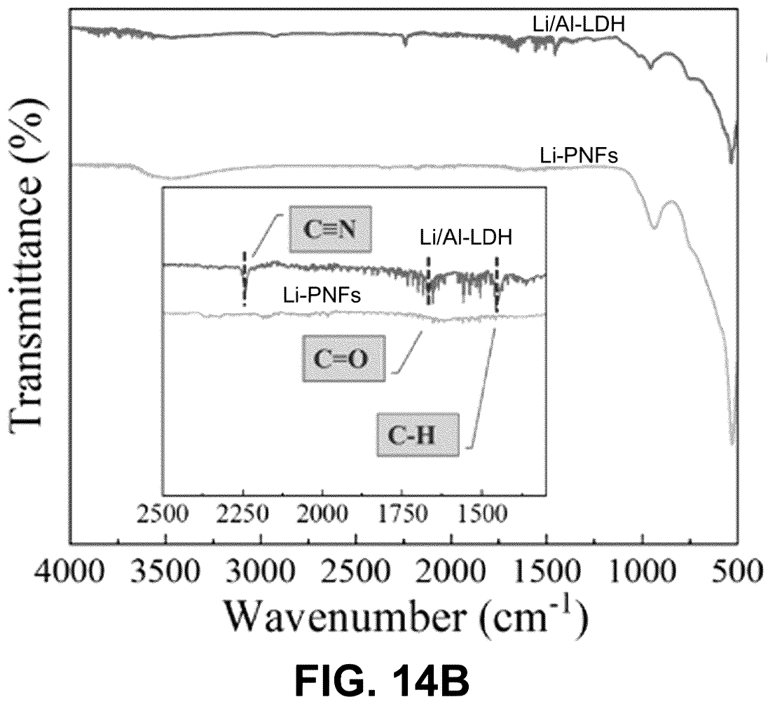

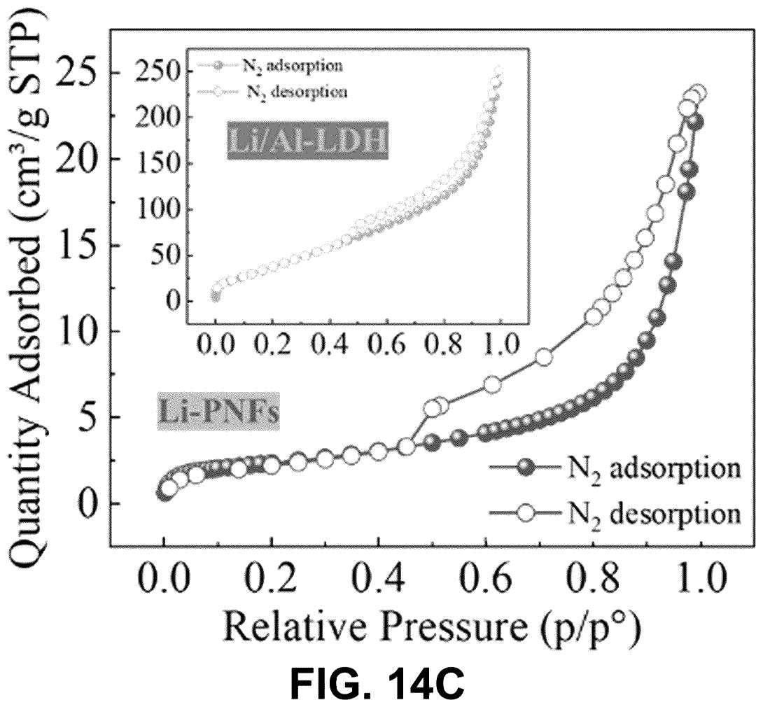

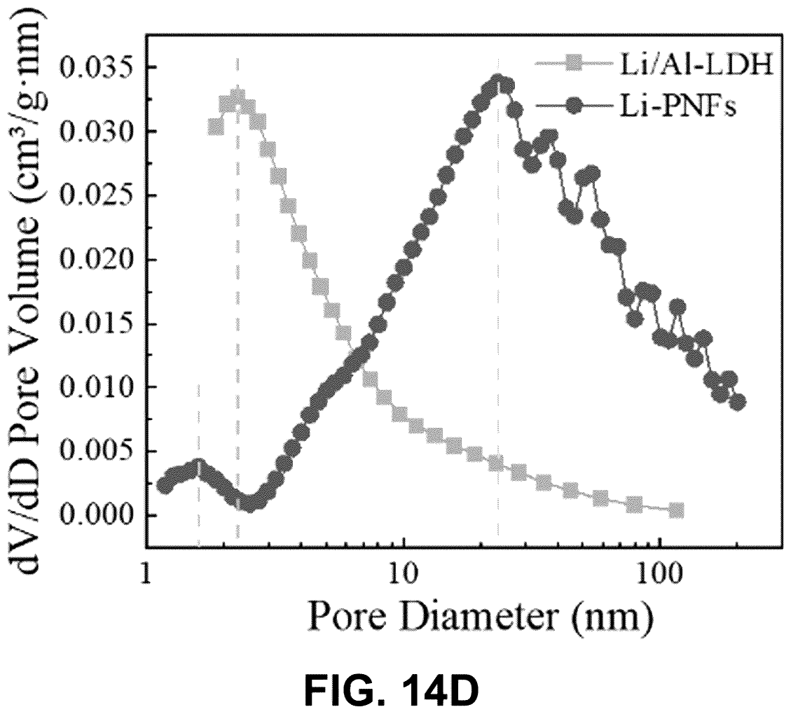

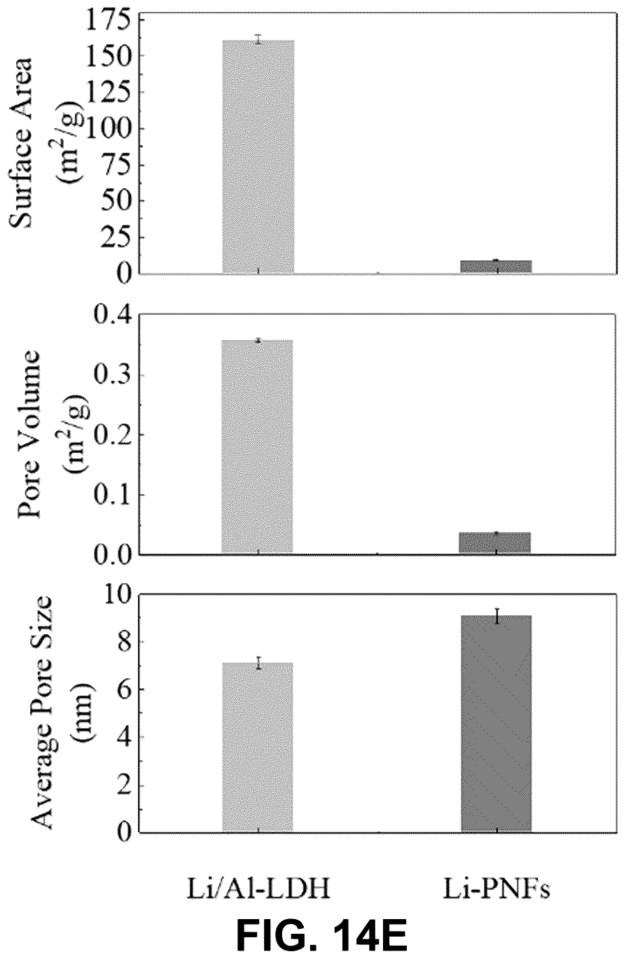

The composition and pore structure of Li-PNFs were analyzed and compared with Li/Al-LDH powder. The XRD pattern, shown in FIG. 14A, indicates that both Li-PNFs and Li/Al-LDH conform to the standard crystallographic pattern of LiAl₂(OH)₆Cl·xH₂O (Card No. 51-0356). However, for Li-PNFs, two additional peaks were observed near 17° and 26°, corresponding to PAN substances⁷⁷. Furthermore, as depicted in FIG. 14B, the FTIR spectra of both Li/Al-LDH and Li-PNFs exhibit three characteristic peaks at 957 cm⁻¹, 752 cm⁻¹, and 532 cm⁻¹, corresponding to —OH vibration, Al—O oscillation, and Al—O deformation vibration, respectively, consistent with the structure of Li/Al-LDH⁷⁸. In contrast, the FTIR spectra of Li-PNFs revealed additional peaks at 2240 cm⁻¹, 1670 cm⁻¹, and 1458 cm⁻¹, which correspond to the C≡N stretch, C═O stretching vibration, and C—H bending vibration of PAN, respectively⁷⁹.

The N₂ adsorption-desorption isotherms for Li/Al-LDH powder and Li-PNFs are presented in FIG. 14C. Both materials exhibited a gradual increase in N₂ adsorption with increasing relative pressure, followed by a significant surge around a relative pressure of 0.5. This behavior categorized the isotherms as IUPAC type IV, indicating the formation of an adsorption layer at moderate relative pressures⁸⁰. The higher N₂ adsorption observed in Li/Al-LDH suggested that it had a larger specific surface area and a more developed microporous structure compared to Li-PNFs. In addition, the pore size distributions of these two materials in FIG. 14D demonstrate that Li/Al-LDH primarily features a microporous structure, whereas Li-PNFs exhibit both micropores and mesopores, with a predominance of pores around 50 nm. The mesoporous structure helped Li-PNFs to enhance the rate of mass transfer during adsorption and reduced the resistance to molecular diffusion⁸¹. FIG. 14E further contrasts the surface area, pore volume, and average pore size of these materials. Li-PNFs had a smaller specific surface area and pore volume but a larger average pore size of approximately 9 nm. Therefore, Li-PNFs demonstrate better permeability, lower pressure drops, and higher porosity during the adsorption process, enhancing efficiency and maintaining the structural integrity of the adsorbent material.

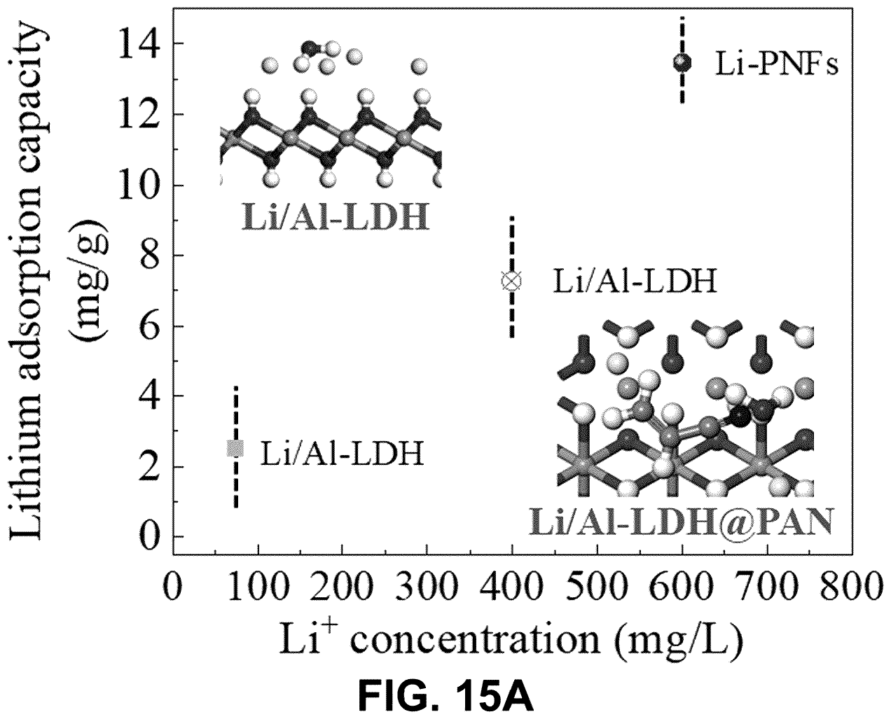

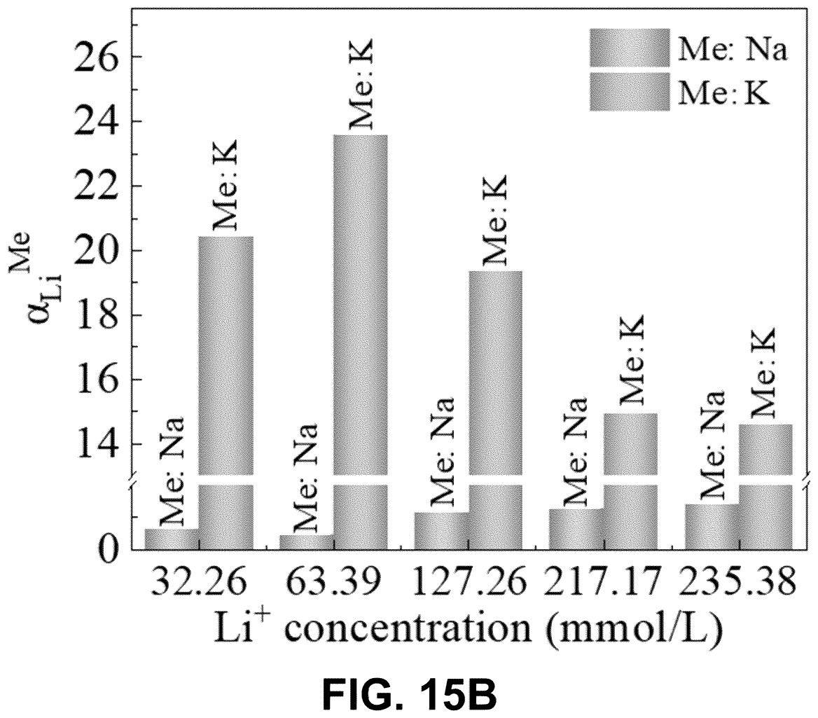

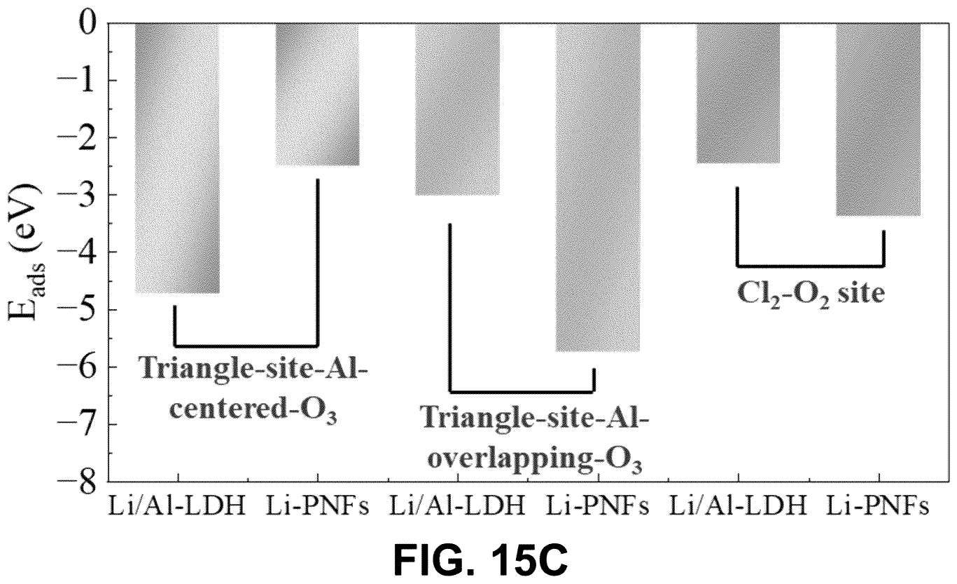

Lithium adsorption. FIG. 15A provides a summary of the static adsorption capacities of Li-PNFs and Li/Al-LDH across various lithium concentrations. It was observed that at a lower lithium concentration of 80 mg/L, typically found in produced water, the adsorption capacity of Li/Al-LDH was approximately 2.0 mg/g⁸². Conversely, at higher lithium concentrations of 400 mg/L, such as those encountered in salt lake brines, the adsorption capacity increased to 7.0 mg/g⁸³. Notably, this study leveraged PAN as a substrate to synthesize Li/Al-LDH@PAN nanosorbent fibers, which demonstrated an enhanced adsorption capacity of 13.0 mg/g at a lithium concentration of 600 mg/L. This improved adsorption was attributed to the formation of hydrogen bonds between Li/Al-LDH and PAN, which altered the original spatial structure of Li/Al-LDH to a configuration more conducive to Li⁺ uptake. Additionally, FIG. 15B details the lithium selectivity of Li-PNFs relative to potassium (K) and sodium (Na). The results indicated a pronounced selectivity for Li⁺, primarily due to the significant difference in atomic radii⁸⁴. Li me has an atomic radius of 152 pm compared to Na's 186 pm and K's 227 pm.

To delve deeper into the efficacy of Li⁺ embedding within various sites of the lamellae in Li-PNFs as compared to Li/Al-LDH, the binding energies of Li⁺ were calculated for both optimized systems at three specific sites: Triangle-site-Al-centered-O₃, Triangle-site-Al-overlapping-O₃, and Cl₂—O₂ site⁸⁵. Notably, as presented in FIG. 15C, the binding energy for Li-PNFs at the Triangle-site-Al-centered-O₃ site was recorded at −2.49 eV, which was lower than that observed for Li/Al-LDH at the same site, where it calculated −4.72 eV. Conversely, at the Triangle-site-Al-overlapping-O₃ and Cl₂—O₂ sites, the binding energies for Li-PNFs were higher, registering at −5.72 eV and −3.38 eV respectively, surpassing those of Li/Al-LDH at these sites. These results suggest that the Li⁺ binding energies in Li-PNFs are enhanced compared to the original Li/Al-LDH, thus providing enhanced Li⁺ capture performance.

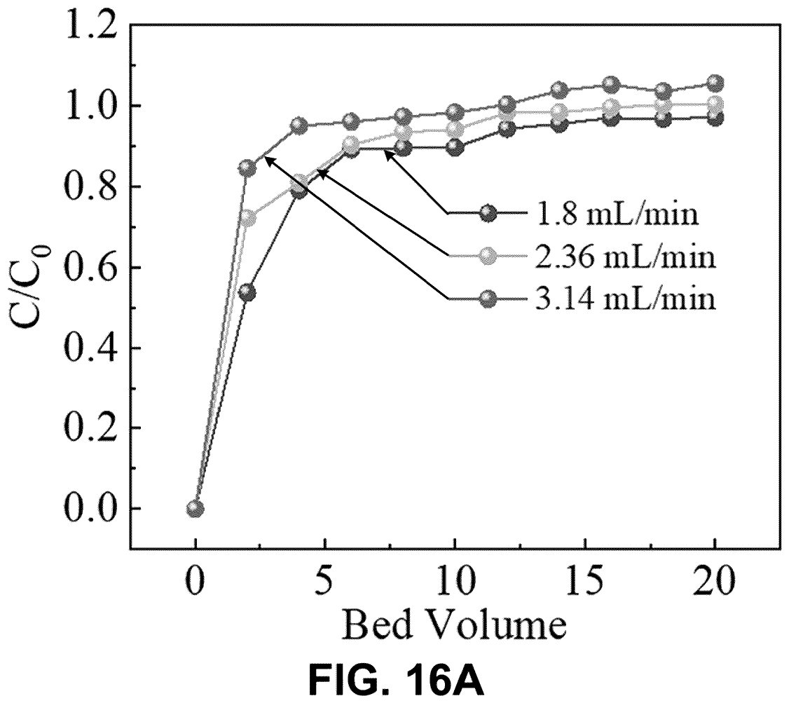

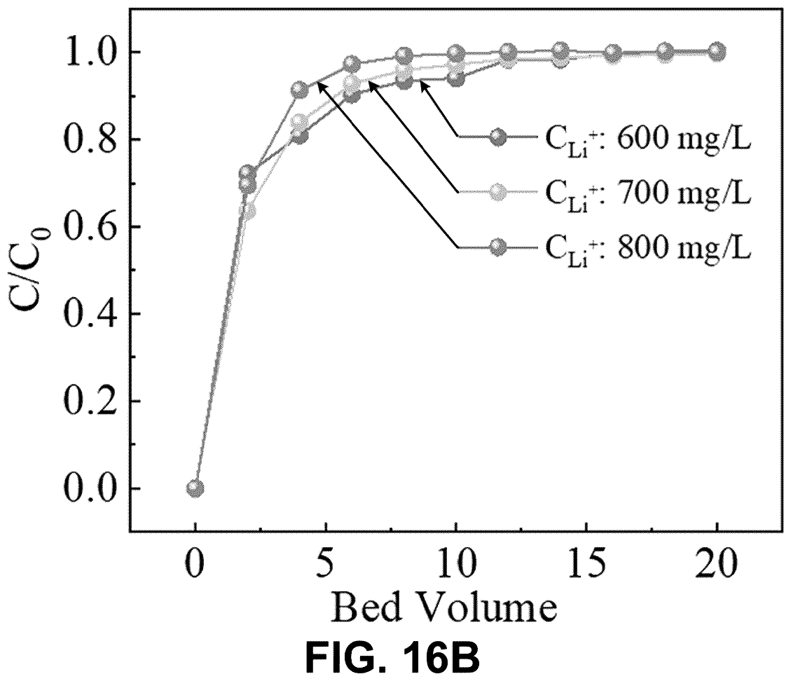

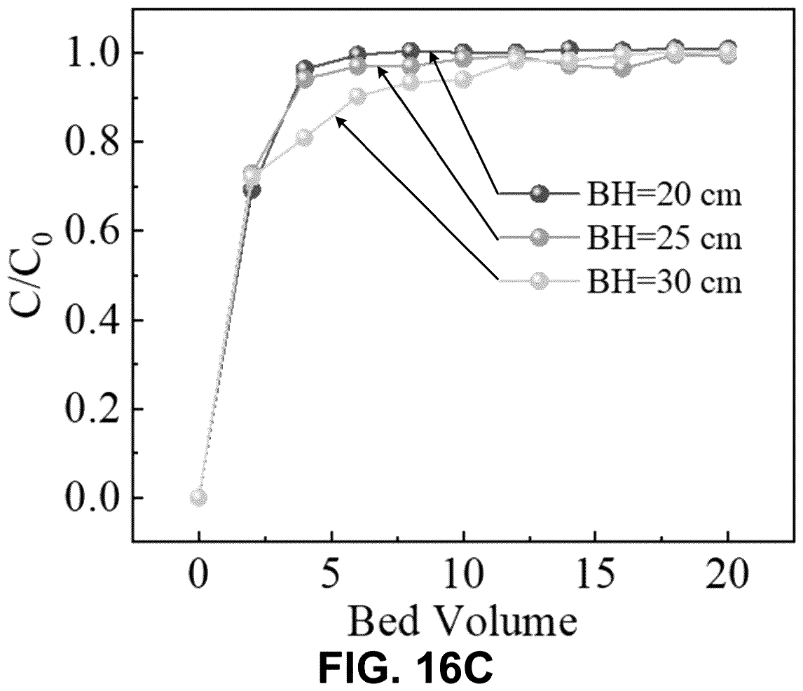

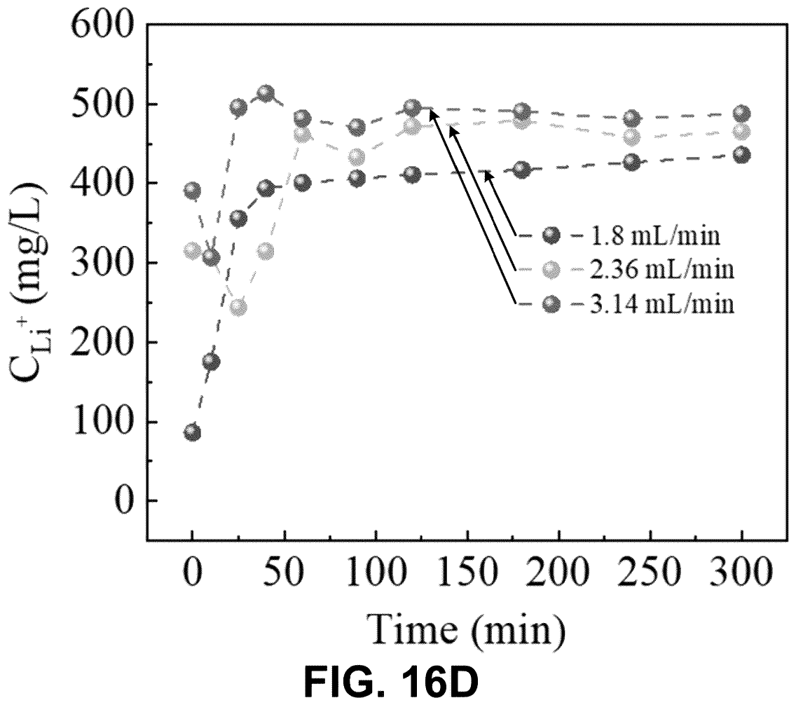

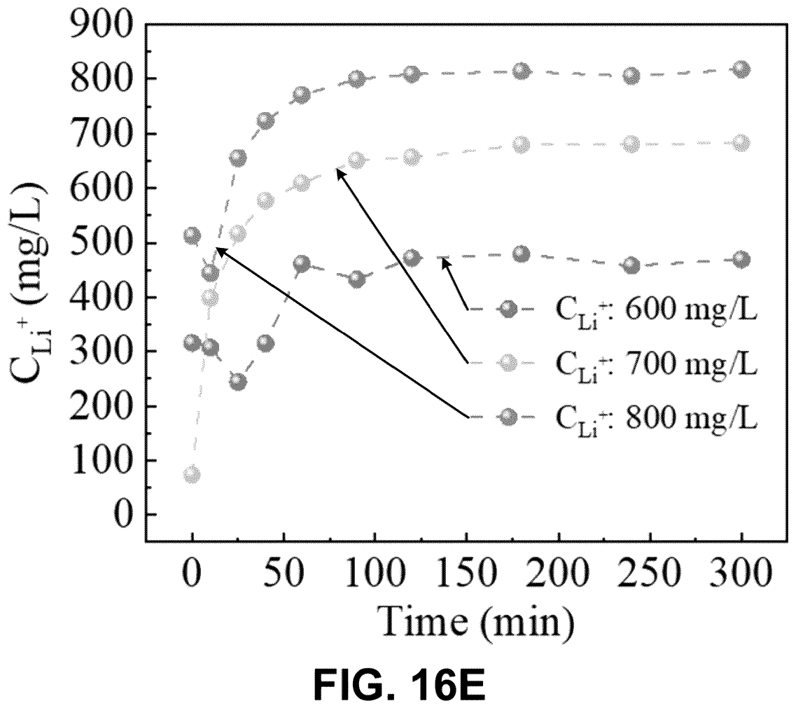

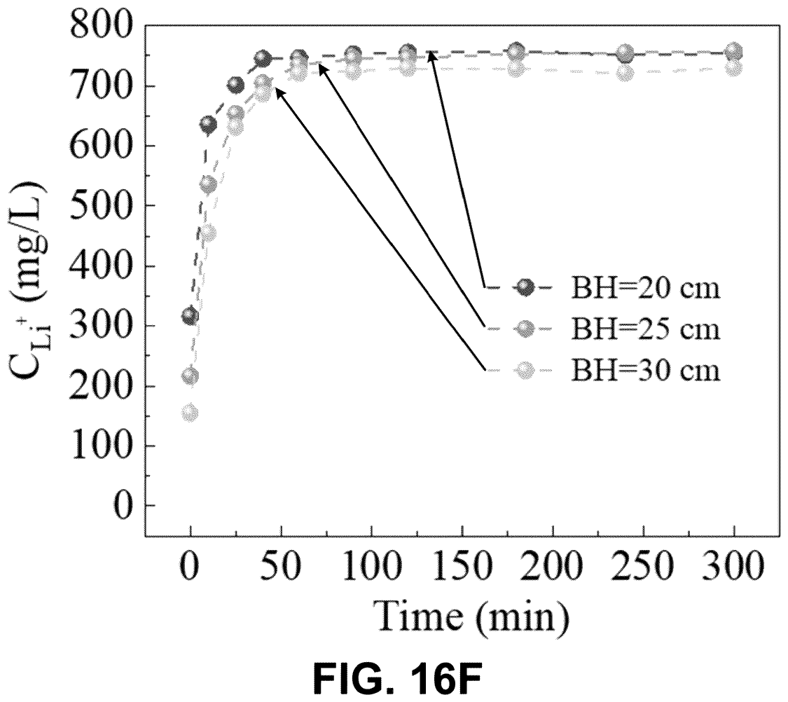

To simulate actual flow conditions during treatment processes and evaluate the industrial applicability of Li-PNFs, systematic fixed-bed adsorption experiments were conducted. Initially, adsorption penetration curves under varying feed flow rates are presented in FIG. 16A. The adsorption penetration curve refers to the change in lithium concentration at the outlet of the adsorption bed relative to the feed lithium concentration over time. Notably, the time required for bed penetration exhibited an inverse relationship with the feed flow rate, and higher flow rates resulted in shorter saturation times. Without wishing to be bound by a particular theory, this effect is believed to arise because increased flow rates reduced the contact time between the adsorbent and the solution, limiting adsorption opportunities. Additionally, higher flow rates can enhance mass transfer resistance, leading to a more pronounced channelization effect. This caused the solution to flow rapidly along specific paths within the adsorbent bed, rather than achieving uniform contact with all adsorbents. Furthermore, a comparison of the penetrated Li⁺ concentrations at different feed rates (FIG. 16D) indicates that lower flow rates resulted in lower final equilibrium penetrated Li⁺ concentrations. This suggested that slower flow rates enabled more thorough utilization of the bed's adsorbent capacity, effectively trapping more Li⁺ within the bed.

Secondly, the influence of varying initial Li⁺ concentrations in the feed was investigated, with the results depicted in FIG. 16B and FIG. 16E. It was observed that while the initial Li⁺ concentrations did not significantly alter the overall behavior of the penetration curves, distinct differences were evident among the individual penetrated Li⁺ concentration curves. Notably, the equilibrium penetrated Li⁺ concentration was directly proportional to the initial feed Li⁺ concentration, with equilibrium typically reached in approximately 120 min. At this point, the adsorbent within the bed became fully saturated and had decreased capability for adsorbing additional Li⁺. It appeared that higher initial Li⁺ concentrations in the feed resulted in a correspondingly higher amount of Li⁺ being captured by the adsorbent.

Besides, the impact of different BH on the stationary bed adsorption process was investigated. As depicted in FIG. 16C, beds with heights of 20 cm and 25 cm reached penetration at 5 bed volumes (BV) of feed, whereas a bed height of 30 cm required nearly 10 BV for penetration. This is believed to be due primarily because the increased bed height extended the fluid's pathway through the fixed bed, consequently lengthening the contact time between the fluid and the adsorbent, thereby decelerating the adsorbent's saturation rate. Moreover, variations in the penetrated Li⁺ concentrations at different BH were not pronounced, as shown in FIG. 16F. The saturated Li⁺ penetration concentration exhibited a slight inverse relationship with BH, suggesting that a higher BH enhanced the Li⁺ adsorption capacity of the bed.

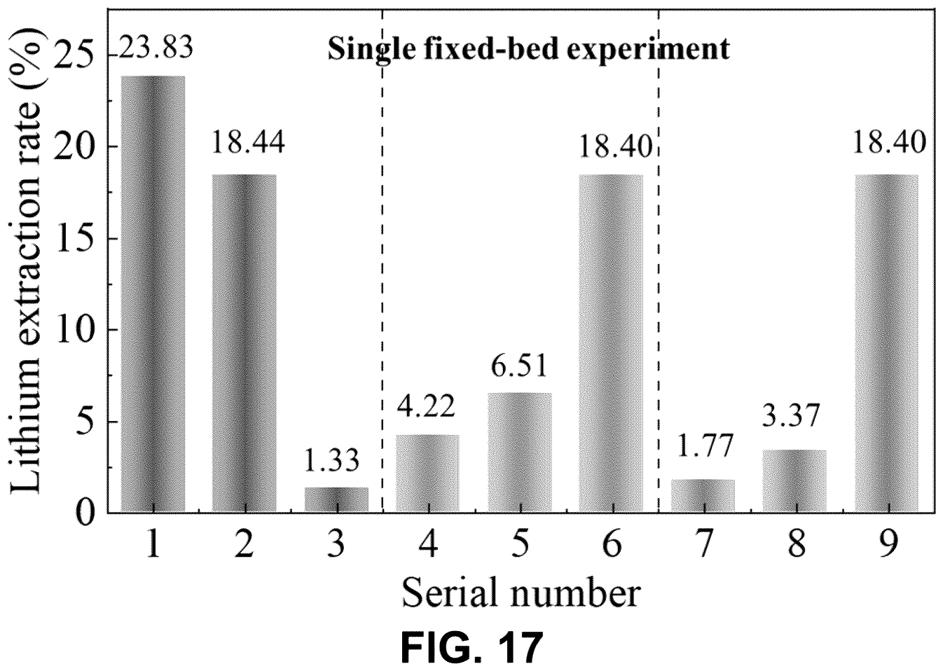

FIG. 17 presents a comparison of lithium extraction rates across different batches, providing a clear visualization of the lithium capture efficiency under various conditions. The experimental parameters and settings corresponding to serial numbers 1-9 are shown in Table 7. Notably, in the initial three experiments which compared the different feed flow rates, the fixed-bed adsorption process with a lower flow rate demonstrated a higher lithium extraction rate after a single passage through the adsorption column. Specifically, an extraction rate of 23.83% was achieved at a feed flow rate of 1.8 mL/min. Without wishing to be bound by a particular theory, this enhanced performance was believed to attributable to the longer contact time between the adsorbent and the solution at slower flow rates as aforementioned, which mitigates the negative impacts of channelization. The foregoing suggest that higher feeding Li⁺ concentrations correlated with increased extraction rates. For instance, using a feed solution with a lithium concentration of 800 mg/L resulted in an extraction rate of 18.40%. Without wishing to be bound by a particular theory, this improvement is believed to be due to the greater ionic strength differential between the interior and exterior of the adsorbent, facilitating more targeted Li⁺ capture⁸⁶. Moreover, the lithium extraction rate also showed a direct correlation with BH and an extraction rate of 18.40% was observed with a BH of 30 cm. In summary, the foregoing suggests that lower feed flow rates, higher lithium concentrations in the feed, and greater bed heights collectively enhanced the efficiency of lithium extraction in fixed-bed operations.

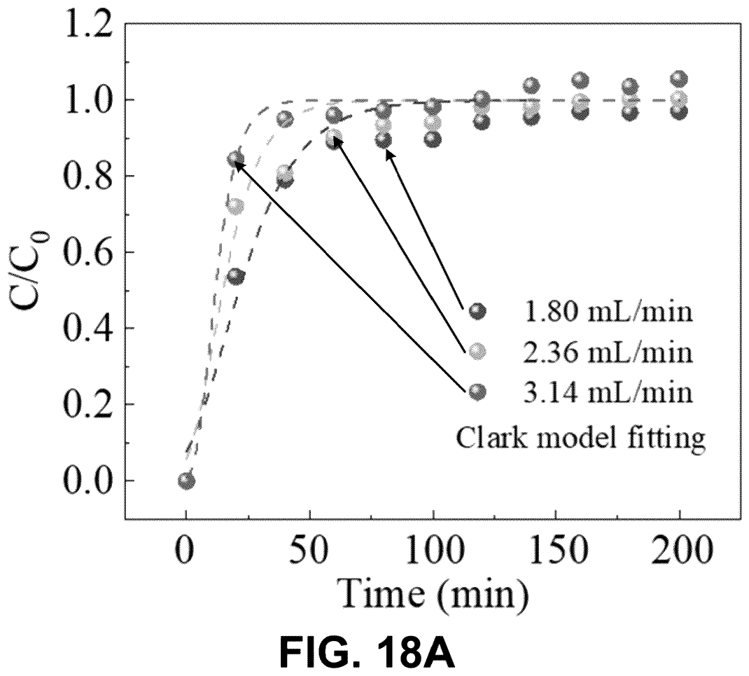

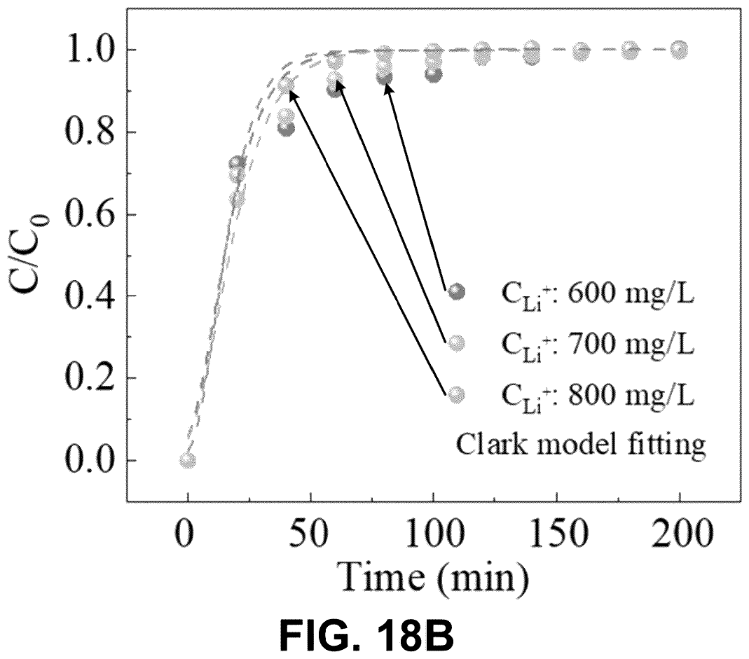

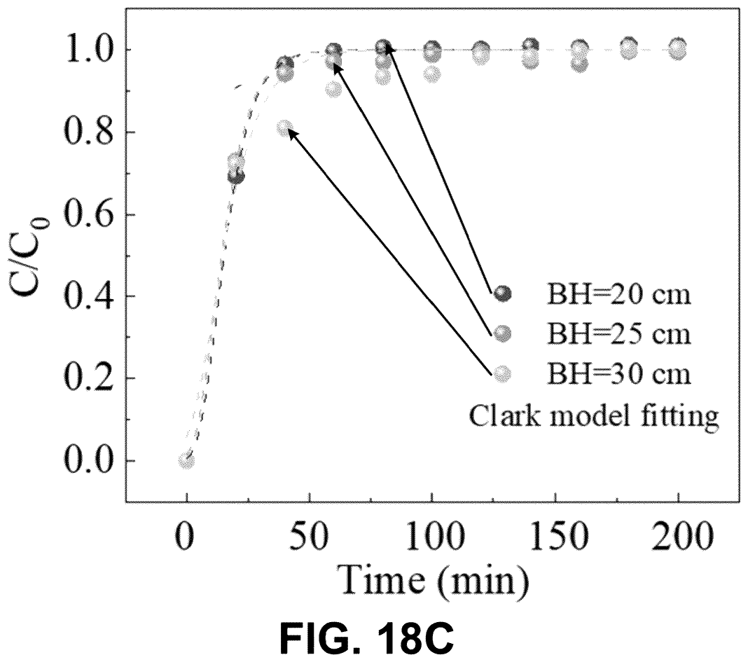

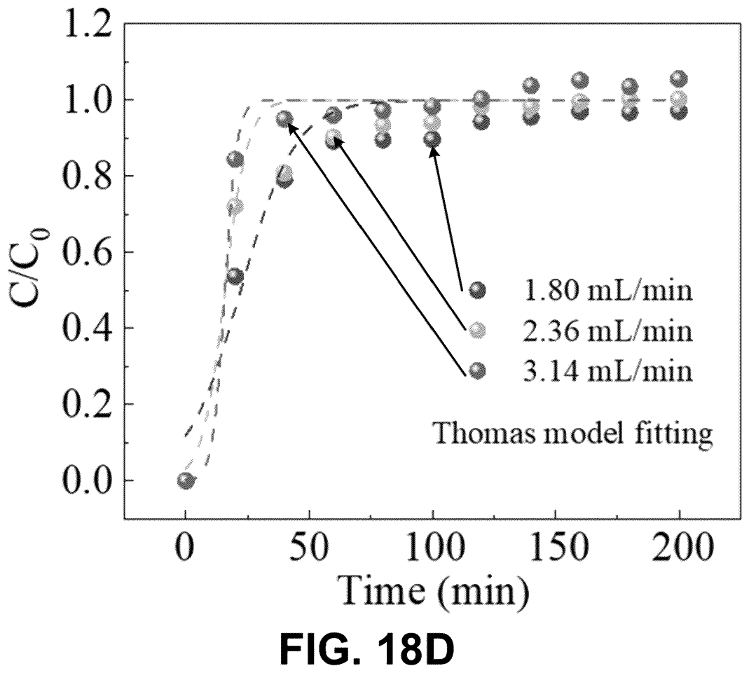

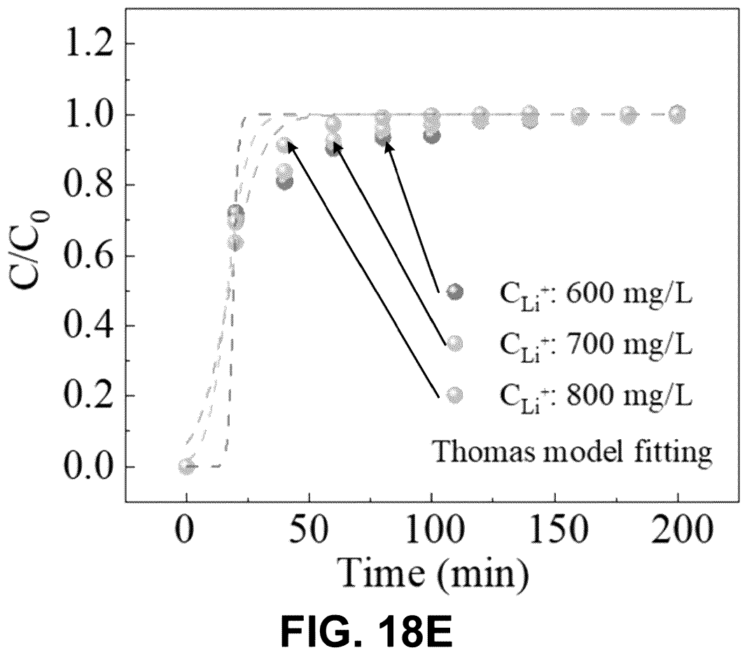

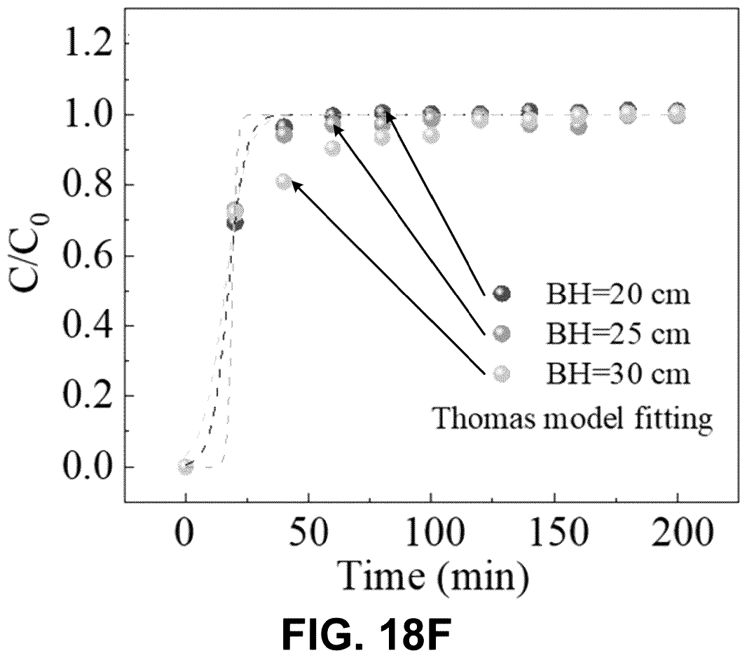

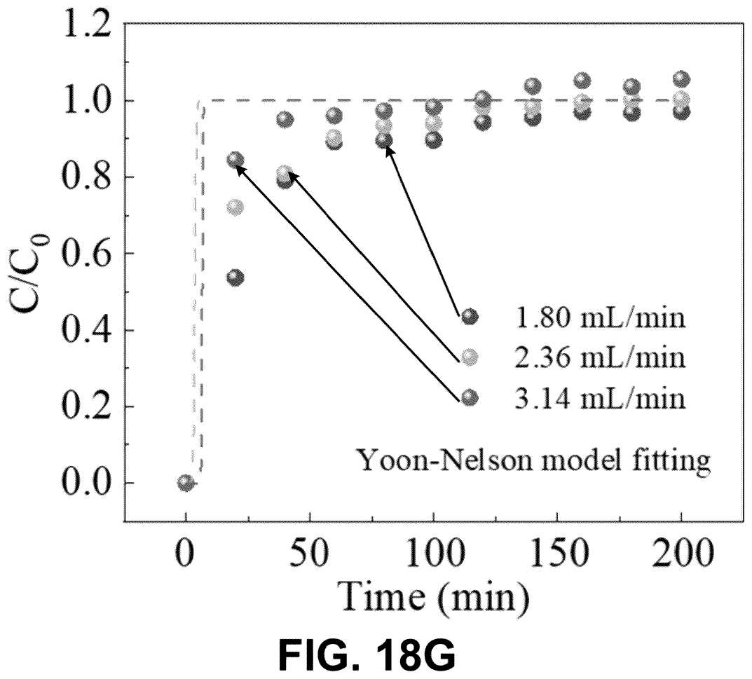

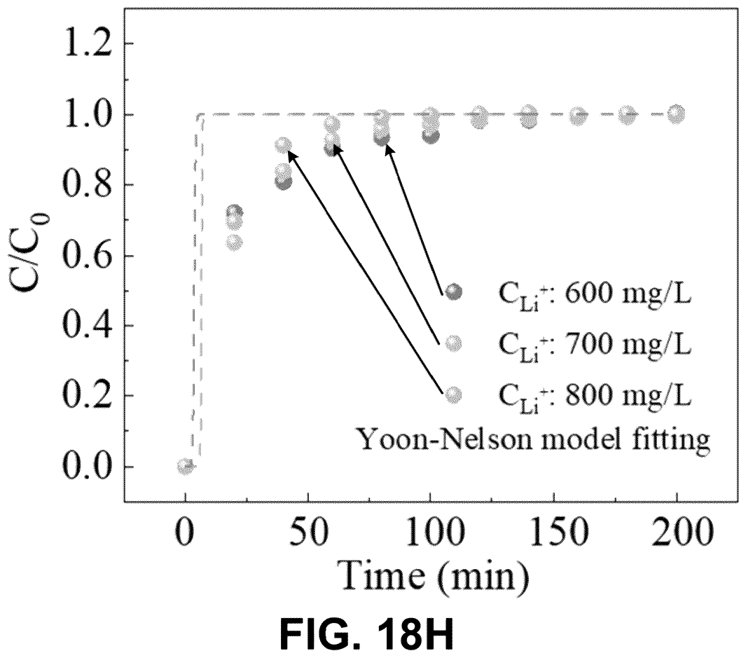

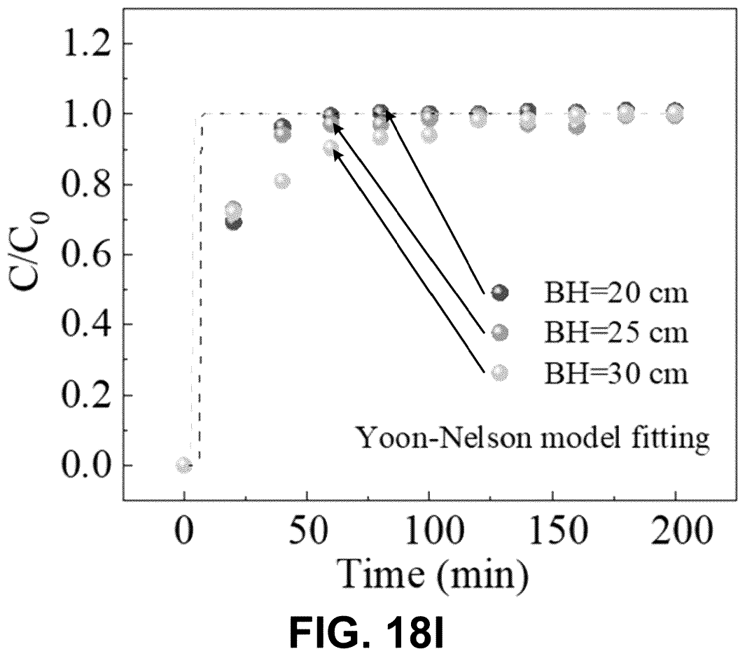

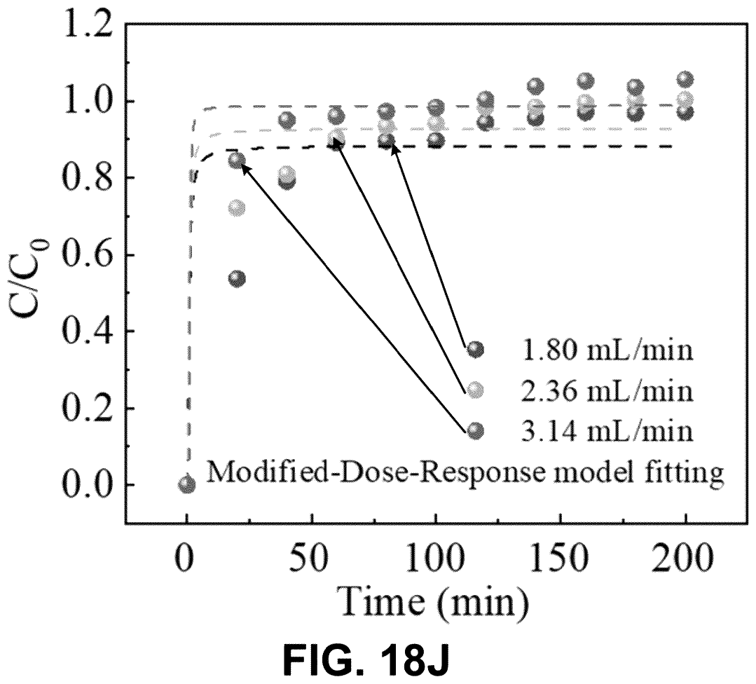

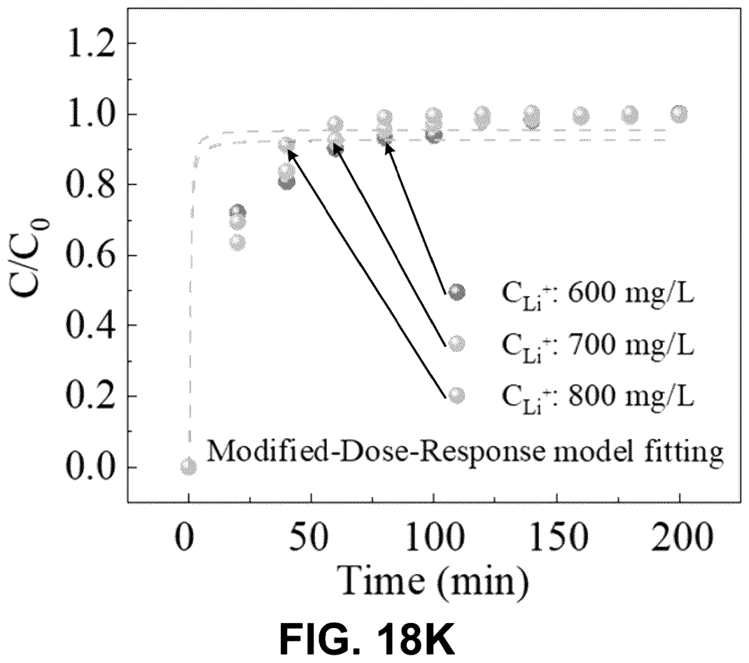

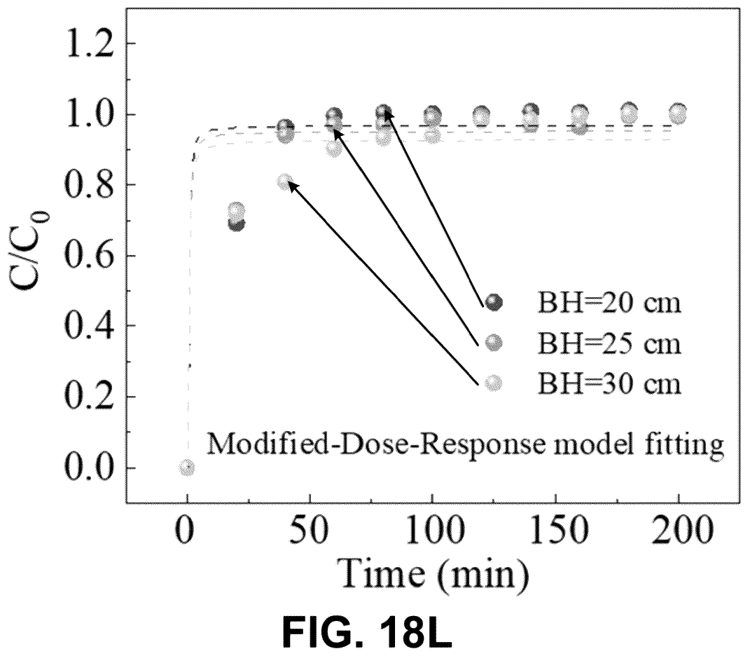

Penetration curve modeling. To predict the penetration behavior of Li-PNFs under various operational conditions, four empirical models, Clark, Thomas, Yoon-Nelson, and Modified-Dose-Response, were employed. The results are presented in FIGS. 18A-18L and Table 9. As indicated in FIG. 18A, FIG. 18D, FIG. 18G, and FIG. 18J, both the Clark and Thomas models effectively forecasted the adsorption penetration behavior across three distinct flow rate conditions, with the Clark model achieving an R² value exceeding 0.95. This high R² value suggested that the adsorption process was predominantly governed by mass transfer in the liquid phase, with the saturation degree and concentration changes of the adsorbent significantly influencing the adsorption rate⁸⁷. Moreover, the penetration curves at the highest flow rate of 3.14 mL/min were accurately predicted by both the Yoon-Nelson and Modified-Dose-Response models. This consistency highlighted that at elevated flow rates, each adsorbent particle was equally likely to adsorb the adsorbate, and the adsorption rate decreased in proportion to the penetration rate of the adsorbent⁸⁸. The data suggest that the penetration curves for the adsorption of Li-PNFs demonstrated reliable predictability at varying flow rates, affirming the robust performance of the fixed-bed system.

Additionally, FIG. 18B, FIG. 18E, FIG. 18H, and FIG. 18K present the empirical fitting results of penetration curves at varying feed Li⁺ concentrations. Both the Clark and Thomas models effectively predicted the adsorption penetration behavior under these conditions, achieving R² values as high as 0.99 at concentrations up to 800 mg/L. This high degree of fit suggested that the adsorbent's saturated adsorption capacity and adsorption affinity were crucial at higher feed Li⁺ concentrations. Furthermore, the mass transfer process, which involved the migration of substances from the solution to the adsorbent surface, also played a significant role in determining adsorption efficiency⁸⁹. Finally, the adsorption penetration curves were analyzed across different BHs. It was evident in FIG. 18C, FIG. 18F, FIG. 18I, and FIG. 18L that the penetration behaviors at three distinct BHs could be accurately predicted by the Clark model, Thomas model, and Modified-Dose-Response model, with R² values exceeding 0.90. The foregoing suggests that the efficiency of the adsorption system depended not only on the initial lithium concentration in the adsorbate solution but also on the effective contact between the adsorbent and adsorbate within the bed⁹⁰.

The foregoing suggests that the adsorption penetration behaviors under diverse conditions were reliably predicted by these empirical models when Li-PNFs were employed as the bed-filled adsorbent material. Thus, the disclosed methods and Li-PNFs are highly adaptable and industrially applicable due to the properties of this material.

TABLE 9
Confidence coefficient R² of different
models for lithium breakthrough curves.

| | R² | | R² | R² |
|---|---|---|---|---|
| Serial | (Clark | R² | (Yoon- | (Modified-Dose- |
| number | model) | (Thomas) | Nelson) | Response) |
| 1 | 0.9669 | 0.9334 | 0.6160 | 0.8239 |
| 2 | 0.9531 | 0.9383 | 0.8471 | 0.8752 |
| 3 | 0.9860 | 0.9855 | 0.9593 | 0.9615 |
| 4 | 0.9531 | 0.9373 | 0.8301 | 0.9127 |
| 5 | 0.9825 | 0.9657 | 0.8152 | 0.8771 |
| 6 | 0.9959 | 0.9910 | 0.8892 | 0.9127 |
| 7 | 0.9995 | 0.9983 | 0.8980 | 0.9106 |
| 8 | 0.9942 | 0.9917 | 0.9088 | 0.9376 |
| 9 | 0.9531 | 0.9383 | 0.8471 | 0.9127 |

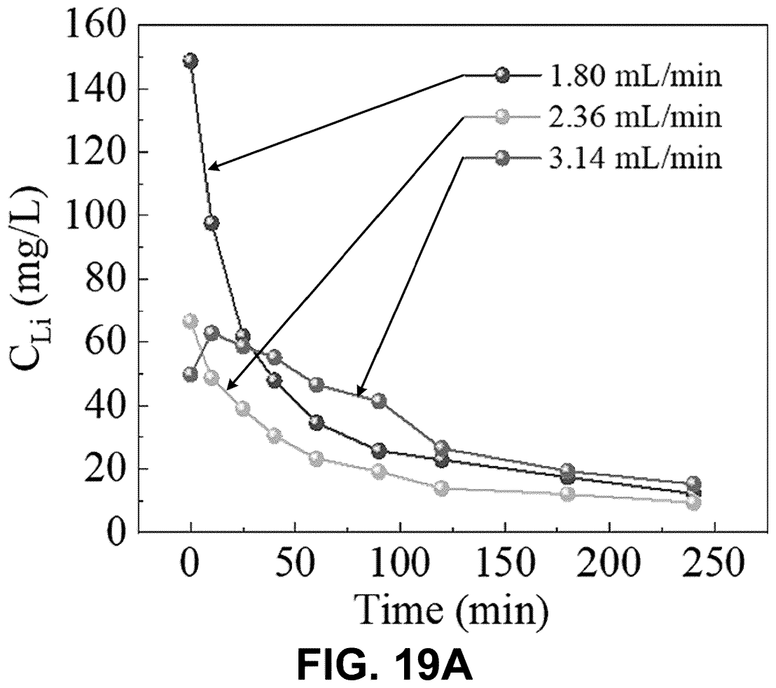

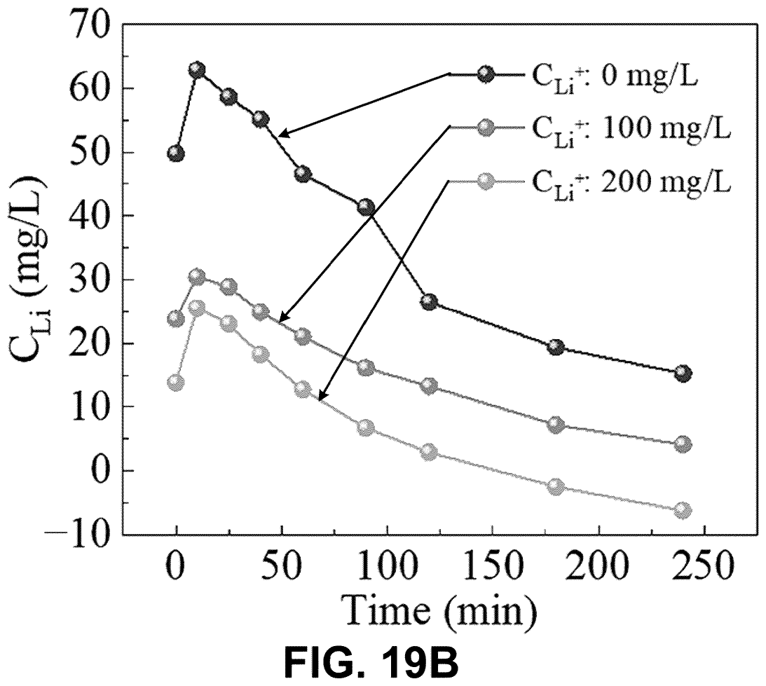

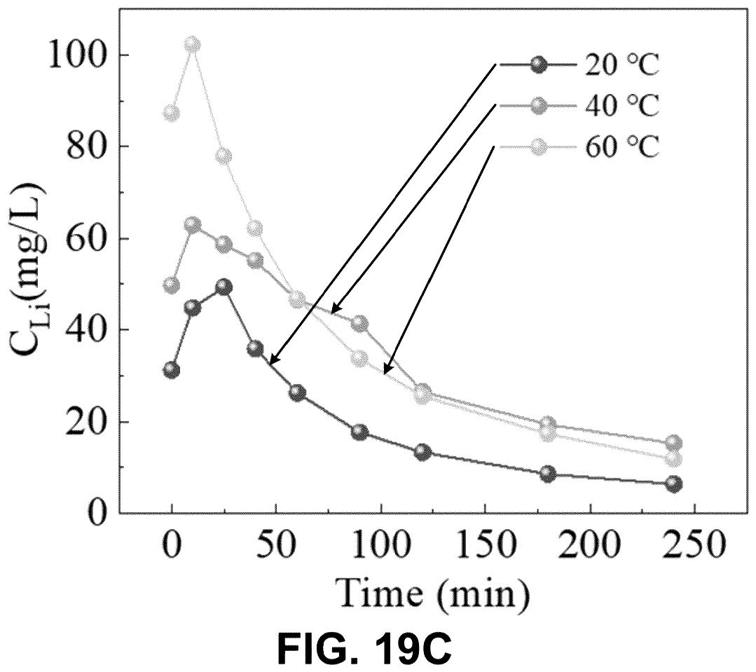

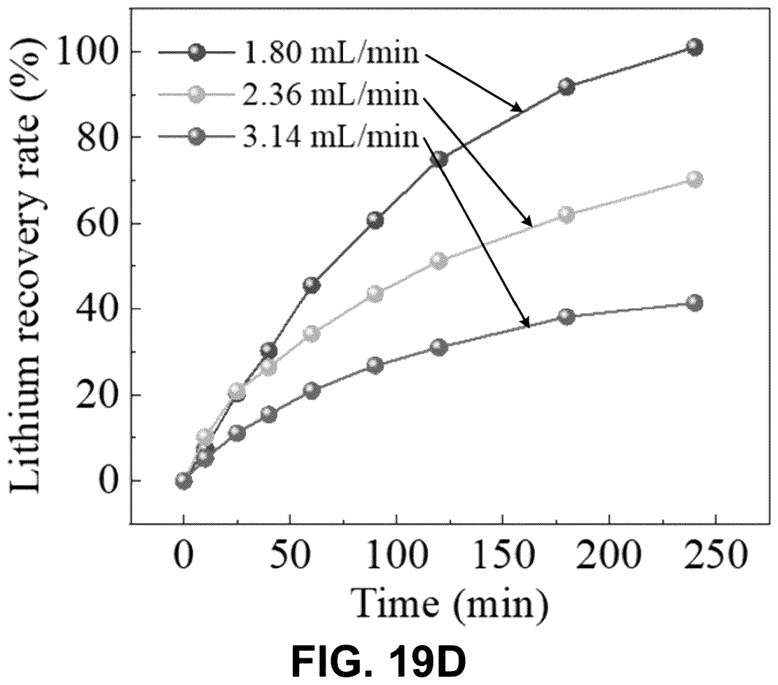

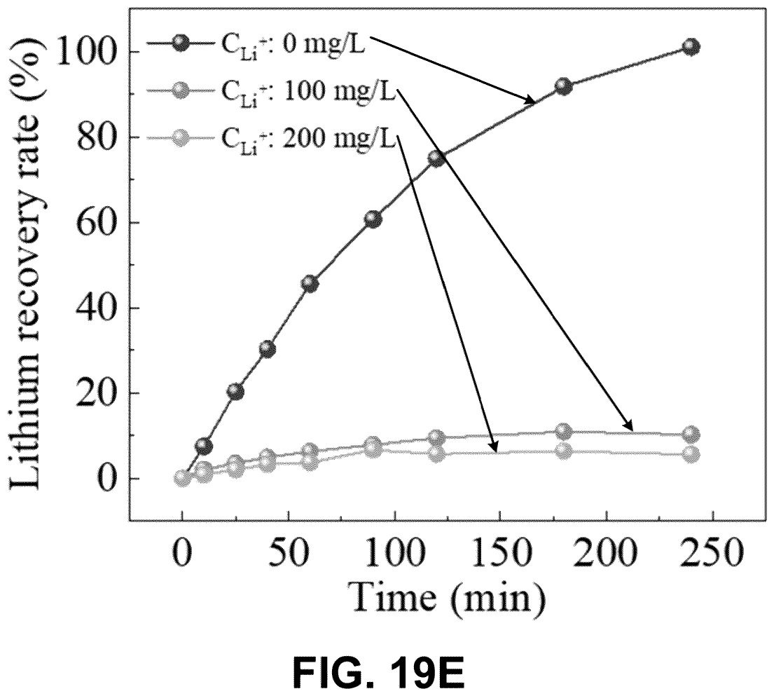

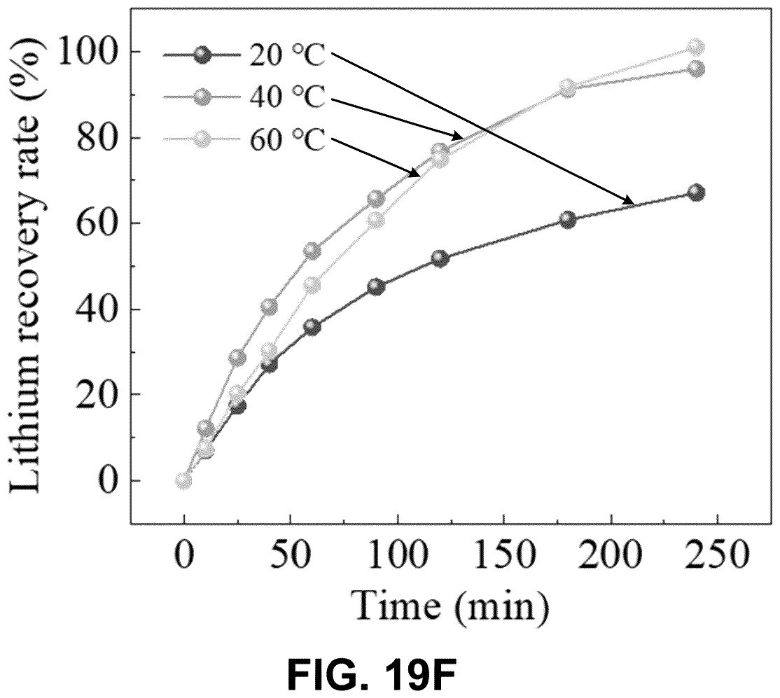

Lithium desorption. To methodically explore the fixed-bed desorption process, the impact of feed flow rate of desorption solution, Li⁺ concentration in this solution, and desorption temperature were sequentially investigated. FIG. 19A illustrates that a pronounced desorption effect of lithium was observed within the first 50 min of operation, with the outlet Li⁺ concentration decreasing as the feed time increased. This trend could be attributed to the more effective desorption initially, which gradually diminished over time due to the depletion of available Li⁺ for desorption. Furthermore, better desorption was achieved at the lowest feed flow rate of 1.80 mL/min. Corresponding data in FIG. 19D compares lithium recoveries across different feed flow rates, suggesting that lithium recovery was inversely proportional to the feed flow rate. This relationship was primarily due to the longer contact time between the desorption solution and the lithium-loaded adsorbent at slower flow rates, which also mitigated the kinetic limitations on mass transfer imposed by the fluid dynamics, thereby enhancing the desorption efficacy⁹¹.

In addition, the desorption effects of solutions containing different Li⁺ concentrations were analyzed, as depicted in FIG. 19B and FIG. 19E. The outlet Li⁺ concentration demonstrated a sharp initial decrease followed by a more gradual reduction over time. This pattern suggested that Li⁻ desorption was most effective at the beginning of the desorption process. Moreover, the outlet Li⁺ concentration inversely correlated with the Li⁻ concentration in the feed solution, indicating that higher Li⁻ concentrations in the solution reduced the effectiveness of the desorption. Further analysis from FIG. 19E shows that complete desorption of Li⁻ was achieved within 250 min when using solution containing 0 mg/L of Li⁺. In contrast, desorption solutions with Li⁺ exhibited poor recovery effects and were largely ineffective in facilitating high-intensity recovery⁹². In some practical industrial applications, excessive desorption may lead to the structural collapse of the adsorbent bed, rendering it non-recyclable. In some aspects, employing solutions with a low concentration of Li⁺ may be desired to provide a protective option, preventing damage to the adsorbent structure while still facilitating effective desorption.

The influence of varying desorption temperatures on the desorption effectiveness was also investigated. As depicted in FIG. 19C, the outlet Li⁺ concentration initially decreased rapidly before slowing down, with higher temperatures correlating with higher outlet concentrations, thereby indicating more effective desorption of Li⁺. Further analysis from FIG. 19F shows that an increase in temperature enhances Li⁺ recovery, achieving complete recovery within 250 min using a desorption solution at 60° C. This enhanced desorption efficiency at elevated temperatures was primarily due to the increased rate of molecular diffusion, which also improved mass transfer between the desorbing solution and the adsorbent, facilitating the removal of Li^{+ 93}. In conclusion, in practical industrial applications, optimizing Li⁺ recovery efficiency involves not only achieving high recovery rates but also considering the recyclability of the adsorbent and energy consumption. In various aspects, the following parameters can be modulated: desorption feed flow rate, the concentration of Li⁺ in the desorption solution, and the desorption temperature.

Static Adsorption Experiments. Static lithium adsorption experiments were conducted to evaluate the performance of Li-PNFs. A specific amount of fiber was added to a fixed volume of synthetic brine, and the mixture was agitated at 300 rpm for 4 hours using a water-bath shaker (Model 290400, Boekel Scientific, USA) to ensure proper mixing before sample collection. By testing the Li⁻ ion concentration before and after the adsorption using ICP-MS, the lithium adsorption capacity q was calculated using Eq. (13):

$$q = \frac{v \cdot ( {C}_{0} - {C}_{t} )}{m} \qquad ( 13 )$$

where C₀ (mg/L) and Cₜ (mg/L) refer to the Li⁻ ion concentration before and after adsorption, respectively; m (g) is the mass of the added fiber; v (L) is the volume of the feed brine.

Different salt solutions of the same concentration were configured and diluted to prepare two-component solutions used for adsorption selectivity performance investigations. The selectivity factor was calculated according to Eq. (14) and Eq. (15)

$${K}_{Me , i} = \frac{( {C}_{0 , i} - {C}_{e , i} ) \cdot V}{{C}_{e , i} \cdot m} \qquad ( 14 )$$

$${a}_{Li}^{Me} = \frac{{K}_{Me , Li}}{{K}_{Me , i}} \qquad ( 15 )$$

where C_{0,i} (mg/L) and C_{e,i} (mg/L) are the initial and equilibrium concentrations of the cations, respectively. m (g) and V (L) are the mass of adsorbents used and the volume of feed solution, respectively.

Porosity calculations. The porosity ϕ of the Li-PNFs fibers could be calculated using Eq. (16):

$$ϕ = \frac{{m}_{fibeτ} \cdot {v}_{pore}}{z \cdot {d}^{2}} \qquad ( 16 )$$

where m_{fiber} (g) refers to the BET tested-fibers mass; vₚₒᵣₑ (cm³/g) is the pore volume which can be obtained from BET results; z (cm) means the thickness of each fiber piece; d (cm) represents the side length of the square piece, with d set to 0.8 cm in this work.

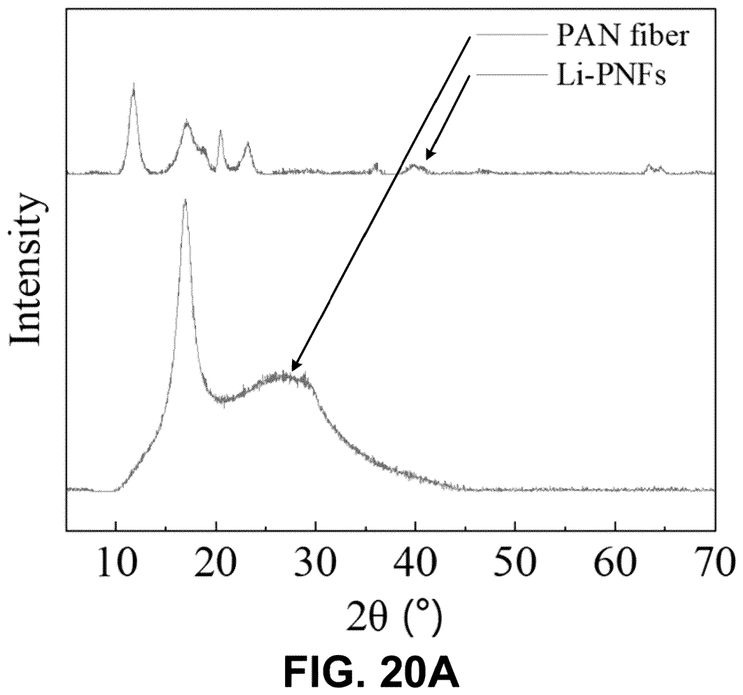

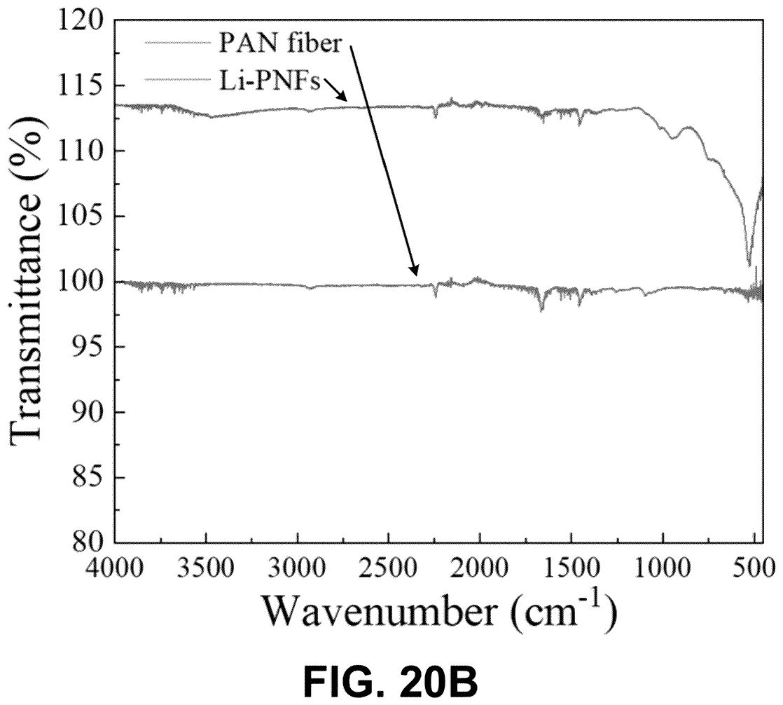

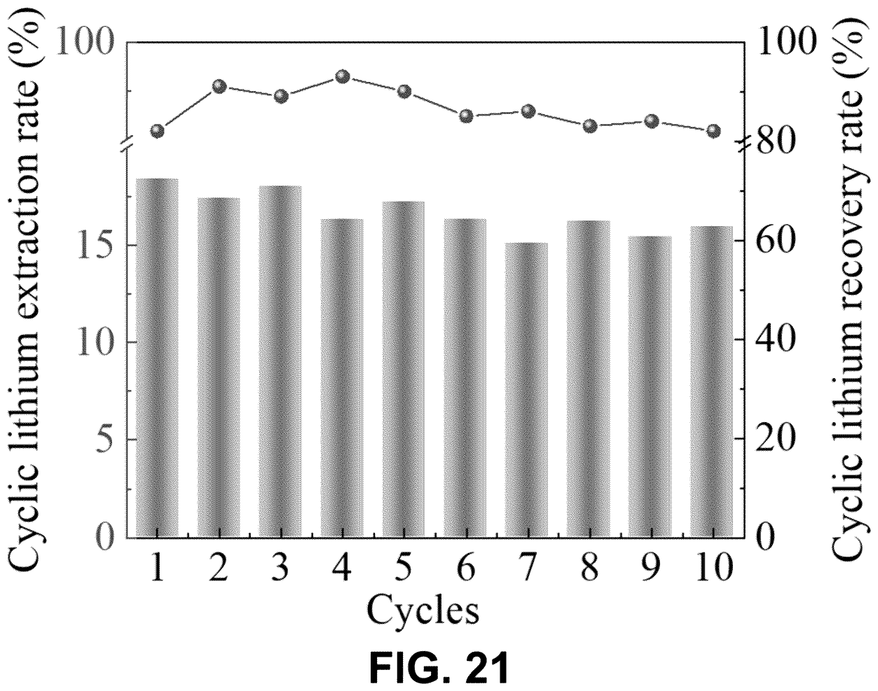

Additional results showing XRD pattern comparisons and FTIR results of PAN fiber and Li-PNF fiber are shown in FIGS. 20A and 20B. FIG. 21 also present adsorption phase cyclic lithium extraction and desorption phase lithium recovery rates.

Summary. Disclosed are electrospun-porous nanosorbent fiber (Li-PNFs), constructed from PAN and Li/Al-LDH, that are engineered for the efficient continuous lithium extraction from brines via a fixed-bed system. The Li-PNFs featured a three-dimension interconnected mesh with a 500 nm fiber diameter and were functionalized with needle-like Li/Al-LDH structures. Besides, the analysis of Li/Al-LDH and Li-PNFs revealed that Li-PNFs had enhanced microporous and mesoporous structures with optimal pore sizes, enhancing Li⁺ transfer, reducing diffusion resistance and pressure drop, and maintaining adsorbent integrity. Comparative static lithium adsorption studies and DFT calculations confirmed that the interaction between Li/Al-LDH and PAN enhanced lithium adsorption capacity, lithium selectivity, and optimized Li⁺ binding energy. Experimental fixed-bed adsorption evaluated the influence of feed flow rate, initial lithium concentration, and bed height on the penetration process of the fluid through the bed. Lower feed rates, higher initial lithium concentrations, and greater bed heights were found to facilitate more efficient flow of the adsorbate, thereby improving lithium extraction performance. The Clark and Thomas models were successfully applied to empirically predict the adsorption penetration process, confirming the adaptability and potential industrial application of Li-PNFs as lithium adsorbent materials. Finally, fixed-bed desorption test results indicated that lithium recovery performance was inversely proportional to both the feed flow rate and lithium concentration in desorption solution, and directly proportional to the desorption temperature.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A lithium porous nanosorbent fiber composition comprising:
an LDH (Layered Double Hydroxide) substrate; and
a polymer attached to the LDH substrate;
wherein the lithium porous nanosorbent fiber composition has a fibrous structure.

2. The lithium porous nanosorbent fiber composition of claim 1, wherein the LDH substrate is Li/Al-LDH.

3. The lithium porous nanosorbent fiber composition of claim 1, wherein the polymer is selected from a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), and combinations thereof.

4. The lithium porous nanosorbent fiber composition of claim 1, wherein the lithium porous nanosorbent fiber composition comprises a plurality of fibers, wherein an individual fiber of the plurality of fibers has a diameter of from about 50 nm to about 2000 nm.

5. The lithium porous nanosorbent fiber composition of claim 1, wherein the lithium porous nanosorbent fiber composition has a lithium adsorption capacity of about 0.1 mg/g to about 50 mg/g.

6. The lithium porous nanosorbent fiber composition of claim 1, wherein the lithium porous nanosorbent fiber composition has a weight ratio of the LDH substrate to the polymer of from about 1:1 to about 1:100.

7. The lithium porous nanosorbent fiber composition of claim 1, wherein the polymer is a block copolymer comprising two or more blocks; and wherein each individual block is independently selected from a polymer block comprising a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), or combinations thereof.

8. The lithium porous nanosorbent fiber composition of claim 1, wherein the polymer is a gradient copolymer comprising a first gradient block comprising a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), or combinations thereof; and
wherein the gradient copolymer comprises a higher concentration of the first gradient block at a first terminus of the gradient copolymer and a lower concentration of the first gradient block at a second terminus of the gradient copolymer distal to the first terminus.

9. The lithium porous nanosorbent fiber composition of claim 1, wherein the lithium porous nanosorbent fiber composition has a tensile strength of about 2.0 MPa to about 4.0 MPa.

10. The lithium porous nanosorbent fiber composition of claim 1, wherein the lithium porous nanosorbent fiber composition has a porosity of about 5% to about 30%.

11. A method for fabrication of porous nanosorbent fibers, the method comprising:
a. preparing a Li/Al-LDH substrate using co-precipitation;
b. dissolving a polymer in a dissolving solution, thereby creating a polymer suspension;
c. adding the Li/Al-LDH substrate to the polymer suspension, thereby forming a Li/Al-LDH-polymer suspension;
d. electrospinning the Li/Al-LDH-polymer suspension, thereby forming a fibrous product; and
e. drying the fibrous product.

12. The method of claim 11, wherein preparing the Li/Al-LDH substrate using co-precipitation comprises:
i. combining a mixed salt solution comprising Li and Al with a base solution, thereby forming a mixture comprising an aqueous phase and a solid; and
ii. drying the solid.

13. The method of claim 12, wherein the mixed salt solution comprises a Li to Al molar ratio of about 0.1 to about 1.0.

14. The method of claim 11, wherein the polymer is selected from a polyacrylonitrile (PAN), a polyvinylidene fluoride (PVDF), a polyvinyl chloride (PVC), a polyethylene glycol (PEG), a polyacrylic acid (PAA), a polylactic acid (PLA), a polypropylene (PP), a poly (ethylene terephthalate) (PET), a polystyrene (PS), and combinations thereof.

15. The method of claim 11, wherein adding the Li/Al-LDH substrate to the polymer suspension is done at a LDH to polymer ratio of about 0.1:1 to about 10:1.

16. A method, comprising:
a. flowing a feedstock solution comprising lithium over a solid comprising the lithium porous nanosorbent fiber composition of claim 1, thereby producing a first effluent;
b. flowing an aqueous solution over the solid; and
c. flowing a desorption solution over the solid, thereby producing a second effluent.

17. The method of claim 16, wherein flowing the feedstock solution over the solid is done at a flow rate of about 1 mL/min to about 4 mL/min.

18. The method of claim 16, wherein flowing the desorption solution over the solid is done at a flow rate of about 1 mL/min to about 4 mL/min.

19. The method of claim 16, wherein the desorption solution is an aqueous solution comprising a lithium concentration of about 1 ppm to about 200 ppm.

20. The method of claim 16, wherein the second effluent comprises lithium.
